(19) United States
(12) Patent Application Publication
(10) Pub. No.: US 2023/0356792 A1
(43) Pub. Date: Nov. 9, 2023

(54) SYSTEMS AND METHODS FOR MONITORING VEHICLES

(71) Applicant: Camso Inc., Magog (CA)

(72) Inventors: Ghislain LAPERLE, Sherbrooke (CA); David GINGRAS, Magog (CA)

(21) Appl. No.: 18/223,841

(22) Filed: Jul. 19, 2023

Related U.S. Application Data
(63) Continuation of application No. 16/557,523, filed on Aug. 30, 2019.
(60) Provisional application No. 62/724,846, filed on Aug. 30, 2018.
(60) Provisional application No. 62/724,853, filed on Aug. 30, 2018.

(51) Int. Cl. B62D 55/10; B62D 55/247; B60C 23/04; B60T 8/172; B62D 55/265

(52) U.S. Cl. CPC B62D 55/10; B62D 55/247; B60C 23/0447; B60T 8/1725; B62D 55/265; B60T 2240/03

(57) ABSTRACT

Monitoring vehicles comprising track systems or tires to obtain information regarding the vehicle, including information regarding the track systems or tires, such as an indication of a level of wear, a rupture like a break, a puncture, chunking, de-bonding, etc., which can be used for various purposes, such as, for example, to convey the information to a user (e.g., the operator); control the vehicle (e.g., a speed of the vehicle, operation of a work implement, etc.); transmit the information to a remote party (e.g., a provider such as a manufacturer or distributor of the track systems or tires); etc.

### CROSS-REFERENCE TO RELATED APPLICATION

This application claims priority to U.S. Non-Provisional patent application Ser. No. 16/557,523, filed Aug. 30, 2019, which claims priority to, and the benefit of, both U.S. Provisional Patent App. No. 62/724,853 filed Aug. 30, 2018 and U.S. Provisional Patent App. No. 62/724,846 filed Aug. 30, 2018, where all such related applications are hereby incorporated by reference.

### FIELD

This disclosure relates generally to vehicles and, more particularly, to off-road vehicles comprising tracks, as well as vehicles comprising tires, including pneumatic and non-pneumatic tires (NPTs), for vehicles, including road vehicles and off-road vehicles.

### BACKGROUND

Certain off-road vehicles, including industrial vehicles such as construction vehicles (e.g., loaders, bulldozers, excavators, etc.), agricultural vehicles (e.g., harvesters, combines, tractors, etc.), and forestry vehicles (e.g., feller-bunchers, tree chippers, knuckleboom loaders, etc.), as well as military vehicles (e.g., combat engineering vehicles (CEVs), etc.), to name a few, may be equipped with elastomeric tracks which enhance their traction and floatation on soft, slippery and/or irregular grounds (e.g., soil, mud, sand, ice, snow, etc.) on which they operate.

Elastomeric tracks may be constructed in various ways, often comprising internal reinforcements in their elastomeric material. For example, an elastomeric track may comprise transversal cores embedded in its elastomeric material (e.g., rubber) and spaced apart in the track's longitudinal direction to impart transversal rigidity to the track and possibly interact with wheels (e.g., a drive wheel and/or roller wheels) around which the track is disposed. For instance, in some cases, the track may comprise transversal metallic cores embedded in its elastomeric material. Each metallic core may comprise one or more wheel-engaging projections for interacting with one or more of the wheels around which the track is disposed to guide and/or drive the track.

Issues may arise when a track wears or otherwise deteriorates. For example, wear of elastomeric treads of the track can lead to decreased performance. Damage of cores or other internal reinforcements of the track may also be problematic. For instance, the cores or other internal reinforcement may become exposed and this may cause a progressive loss of adhesion between them and the track's elastomeric material due to, for instance, infiltration of rocks, sand, water and/or other undesirable matter between the internal reinforcements and the elastomeric material. Such problems may often result in downtime and other adverse effects.

Similar issues may arise because of wear or other deterioration of a wheel (e.g., a drive wheel such as a sprocket) around which a track is disposed.

For these and other reasons, there is a need for solutions to detect deterioration of track system components of off-road vehicles.

Similarly, wheels for vehicles comprise tires, which may be pneumatic tires or non-pneumatic tires. Tires are subject to various forces and environments that cause them to wear and sometimes fail. While various designs and solutions have been developed to address this, they may be impractical, expensive or inefficient in some cases. For example, tire-pressure monitoring systems for pneumatic tires may detect a puncture or other inflation loss in a tire only after that issue arises.

For these and other reasons, there is a need to improve wheels comprising tires for vehicles.

### SUMMARY

According to a first aspect, this disclosure relates a track system for traction of a vehicle. The track system comprises a plurality of wheels and a track mounted around the wheels. The track is elastomeric and comprises a ground-engaging outer surface and an inner surface opposite to the ground-engaging outer surface. The track system comprises a sensor configured to sense deterioration of a component of the track system.

According to another aspect, this disclosure relates to a monitoring system for use in respect of a vehicle comprising a track system for traction of the vehicle. The track system comprising a plurality of wheels and a track mounted around the wheels. The track is elastomeric and comprises a ground-engaging outer surface and an inner surface opposite to the ground-engaging outer surface. The track system comprises a sensor. The monitoring system comprises a processing apparatus configured to be mounted to the vehicle, receive a signal output by the sensor of the track system, and process the signal output by the sensor of the track system. The monitoring system also comprises a communication device external to the processing apparatus and the vehicle and configured to communicate with the processing apparatus to derive information regarding the vehicle.

According to yet another aspect, this disclosure relates to a tire for a vehicle. The tire comprises elastomeric material. The tire comprises reinforcement within the elastomeric material and a sensor configured to sense deterioration of the tire.

These and other aspects of this disclosure will now become apparent upon review of a description of embodiments that follows in conjunction with accompanying drawings.

### BRIEF DESCRIPTION OF THE DRAWINGS

A detailed description of examples of implementations is provided below, with reference to the following drawings, in which:

FIG. 1 shows an example of an off-road vehicle comprising a track system including a track in accordance with an embodiment;

FIGS. 2 and 3 show a perspective view and a side view of the track system of the vehicle that includes the track;

FIGS. 4 and 5 show an inner plan view and a cross-sectional view of the track;

FIGS. 6 to 8 show examples of a wheel of the track system in relation to the track;

FIG. 9A shows an embodiment in which the track comprises at least one degradation sensor;

FIG. 9B shows an embodiment of a degradation monitoring system;

FIG. 10 shows an embodiment of a degradation sensor of the monitoring system;

FIG. 11 shows an embodiment of a processing entity for interacting with the degradation sensor of the monitoring system;

FIGS. 12 and 13 show examples of the degradation sensor communicating with the processing entity of the monitoring system;

FIG. 14 shows an embodiment of a degradation sensor arrangement of the monitoring system for monitoring degradation in the track;

FIG. 15 shows an embodiment of a degradation sensor arrangement of the monitoring system for monitoring degradation in the track;

FIG. 16A shows an embodiment of a degradation sensor arrangement of the monitoring system for monitoring degradation in a drive sprocket;

FIGS. 16B and 16C show an embodiment of a degradation sensor arrangement of the monitoring system for monitoring degradation in a drive sprocket;

FIG. 17A shows an embodiment of a degradation sensor arrangement of the monitoring system for monitoring degradation in guide/drive projections of the track;

FIGS. 17B and 17C show an embodiment of a degradation sensor arrangement of the monitoring system for monitoring degradation in guide/drive projections of the track;

FIG. 18A shows an embodiment of a degradation sensor arrangement of the monitoring system for monitoring degradation in the track;

FIG. 18B shows an embodiment of a degradation sensor arrangement of the monitoring system for monitoring degradation in the track;

FIG. 19 shows an embodiment of a degradation sensor arrangement of the monitoring system for monitoring degradation in track reinforcing cables;

FIG. 20 shows an embodiment of a degradation sensor arrangement of the monitoring system for monitoring degradation in track reinforcing cables;

FIG. 21 shows an embodiment of a degradation sensor arrangement of the monitoring system for monitoring degradation in track reinforcing cables;

FIGS. 22 to 24 show an example of an embodiment in which the track system comprises tags for identifying components of the track system, such as its track and wheels;

FIGS. 25 and 26 show examples of embodiments of the processing entity of the monitoring system interacting with a powertrain of the vehicle and a communication device;

FIGS. 27 and 28 show an example of an embodiment of the processing entity of the monitoring system interacting with a powertrain controller of the vehicle;

FIGS. 29 to 32 show an example of an embodiment of the communication device;

FIG. 33 shows an embodiment of a drone device for inspecting the track system;

FIG. 34 shows the drone device for inspecting the track system;

FIG. 35 shows a flow diagram of an embodiment of a method of repairing or replacing a track system component;

FIG. 36 shows a flow diagram of another embodiment of a method of repairing or replacing a track system component;

FIG. 37 shows a flow diagram of yet another embodiment of a method of repairing or replacing a track system component;

FIG. 38 shows another example of an off-road vehicle comprising a track system including a track in accordance with an embodiment;

FIG. 39 shows yet another example of an off-road vehicle comprising a track system including a track in accordance with an embodiment;

FIG. 40 shows yet another example of an off-road vehicle comprising a track system including a track in accordance with an embodiment;

FIG. 41 shows an example of a degradation sensor arrangement of the monitoring system for monitoring degradation in chain-on rubber pads;

FIG. 42 shows an example of a degradation sensor arrangement of the monitoring system for monitoring degradation in bushings, pins and/or rails of chain links;

FIG. 43 shows an example of a camera station for inspecting track systems;

FIG. 44 shows an example of a laser line scanner station for inspecting track systems;

FIG. 45 shows a schematic network diagram for a track monitoring and ordering system;

FIG. 46 shows a schematic network diagram for a track monitoring fleet management system;

FIG. 47 shows a schematic network diagram for a track monitoring and track-as-a-service system;

FIG. 48 shows an example of a vehicle-mounted inspection device for inspecting track systems;

FIG. 49 shows an example of a vehicle comprising a wheel including a pneumatic tire in accordance with an embodiment;

FIG. 50 shows an example of a pneumatic tire in accordance with an embodiment;

FIG. 51 shows a cutaway view of the pneumatic tire of FIG. 50;

FIG. 52 shows an embodiment in which the pneumatic tire of FIG. 50 comprises at least one degradation sensor;

FIG. 53 shows an embodiment of a degradation sensor arrangement of the monitoring system for monitoring degradation of the tire;

FIG. 54 shows another embodiment of a degradation sensor arrangement of the monitoring system for monitoring degradation of the tire;

FIG. 55 shows yet another embodiment of a degradation sensor arrangement of the monitoring system for monitoring degradation of the tire;

FIG. 56 shows another example of the degradation sensor arrangement of FIG. 55 of the monitoring system for monitoring degradation of the tire;

FIG. 57 shows an embodiment in which the tire monitoring system comprises tags for identifying a tire and components of the tire;

FIG. 58 shows an embodiment of a degradation monitoring system;

FIG. 59 shows an embodiment of a degradation sensor of the monitoring system;

FIG. 60 shows an embodiment of a processing entity for interacting with the degradation sensor of the monitoring system;

FIGS. 61 and 62 show examples of the degradation sensor communicating with the processing entity of the monitoring system;

FIGS. 63 to 66 show an example of an embodiment in which the tires comprise tags for identifying the tire;

FIGS. 67 and 68 show an example of an embodiment of the processing entity of the monitoring system interacting with a powertrain controller of the vehicle;

FIGS. 69 to 71 show an example of an embodiment of the communication device;

FIG. 72 shows a flow diagram of an embodiment of a method of repairing or replacing a tire;

FIG. 73 shows a flow diagram of another embodiment of a method of repairing or replacing a tire;

FIG. 74 shows a flow diagram of yet another embodiment of a method of repairing or replacing a tire;

FIG. 75 shows a schematic network diagram for a tire monitoring and ordering system;

FIG. 76 shows a schematic network diagram for a tire monitoring fleet management system;

FIG. 77 shows a schematic network diagram for a tire monitoring and tire-as-a-service system;

FIG. 78 shows another example of a vehicle comprising a wheel including a non-pneumatic tire in accordance with an embodiment;

FIG. 79 shows an example of a non-pneumatic tire in accordance with an embodiment; and

FIG. 80 shows a cutaway view of the non-pneumatic tire of FIG. 79.

These and other aspects of this disclosure will now become apparent to those of ordinary skill in the art upon review of a description of embodiments that follows in conjunction with accompanying drawings.

### DETAILED DESCRIPTION

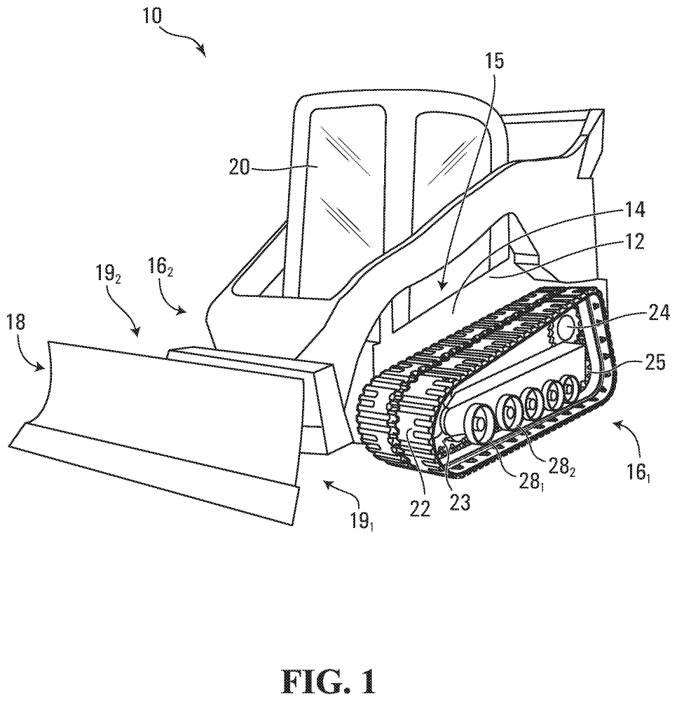

FIG. 1 shows an example of an embodiment of a vehicle 10 comprising track systems 16₁, 16₂. Each of the track systems 16₁, 16₂ comprises a track 22 to engage the ground.

In this embodiment, the vehicle 10 is a heavy-duty work vehicle for performing construction, agricultural, or other industrial work or military work. More particularly, in this embodiment, the vehicle 10 is a construction vehicle. Specifically, in this example, the construction vehicle 10 is a compact track loader. The vehicle 10 comprises a frame 12, a powertrain 15, and an operator cabin 20 for an operator to move the vehicle 10 on the ground to perform work using a work implement 18.

As further discussed later, in this embodiment, the vehicle 10, including the track systems 16₁, 16₂, can be monitored (e.g., during operation of the vehicle 10) to obtain information regarding the vehicle 10, including information regarding the track systems 16₁, 16₂, such as one or more parameters of the track systems 16₁, 16₂ (e.g., an indication of deterioration of the track 22 and/or another component thereof, such as an indication of a level of wear, a rupture like a break, a puncture, chunking, de-bonding, etc.); an identifier of the track 22 and/or another component thereof, etc.) and/or one or more characteristics of an environment of the track systems 16₁, 16₂ (e.g., a compliance, a profile, a soil moisture level, etc. of the ground beneath the track systems 16₁, 16₂), which can be used for various purposes, such as, for example, to: convey the information to a user (e.g., the operator); control the vehicle 10 (e.g., a speed of the vehicle 10, operation of the work implement 18, etc.); transmit the information to a remote party (e.g., a provider such as a manufacturer or distributor of the track systems 16₁, 16₂, the track 22 and/or another component thereof, and/or of the vehicle 10; etc.); etc. This may be useful, for example, to gain knowledge about the vehicle 10, the track systems 16₁, 16₂, and/or their environment to enhance efficiency of work performed by the vehicle 10, help prevent rapid wear or other deterioration of the track systems 16₁, 16₄, facilitate maintenance (e.g., replacement or repair) of the track 22 and/or other components of each of the track systems 16₁, 16₂, and/or for various other reasons.

The powertrain 15 is configured to generate motive power for the track systems 16₁, 16₂ to propel the vehicle 10 on the ground. To that end, the powertrain 15 comprises a prime mover 14 which is a source of motive power that comprises one or more motors. For example, in this embodiment, the prime mover 14 comprises an internal combustion engine. In other embodiments, the prime mover 14 may comprise another type of motor (e.g., an electric motor) or a combination of different types of motor (e.g., an internal combustion engine and an electric motor). Motive power generated by the prime mover 14 is applied to the track systems 16₁, 16₂. In some embodiments, the powertrain 15 may transmit power from the prime mover 14 to the track systems 16₁, 16₂ (e.g., via a transmission, a differential, and/or any other suitable mechanism). In other embodiments, at least part of the powertrain 15 (e.g., a motor and/or a transmission) may be part of one or more of the track systems 16₁, 16₂.

The operator cabin 20 comprises a user interface that allow the operator to interact with the vehicle 10, including to steer the vehicle 10 on the ground, use the work implement 18, and control other aspects of the vehicle 10. For example, the user interface comprises an accelerator, a brake control, and a steering device that can be used by the operator to control motion of the vehicle 10 on the ground, as well as controls to operate the work implement 18. The user interface may also comprise an instrument panel (e.g., a dashboard) which provides indicators (e.g., a speedometer indicator, a tachometer indicator, etc.) to convey information to the operator. In other embodiments in which the vehicle 10 is an autonomous vehicle, the operator cabin 20 may not comprise a user interface.

The work implement 18 is operable to perform work. In this embodiment, the work implement 18 comprises a bucket for moving soil, debris or other material. In this example, the vehicle 10 comprises support arms 19₁, 19₂ carrying the work implement 18 and mounted to a rear part 21 of the frame 12 so that they extend forwardly pass the operator cabin 20. In other embodiments, the work implement 18 may comprise a dozer blade, a backhoe, a fork, a grapple, a scraper pan, an auger, a saw, a ripper, a material-handling arm, or any other type of work implement. In still other embodiment, the vehicle 10 may not comprise a work implement.

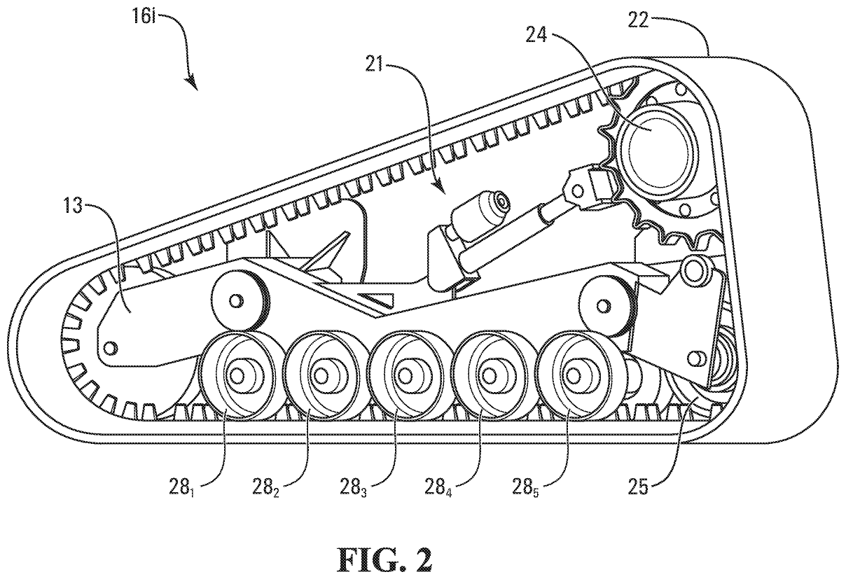

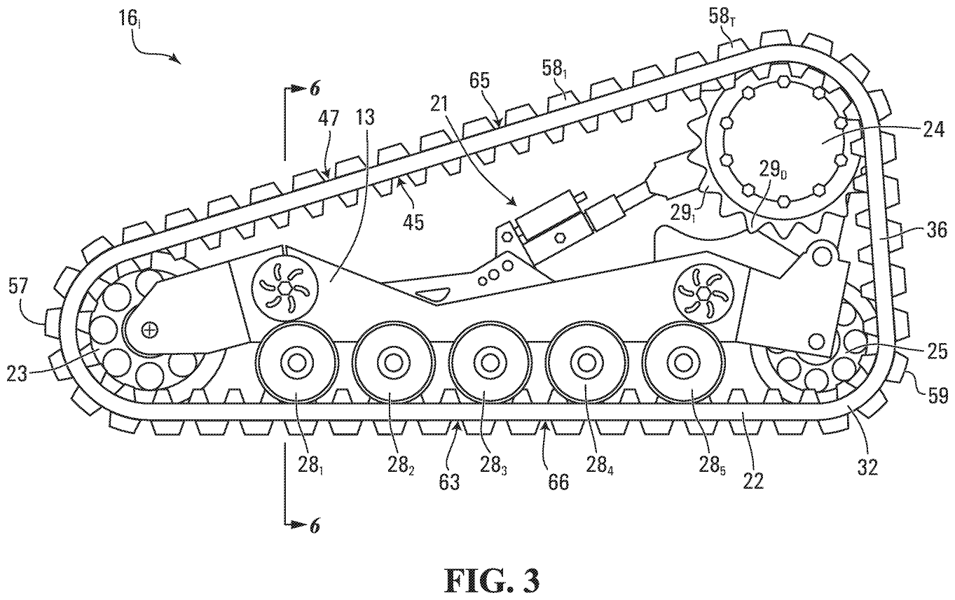

The track systems 16₁, 16₂ engage the ground to propel the vehicle 10. With additional reference to FIGS. 2 and 3, each track system 16ᵢ comprises a track-engaging assembly 21 and the track 22 disposed around the track-engaging assembly 21. In this embodiment, the track-engaging assembly 21 comprises a plurality of wheels which, in this example, includes a drive wheel 24 and a plurality of idler wheels that includes a front (i.e., leading) idler wheel 23, a rear (i.e., trailing) idler wheel 25, and roller wheels 28₁-28₁₀. The track system 16ᵢ also comprises a frame 13 which supports various components of the track system 16ᵢ, including the wheels 24, 23, 25, 28₁-28₁₀. In this embodiment, the vehicle 10 can be steered by operating the track systems 16₁, 16₂ differently, such as by moving their tracks 22 at different speeds and/or in different directions.

The track system 16ᵢ has a longitudinal direction and a front longitudinal end 57 and a rear longitudinal end 59 that define a length of the track system 16ᵢ along a longitudinal axis 61 that defines the longitudinal direction of the track system 16ᵢ. The track system 16ᵢ has a widthwise direction and a width that is defined by a width W_{T} of the track 22. The track system 16ᵢ also has a heightwise direction that is normal to its longitudinal and widthwise directions.

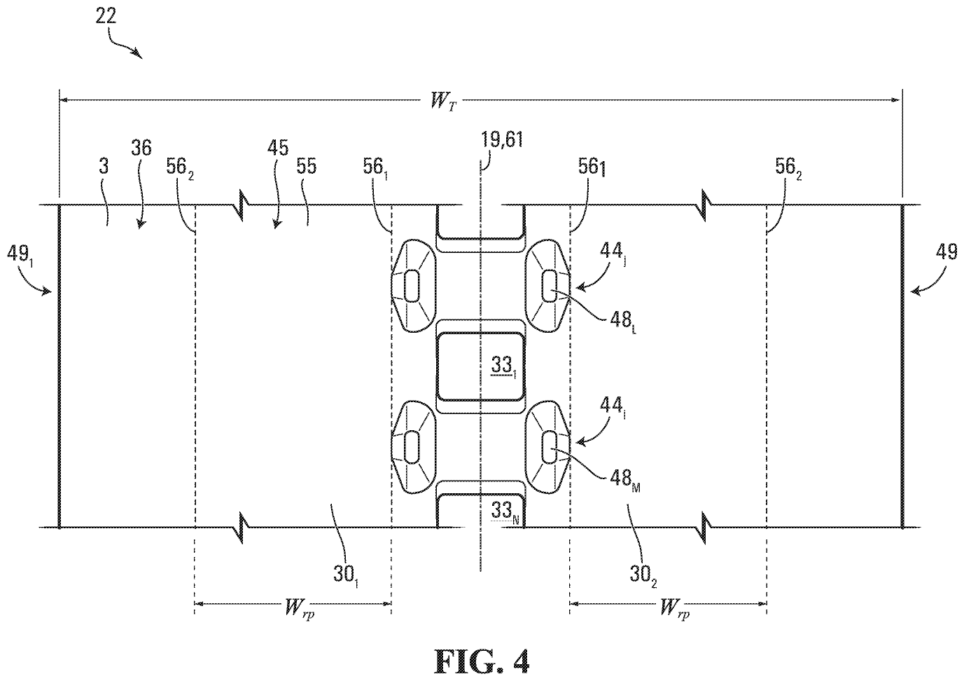

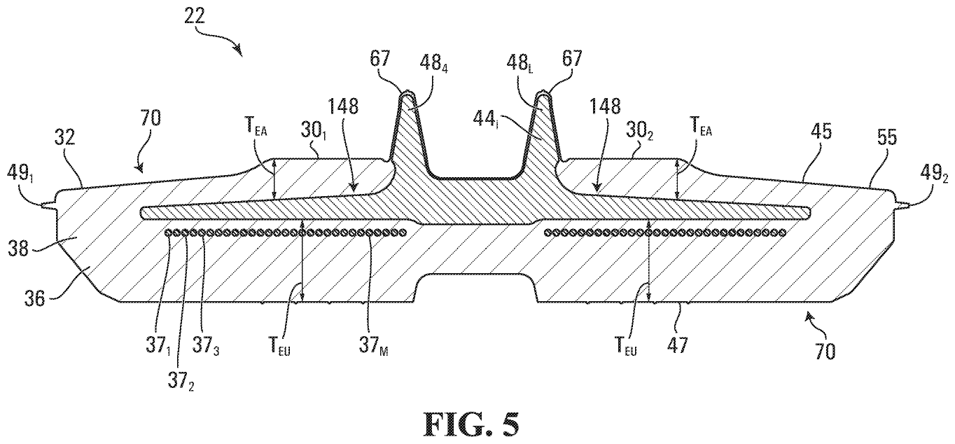

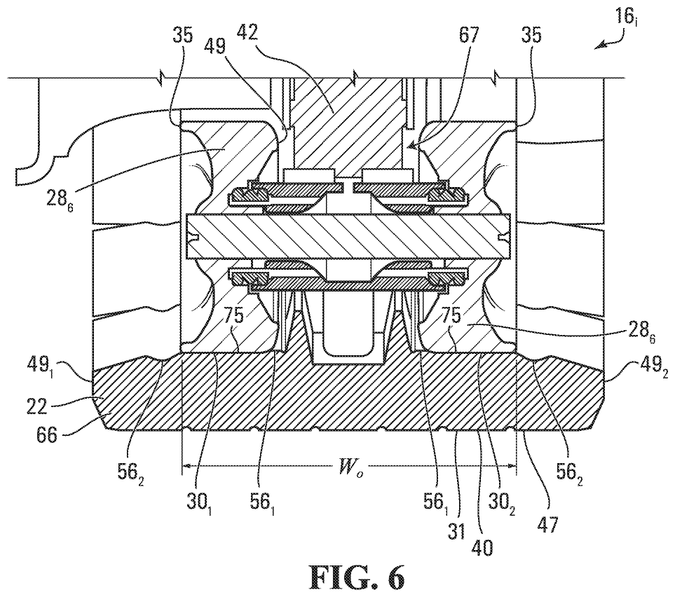

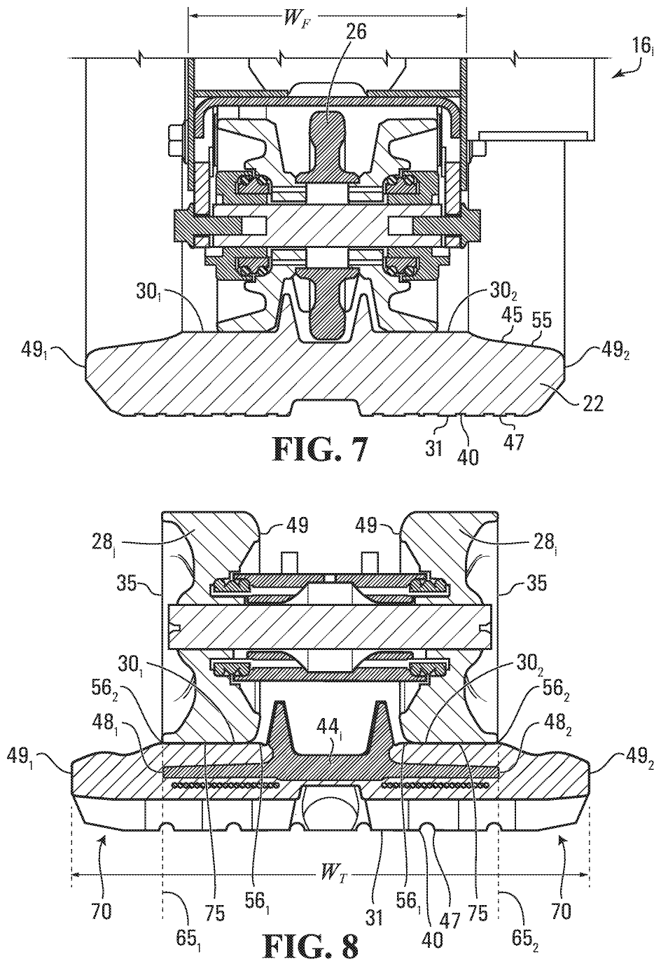

The track 22 engages the ground to provide traction to the vehicle 10. A length of the track 22 allows the track 22 to be mounted around the track-engaging assembly 21. In view of its closed configuration without ends that allows it to be disposed and moved around the track-engaging assembly 21, the track 22 can be referred to as an “endless” track. With additional reference to FIGS. 4 to 6, the track 22 comprises an inner side 45, a ground-engaging outer side 47, and lateral edges 49₁, 49₂. The inner side 45 faces the wheels 24, 23, 25, 28₁-28₁₀, while the ground-engaging outer side 47 engages the ground. A top run 65 of the track 22 extends between the longitudinal ends 57, 59 of the track system 16ᵢ and over the wheels 24, 23, 25, 28₁-28₁₀, whereas a bottom run 66 of the track 22 extends between the longitudinal ends 57, 59 of the track system 16ᵢ and under the wheels 24, 23, 25, 28₁-28₁₀. The bottom run 66 of the track 22 defines an area of contact 63 of the track 22 with the ground which generates traction and bears a majority of a load on the track system 16ᵢ, and which will be referred to as a “contact patch” of the track 22 with the ground. The track 22 has a longitudinal axis 19 which defines a longitudinal direction of the track 22 (i.e., a direction generally parallel to its longitudinal axis) and transversal directions of the track 22 (i.e., directions transverse to its longitudinal axis), including a widthwise direction of the track 22 (i.e., a lateral direction generally perpendicular to its longitudinal axis). The track 22 has a thicknesswise direction normal to its longitudinal and widthwise directions.

The track 22 is elastomeric, i.e., comprises elastomeric material 32, to be flexible around the track-engaging assembly 21. The elastomeric material 32 of the track 22 can include any polymeric material with suitable elasticity. In this embodiment, the elastomeric material of the track 22 includes rubber. Various rubber compounds may be used and, in some cases, different rubber compounds may be present in different areas of the track 22. In other embodiments, the elastomeric material 32 of the track 22 may include another elastomer in addition to or instead of rubber (e.g., polyurethane elastomer).

More particularly, the track 22 comprises an endless body 36 underlying its inner side 45 and ground-engaging outer side 47. In view of its underlying nature, the body 36 will be referred to as a “carcass”. The carcass 36 is elastomeric in that it comprises elastomeric material 38 which allows the carcass 36 to elastically change in shape and thus the track 22 to flex as it is in motion around the track-engaging assembly 21.

In this embodiment, the track 22 comprises internal reinforcements disposed in its elastomeric material 32, including the elastomeric material 38 of the carcass 36.

For instance, in this embodiment, a plurality of cores 44₁-44_{N} are disposed in the elastomeric material 38 of the carcass 36. The cores 44₁-44_{N}, which may in some cases also be referred to as “inserts”, are distributed along and extend transversally to the longitudinal direction of the track 22 to impart transverse rigidity to the track 22. The cores 44₁-44_{N} may also help to drive the track 22 by engagement with the drive wheel 24 and/or guide the track 22 by contacting the wheels 23, 25, 28₁-28₁₀ as the track 22 is driven by the drive wheel 24.

Each core 44ᵢ is embedded in the elastomeric material 38 of the carcass 36 in that at least a substantial part of the core 44ᵢ is disposed in the elastomeric material 38 of the carcass 36. In some cases, an entirety of the core 44ᵢ may be covered by the elastomeric material 32 of the track 22 (e.g., when the track 22 is new). In other cases, a portion of the core 44ᵢ may be exposed and uncovered by the elastomeric material 32 of the track 22 (e.g., when the track 22 has undergone degradation during use). The core 44ᵢ may comprise metal (e.g., steel) that may be forged, cast or otherwise formed into shape. In some cases, the core 44ᵢ may thus be referred to as a “metal bar” or “metal core”.

In this embodiment, the carcass 36 comprises a layer of reinforcing cables 37₁-37_{M} that are adjacent to one another and extend generally in the longitudinal direction of the track 22 to enhance strength in tension of the track 22 along its longitudinal direction. In this case, each of the reinforcing cables 37₁-37_{M} is a cord including a plurality of strands (e.g., textile fibers or metallic wires). In other cases, each of the reinforcing cables 37₁-37_{M} may be another type of cable and may be made of any material suitably flexible along the cable's longitudinal axis (e.g., fibers or wires of metal, plastic or composite material).

Also, in other embodiments, the carcass 36 comprises a layer of reinforcing fabric. The reinforcing fabric comprises thin pliable material made usually by weaving, felting, knitting, interlacing, or otherwise crossing natural or synthetic elongated fabric elements, such as fibers, filaments, strands and/or others, such that some elongated fabric elements extend transversally to the longitudinal direction of the track 22 to have a reinforcing effect in a transversal direction of the track 22. For instance, the reinforcing fabric may comprise a ply of reinforcing woven fibers (e.g., nylon fibers or other synthetic fibers).

The carcass 36 may be molded into shape in a molding process during which the rubber 38 is cured. For example, in this embodiment, a mold may be used to consolidate layers of rubber providing the rubber 38 of the carcass 36, the cores 44₁-44_{N}, and the reinforcing cables 37₁-37_{M}.

The inner side 45 of the track 22 comprises an inner surface 55 of the carcass 36 and a plurality of wheel-contacting projections 48₁-48_{N} that project from the inner surface 55 and are positioned to contact respective ones of the wheels 23, 25, 28₁-28₁₀ to do at least one of guiding the track 22 and driving (i.e., imparting motion to) the track 22.

Since each of them is used to do at least one of guiding the track 22 and driving the track 22, the wheel-contacting projections 48₁-48_{N} can be referred to as “guide/drive projections”. In this embodiment, each guide/drive projection 48ᵢ interacts with respective ones of the idler wheels 23, 25, 28₁-28₁₀ to guide the track 22 to maintain proper track alignment and prevent de-tracking without being used to drive the track 22, in which case the guide/drive projection 48ᵢ is a guide projection. In other embodiments, a guide/drive projection 48ᵢ may interact with the drive wheel 24 to drive the track 22, in which case the guide/drive projection 48ᵢ is a drive projection. In yet other embodiments, a guide/drive projection 48ᵢ may both (i) interact with the drive wheel 24 to drive the track and (ii) interact with respective ones of the idler wheels 23, 25, 28₁-28₁₀ to guide the track 22 to maintain proper track alignment and prevent de-tracking, in which case the guide/drive projection 48ᵢ is both a drive projection and a guide projection.

In this embodiment, each guide projection 48ᵢ comprises elastomeric material 67 overlying a given one of the cores 44₁-44_{N}. The elastomeric material 67 can be any polymeric material with suitable elasticity. More particularly, in this embodiment, the elastomeric material 67 includes rubber. Various rubber compounds may be used and, in some cases, different rubber compounds may be present in different areas of the drive/guide projection 48ᵢ. The elastomeric material 67 of the guide projection 48ᵢ may be provided on the inner side 45 of the track 22 in various ways. For example, in this embodiment, the elastomeric material 67 of the guide projection 48ᵢ is provided by being molded with the carcass 36.

The inner side 45 of the track 22 comprises rolling paths 30₁, 30₂ on which the roller wheels 28₁-28₁₀ roll to apply the bottom run 66 of the track 22 onto the ground. For example, a peripheral surface 75 of each roller wheel 28ᵢ between an outer lateral surface 35 and an inner lateral surface 49 of the roller wheel 28ᵢ is in rolling contact with a given one of the rolling paths 30₁, 30₂ of the track 22. Each of the rolling paths 30₁, 30₂ of the track 22 comprises an inner lateral edge 561 and an outer lateral edge 562 that define a width Wᵣₚ of that rolling path.

The ground-engaging outer side 47 of the track 22 comprises a ground-engaging outer surface 31 of the carcass 36 and a tread pattern 40 to enhance traction on the ground. The tread pattern 40 comprises a plurality of traction projections 58₁-58_{T} projecting from the ground-engaging outer surface 31, spaced apart in the longitudinal direction of the track 22 and engaging the ground to enhance traction. The traction projections 58₁-58_{T} may be referred to as “tread projections” or “traction lugs”. The traction lugs 58₁-58_{T} may have any suitable shape (e.g., curved shapes, shapes with straight parts and curved parts, etc.).

In this embodiment, each traction lug 58ᵢ is an elastomeric traction lug in that it comprises elastomeric material 41. The elastomeric material 41 can be any polymeric material with suitable elasticity. More particularly, in this embodiment, the elastomeric material 41 includes rubber. Various rubber compounds may be used and, in some cases, different rubber compounds may be present in different areas of the traction lug 58ᵢ. In other embodiments, the elastomeric material 41 may include another elastomer in addition to or instead of rubber (e.g., polyurethane elastomer).

The traction lugs 58₁-58_{T} may be provided on the ground-engaging outer side 47 of the track 22 in various ways. For example, in this embodiment, the traction lugs 58₁-58_{T} are provided on the ground-engaging outer side 47 of the track 22 by being molded with the carcass 36.

The drive wheel 24 is rotatable by power derived from the powertrain 15 to drive the track 22. In this embodiment, the drive wheel 24 is a drive sprocket comprising a plurality of drive members 29₁-29_{D} spaced apart circumferentially to engage the drive portion 52 of each of the cores 44₁-44_{N} in order to drive the track 22 (e.g., a “positive drive” arrangement). In this example, the track 22 comprises drive voids 39₁-39_{V} (e.g., recesses or holes) to receive the drive members 29₁-29_{D} of the drive wheel 24.

The idler wheels 23, 25, 28₁-28₁₀ are not driven by power supplied by the powertrain 15, but are rather used to do at least one of supporting part of a weight of the vehicle 10 on the ground via the track 22, guiding the track 22 as it is driven by the drive wheel 24, and tensioning the track 22. More particularly, in this embodiment, the front and rear idler wheel 23, 25 maintain the track 22 in tension and help to support part of the weight of the vehicle 10 on the ground via the track 22. The roller wheels 28₁-28₁₀ roll on the rolling paths 30₁, 30₂ of the track 22 along the bottom run 66 of the track 22 to apply it onto the ground.

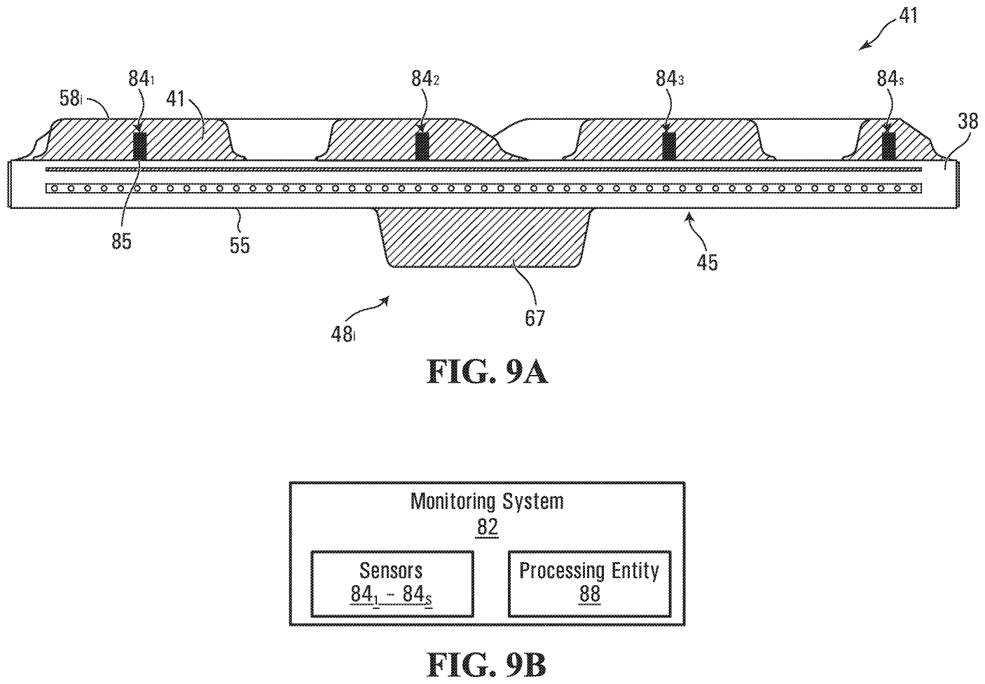

In this embodiment, with additional reference to FIGS. 9A and 9B, a monitoring system 82 is configured to monitor the vehicle 10, including the track systems 16₁, 16₂, to obtain information regarding the vehicle 10, such as information regarding the track systems 16₁, 16₄, that can be used for various purposes, such as, for example, to: convey the information to a user (e.g., the operator); control the vehicle 10 (e.g., a speed of the vehicle 10, operation of the work implement 18, etc.); transmit the information to a remote party (e.g., a provider such as a manufacturer or distributor of the track systems 16₁, 16₂, the track 22 and/or another component thereof, and/or of the vehicle 10, etc.); etc. This may be useful, for example, to gain knowledge about the vehicle 10, the track systems 16₁, 16₂, and/or their environment to enhance efficiency of work performed by the vehicle 10, help prevent rapid wear or other deterioration of the track system 16ᵢ, facilitate maintenance (e.g., replacement or repair) of the track 22 and/or other components of the track system 16ᵢ, and/or for various other reasons.

The information regarding the vehicle 10 that is obtained by the monitoring system 82 may include information regarding each track system 16ᵢ, which may be intrinsic or extrinsic to the track system 16ᵢ.

For example, in some embodiments, the information regarding the track system 16ᵢ that is obtained by the monitoring system 82 may include one or more parameters of the track system 16ᵢ. For instance, in some embodiments, this may include one or more parameters of the track 22 of the track system 16ᵢ, such as:
an indication of deterioration of the track 22 or another component (e.g., a given one of the wheels 24, 23, 25, 28₁-28₁₀) of the track system 16ᵢ (e.g., an indication of a level of wear, a rupture, a break, etc.);
an identifier of the track 22, such as a serial number, a make, a model, a type, and/or any other information identifying the track 22 (i.e., indicating an identity of the track 22);
an identifier of a given one of the wheels 24, 23, 25, 28₁-28₁₀ of the track system 16ᵢ, such as a serial number, a make, a model, a type, and/or any other information identifying the given one of the wheels 24, 23, 25, 28₁-28₁₀ (i.e., indicating an identity of the given one of the wheels 24, 23, 25, 28₁-28₁₀); and/or
any other information about the track system 16ᵢ.

As another example, additionally or alternatively, in some embodiments, the information regarding the track system 16ᵢ that is obtained by the monitoring system 82 may include one or more characteristics of the environment of the track system 16ᵢ. For instance, in some embodiments, this may include one or more characteristics of the ground beneath the track system 16ᵢ, such as:
a compliance (e.g., softness or hardness) of the ground;
a soil moisture level of the ground;
a profile (e.g., a slope or steepness or a levelness) of the ground;
a chemical parameter (e.g., a soil pH, composition, presence of a particular element or ion, concentration, etc.) of the ground; and/or
any other information about the ground.

In this embodiment, the monitoring system 82 comprises a plurality of sensors 84₁-84ₛ for monitoring the vehicle 10, including the track systems 16₁, 16₂, and a processing entity 88 for performing certain actions based on input from the sensors 84₁-84ₛ. For example, in various embodiments, actions performed by the processing entity 88 based on input from the sensors 84₁-84ₛ may include an action to convey the information regarding the vehicle 10 (e.g., the information regarding each track system 16ᵢ), an action to store the information regarding the vehicle 10, and/or an action relating to the operation of the vehicle 10, such as, for example, controlling the speed and/or another operational aspect of the vehicle 10 and/or providing information to the operator of the vehicle 10.

Each of the sensors 84₁-84ₛ is configured to sense a physical aspect of the vehicle 10, such as of each of the track systems 16₁, 16₂, or of the environment of the vehicle 10, such as of each of the track systems 16₁, 16₂ (e.g., the ground beneath or around each of the track systems 16₁, 16₂) to issue a sensor signal derived based on the physical aspect that is sensed. Each of the sensors 84₁-84ₛ comprises a sensing device 85 to sense the physical aspect of the vehicle 10 or the environment of the vehicle 10 that is sensed.

In this embodiment, as shown in FIG. 9A, a sensor 84ₓ may be part of the track 22 of a track system 16ᵢ. For instance, in this embodiment, the sensor 84ₓ is embedded within the elastomeric material of the track 22. This may allow degradation of the elastomeric material to be detected by the sensor 84ₓ. For example, in embodiments where the sensor 84ₓ is to detect degradation of the track, the sensor 84ₓ may be located in an area of increased degradation within the track 22, such as an area close to the surface of the elastomeric material of the track 22. More particularly, in this embodiment, the sensor 84ₓ is disposed within the elastomeric material 41 of a traction lug 58ᵢ.

In this example, respective ones of the sensors 84₁-84ₛ are disposed in the elastomeric material 69 of respective ones of the traction lugs 58₁-58_{T}. As such, an amount of degradation of the elastomeric material of each traction lug 58ᵢ can be detected. Although it is possible to have a sensor 84ₓ within each traction lug 58ᵢ, this may not be the case in some embodiments. For example, in this embodiment, three or four of the sensors 84₁-84ₛ provided within respective ones of the traction lugs 58₁-58_{T} may enable assessment of degradation to the track 22. In other cases, the track 22 may include only a single sensor 84ₓ (e.g., in only a single one of the traction lugs 58₁-58_{T}).

The sensor 84ₓ may be provided and retained within the elastomeric material 69 of the traction lug 58ᵢ in various ways. For instance, in some embodiments, the sensor 84ₓ is placed in a mold used for molding of the track 22 (including the carcass 36, the drive/guide lugs 48₁-48_{N} and the traction lugs 58₁-58_{T}) and the elastomeric material 69 is molded over the sensor 84ₓ. For example, this may involve disposing a first layer of elastomeric material (e.g., destined to form part of the elastomeric material 38 of the carcass 36 or the elastomeric material 69 of the traction lugs 58₁-58_{T}) within the mold, positioning the sensor 84ₓ on the first layer of elastomeric material, and disposing a second layer of elastomeric material (e.g., destined to form part of the elastomeric material 69 of the traction lugs 58₁-58_{T}) on top of the first layer of elastomeric material such as to effectively sandwich the sensor 84ₓ between the first and second layers of elastomeric material.

In some embodiments, an adhesive may be used to help retention of the sensor 84ₓ in elastomeric material (e.g., in the elastomeric material 69 of the traction projection 58ᵢ and/or in the elastomeric material 38 of the carcass 36). For example, the adhesive may be a metal-to-elastomer adhesive such as Chemlok™ or any other suitable metal-to-elastomer adhesive.

In some cases, the sensor 84ₓ may be inserted into the elastomeric material 69 of the traction lug 58ᵢ after molding of the elastomeric material 69 of the traction lug 58ᵢ. For example, in a post-molding operation, the traction lug 58ᵢ may be opened (e.g., via drilling a hole or making an incision) and the sensor 84ₓ inserted into the elastomeric material 69 of the traction lug 58ᵢ. The traction lug 58ᵢ may be sealed thereafter. In such cases, the sensor 84ₓ may be retained in the traction lug 58ᵢ by overmolding (i.e., molding a layer of elastomeric material on top of an already molded layer of elastomeric material), by friction (e.g., a press-fit), by an adhesive, or by a fastener.

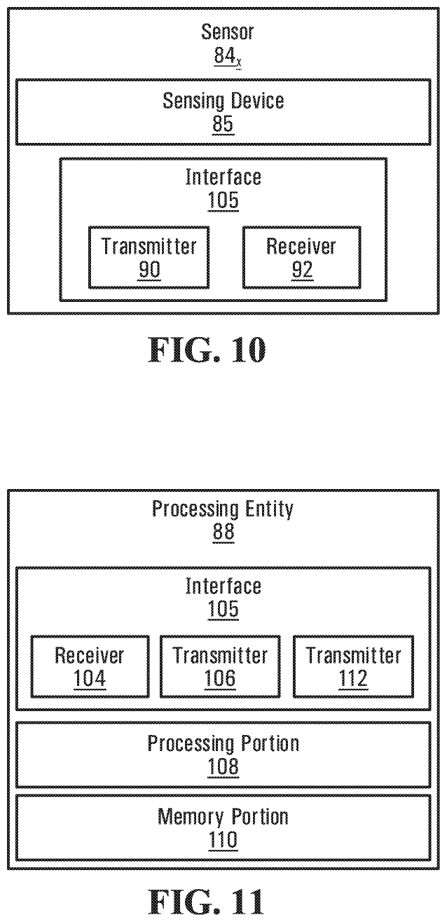

With reference to FIG. 10, the sensor 84ₓ may comprise an interface 105 comprising a transmitter 90 for issuing a detection signal indicative of the physical aspect of the track 22 that is detected. In this embodiment, the transmitter 90 is configured for transmitting the detection signal to the processing entity 88, which comprises a receiver 104 to receive the detection signal from the sensor 84ₓ. The sensor 84ₓ further comprises a sensing device, arranged to affect a physical characteristic of the sensor 84ₓ once a characteristic of the track system component is altered. For example, and as described in more detail below, in some embodiments, the sensing device 85 can be arranged to detect an electrical change (e.g., a current flowing and/or a voltage variation in an electrical circuit) caused by physical degradation of the track 22 or another track system component, such as a sprocket.

The transmitter 90 of the sensor 84ₓ and the receiver 104 of the processing entity 88 may be connected in any suitable way. In this embodiment, the sensor 84ₓ and the processing entity 88 are connected wirelessly. Thus, in this embodiment, the transmitter 90 of the sensor 84ₓ is a wireless transmitter that can wirelessly transmit the detection signal and the receiver 104 of the processing entity 88 is a wireless receiver that can wirelessly receive the detection signal.

The sensor 84ₓ may be disposed such that the detection signal issued by the sensor 84ₓ has a signal strength sufficient to overcome a thickness of elastomeric material of the track 22 and the interference created by the metallic cables and metal bars along a path of the sensor signal.

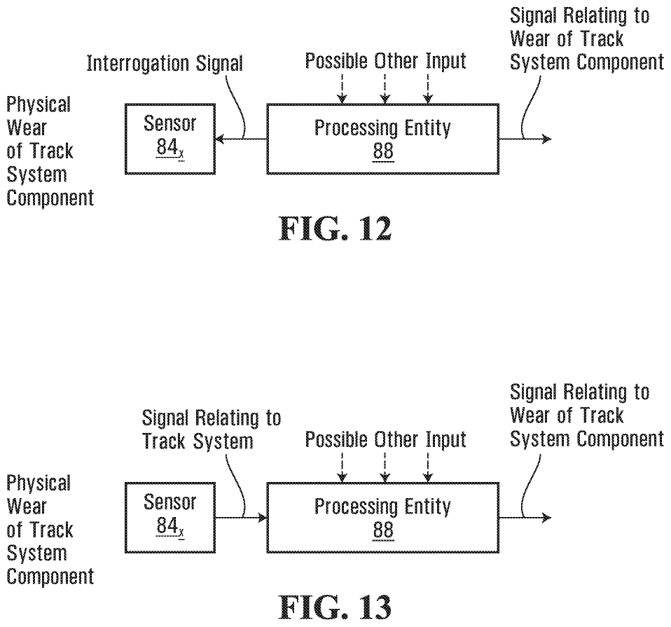

The detection signal may be issued by the sensor 84ₓ in any suitable manner in various embodiments. For example, in this embodiment, as shown in FIG. 12, the processing entity 88 is configured to issue an interrogation signal directed to the sensor 84ₓ, which is configured to issue the sensor signal to the processing entity 88 in response to the interrogation signal. Thus, in this embodiment, the processing entity 88 comprises a transmitter 106 to transmit the interrogation signal to the sensor 84ₓ, the interface 105 of which comprises a receiver 92 to receive the interrogation signal. In this case, the transmitter 106 of the processing entity 88 is a wireless transmitter to wirelessly transmit the interrogation signal and the receiver 92 of the interface 105 of sensor 84ₓ is a wireless receiver to wirelessly receive the interrogation signal. In some examples of implementation, the transmitter 90 and the receiver 92 of the sensor 84ₓ may be implemented by a transceiver and/or the transmitter 106 and the receiver 104 of the processing entity 88 may be implemented by a transceiver.

More particularly, in this embodiment, the sensor 84ₓ and the processing entity 88 implement radio-frequency identification (RFID) technology to communicate, including to wirelessly transmit the sensor signal from the sensor 84ₓ to the processing entity 88. In this case, the transmitter 90 and the receiver 92 of the sensor 84ₓ implement an RFID element (e.g., an RFID tag) and the transmitter 106 and the receiver 104 of the processing entity 88 implement an RFID element (e.g., an RFID reader).

The RFID element implemented by the transmitter 90 and the receiver 92 of the sensor 84ₓ may be a passive RFID tag that is powered by the interrogation signal of the RFID element implemented by the transmitter 106 and the receiver 104 of the processing entity 88, which may be an active RFID reader. That is, the RFID tag implemented by the transmitter 90 and the receiver 92 of the sensor 84ₓ is electromagnetically powered by the interrogation signal of the RFID reader implemented by the transmitter 106 and the receiver 104 of the processing entity 88. The power generated through this interaction may then be used by the RFID tag to issue the sensor signal.

In this example of implementation, the RFID tag implemented by the transmitter 90 and the receiver 92 of the sensor 84ₓ enables the detection entity 140 of the sensor 84ₓ to make a reading of the physical aspect of the sensing device 85 in the track 22. More specifically, when the RFID tag is powered by the interrogation signal of the RFID reader, at least part of the power is routed to the detection entity 140 in order for the detection entity 140 to make a reading of the sensing device 85. The transmitter 90 then issues the detection signal the RFID reader implemented by the transmitter 106 and the receiver 104 of the processing entity 88.

In other embodiments, the sensor 84ₓ may be configured to issue the detection signal to the processing entity 88 autonomously (i.e., without receiving any interrogation signal). For instance, in some embodiments, such as the one shown in FIG. 13, the transmitter 94 of the sensor 84ₓ may issue the detection signal to the processing entity 88 repeatedly (e.g., periodically or at some other predetermined instants).

For instance, in other embodiments, the RFID element implemented by the transmitter 90 and the receiver 92 of the sensor 84ₓ may be an active RFID tag or a battery-assisted passive (BAP) RFID tag.

For example, an active RFID tag implemented by the transmitter 90 and the receiver 92 of the sensor 84ₓ has its own power source (e.g., a battery) to enable the entire functionality of the active RFID tag. That is, the active RFID tag's power source enables the sensor 84ₓ to make a reading of the physical degradation of the track 22 that is detected by the sensor 84ₓ and also enables the transmitter 94 to issue the detection signal to the RFID reader (i.e., the processing entity 88). Thus, in this case, the active RFID tag can implement its functions independently of the RFID reader. In such a case, the power source (i.e., the battery) of the active RFID tag may be configured to provide power to the RFID tag for an amount of time at least as great, and in some cases greater, than a lifetime of the track 22 (i.e., a span of time that the track 22 is expected to last).

Conversely, a BAP RFID tag's power source (e.g., a battery) only enables part of the BAP RFID tag's functions. For instance, the power source may enable the sensor 84ₓ to record a reading of the physical degradation of the track 22 that is detected by the sensor 84ₓ. However the BAP RFID tag is dependent on the interrogation signal of the RFID reader (i.e., the processing entity 88) to power the transmitter 94 to issue the sensor signal to the processing entity 88.

Therefore, in various embodiments, the sensor 84ₓ may comprise a power source for its operation and/or may harvest energy from its environment (e.g., inductively from an interrogation signal; by a piezoelectric effect; etc.) for its operation.

In this embodiment, the sensor 84ₓ comprises a housing that houses components of the sensor 84ₓ and is configured to protect the sensor 84ₓ (e.g., by preventing intrusion of particles that may be damaging to the sensor 84ₓ, protecting against heat, preventing excessive deformation, etc.).

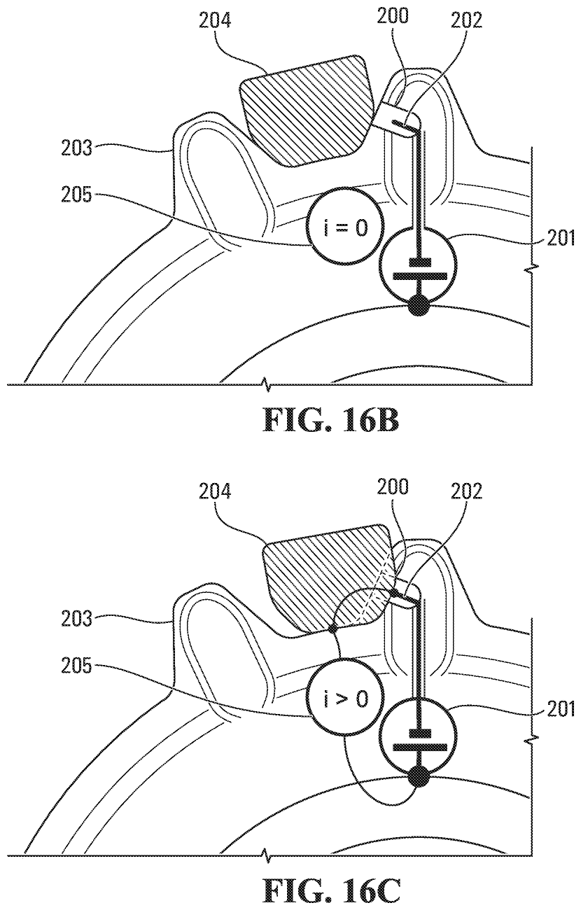

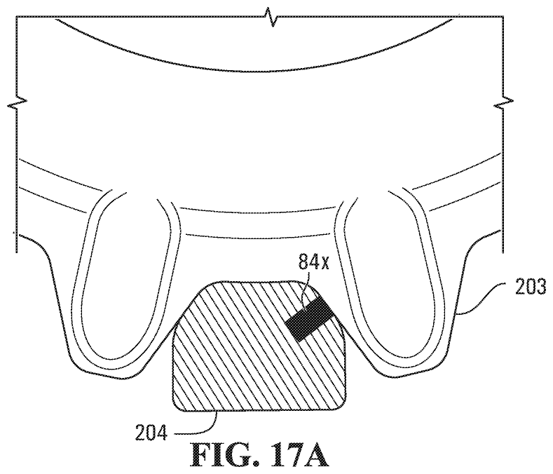

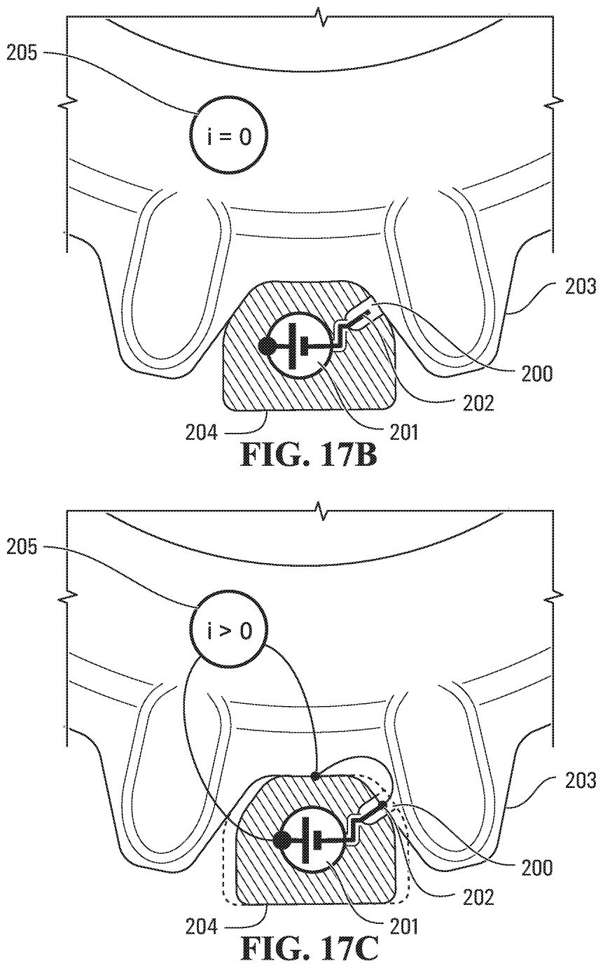

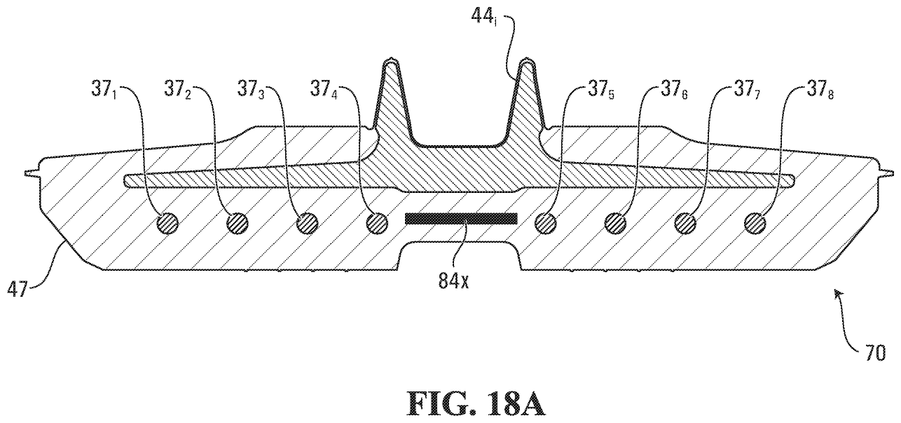

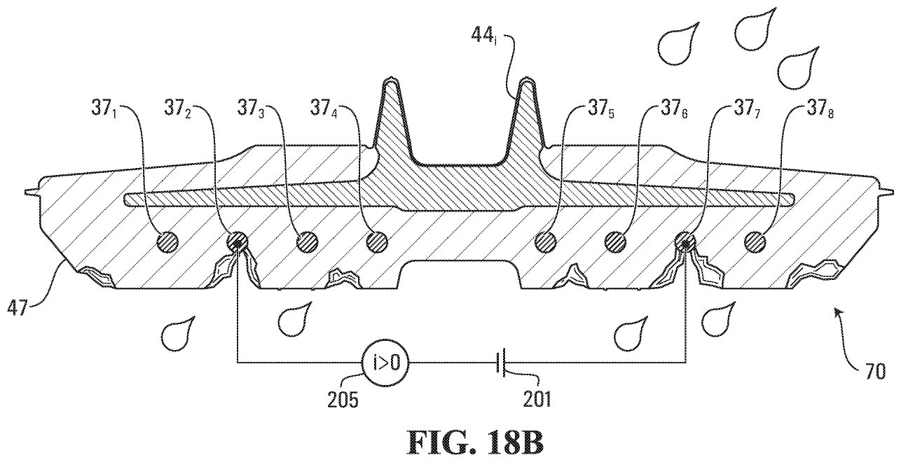

The sensor 84ₓ may be disposed elsewhere on the track 22, or in other components of the track system. For example, in some embodiments, such as those shown in FIGS. 9A and 9B, the sensor 84ₓ may be disposed in the elastomeric material 67 or one or more of the drive/guide lugs. In other embodiments, as shown in FIG. 18A, the sensor 84ₓ may be disposed in the elastomeric material 38 of the carcass 36. In yet other embodiments, as shown in FIG. 16A, the sensor 84ₓ may be disposed in the teeth of the drive wheel 24. In yet other embodiments, as shown in FIG. 17A, the sensor 84ₓ may be disposed in a metal bar 204 of the track system.

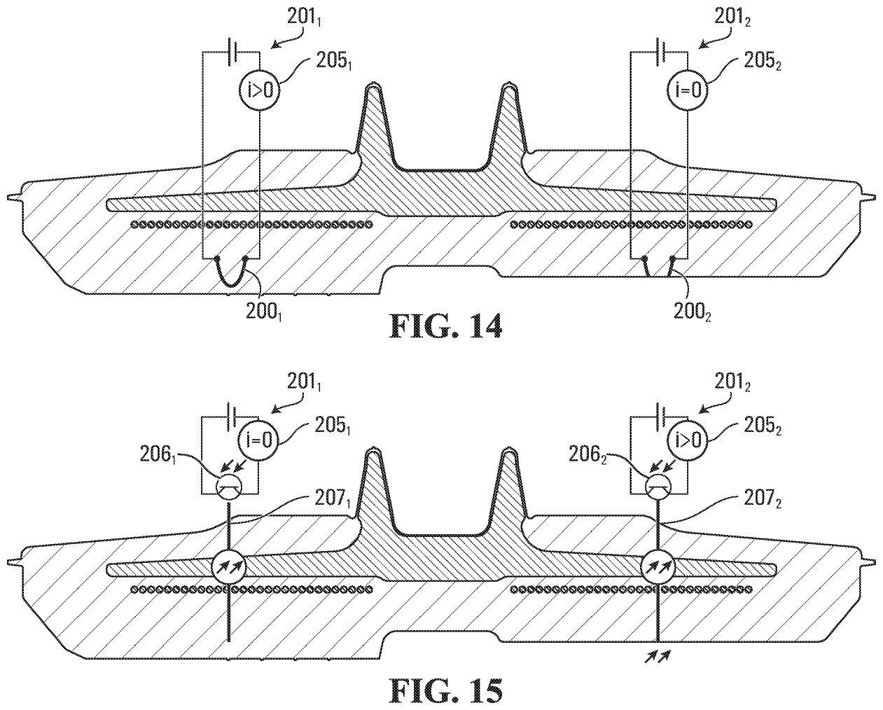

In some embodiments, as set out below with reference to FIGS. 14 to 21, one or more of the sensors 84₁-84ₛ may be arranged to sense a plurality of track system failures or other deteriorations, and to issue corresponding detection signals. Example of such failures or other deteriorations include, but are not limited to, normal track system component degradation, such as tread wear, sprocket wear and core (e.g., metal bar) wear, as well as loss of track carcass integrity, such as punctures, chunking, broken reinforcing cables, reinforcing cable de-bonding and metal bar/core de-bonding.

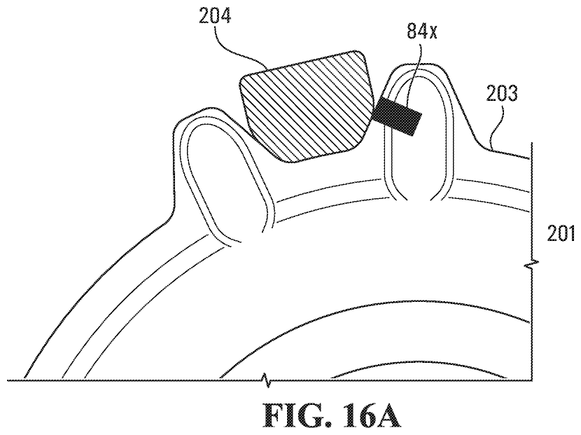

FIGS. 14 and 15 show embodiments for detecting normal tread wear of the elastomeric material 38 of the carcass 36.

With additional reference to FIG. 14, in some embodiments, the sensing device 85 of the sensor 84ₓ comprises an electrical detector 205ₓ configured to detect an electrical change such as a variation in a current flowing or a voltage across the electrical detector 205ₓ. More particularly, in this embodiment, the sensing device 85 comprises a power source 201ₓ, a closed electrical detection circuit having at least one sacrificial part 200ₓ and the electrical detector 205ₓ that is a current detector, all of which are imbedded in the track. The current detector 205ₓ is arranged to measure the current in the electrical detection circuit. The sacrificial part 200ₓ is arranged to break the electrical detection circuit when the track is sufficiently degraded. Accordingly, at least a length of the sacrificial part 200ₓ is located in an area of the track 22 in which degradation is expected, and at a depth to which degradation of the elastomeric material is to be detected. The sacrificial part 200ₓ can be made of any suitable electrically conductive material capable of breaking, snapping, and/or otherwise degrading, to an extent sufficient to open the electrical detection circuit when the elastomeric material of the carcass surrounding at least a piece of the sacrificial part is degraded. Alternatively, the sacrificial part 200ₓ can be made of any suitable electrically conductive material arranged to be dislodged from the track when all or part of the elastomeric material surrounding the sacrificial part 200ₓ is degraded.

In the example shown in FIG. 14, a first section of the ground-engaging side of the track is not degraded, and the sacrificial part 200₁ is intact and completely surrounded by the elastomeric material of the carcass 36. Accordingly, the electrical detection circuit is closed and the power source 201₁ causes the current detector 205₁ to detect a positive current through the electrical circuit. As also shown in FIG. 14, a second section of the ground-engaging part of the track however is degraded, and the sacrificial part 200₂ is no longer intact, having been degraded and/or broken and/or dislodged from the track, along with the surrounding elastomeric material of the carcass. Accordingly, the electrical detection circuit 205₂ is opened and the current detector 205₂ to detects a nil or negligible current value through the electrical detection circuit.

In the example of FIG. 14, the sensor 84ₓ is therefore arranged to issue a detection signal when the elastomeric material of the carcass 36 on the ground engaging side of the track has degraded to a predetermined depth.

As will be appreciated, each of the above components of the sensing device 85 can be replaced with functionally equivalent components. For example, in the present example, the power source 201ₓ is the same power source as that of sensor 84ₓ (e.g. battery, piezo-electric, etc.). In other embodiments however, the power source 201ₓ of sensing device 85 can be different to that of sensor 84ₓ. Moreover, the electrical detector 205ₓ of sensing device 85 could be a voltage detector instead of a current detector. The sensing device 85 could also incorporate any other suitable means of detecting whether the electrical detection circuit has been broken by a degradation of the sacrificial part 200ₓ. In some embodiments, the sacrificial part 200ₓ can be the only part of the sensor that is embedded in the track 22. In other embodiments, however, the entire sensor 84ₓ, or any part thereof, can be embedded in the track 22.

In another embodiment, and with reference to FIG. 15, the sensing device 85 comprises an optical detector 206ₓ configured to detect an optical change such as a variation in light intensity. More particularly, in this embodiment, the sensing device 85 comprises a length of optical fiber 207ₓ that is embedded in the elastomeric material of the track 22, as well as a closed electrical detection circuit including a power source 201ₓ, a current detector 205ₓ and a phototransistor 206ₓ. One end of the optical fiber 207ₓ is located in an area of the carcass in which degradation is expected, and at a depth to which degradation of the elastomeric material is to be detected. The other end of the optical fiber 207ₓ is optically coupled to a phototransistor 206ₓ which is arranged to allow current to flow through the electrical detection circuit when light is introduced into the optical fiber 207ₓ.

In the example shown in FIG. 15, a first section of the ground-engaging side of the track is not degraded, and the optical fiber 207₁ is completely surrounded by the elastomeric material of the carcass 36. Accordingly, negligible amount of light is captured by the optical fiber 207₁ and the phototransistor 206₁ is in a cut-off state. The electrical detection circuit is therefore open and the current detector 205₁ detects a nil or negligible current value through the electrical detection circuit. As also shown in FIG. 15, a second section of the ground-engaging part of the track however is degraded, and part of the optical fiber 207₂ is exposed. Despite typically being covered with debris (e.g., soil, mud, sand, ice, snow, etc.), the exposed portion of optical fiber 207₂ receives more light than in a state of being completely embedded in the elastomeric material of the carcass 36. This difference in the amount of light being received is detected by the phototransistor 50205₂. Accordingly, the electrical detection circuit 205₂ is closed and the current detector 205₂ detects an increase in the current value through the electrical detection circuit.

In the example of FIG. 15, the sensor 84ₓ is therefore arranged to issue a detection signal when the elastomeric material of the carcass 36 on the ground engaging side of the track has degraded to a predetermined depth.

As will be appreciated, each of the above components of the sensing device 85 can be replaced with functionally equivalent components. For example, in the present example, the power source 201ₓ is the same power source as that of sensor 84ₓ (e.g. battery, piezo-electric, etc.). In other embodiments however, the power source 201ₓ of sensing device 85 can be different to that of sensor 84ₓ. Moreover, the sensing device 85 could be arranged to incorporate a voltage detector instead of incorporating a current detector 205ₓ. Moreover, the optical components of the above-described embodiment can be replaced with functionally equivalent components. For example, the current detector 205ₓ and the phototransistor 206ₓ could be replaced with another photosensitive detector, such as a single-pixel charge-coupled device (CCD), or any other suitably sensitive light sensor.

FIGS. 16A to 16C shows embodiments in which a wheel (e.g., the drive wheel 24) of the track system which is a sprocket 203 comprises a sensor 84ₓ for detecting normal wear of a sprocket tooth of the sprocket 203. With reference to FIG. 16B, the sensing device 85 of the sensor 84ₓ comprises an encapsulated power source 201, a current detector 205, an encapsulated wire 202, and an electrically insulating sacrificial part 200 electrically coupled to the encapsulated wire 202 which runs partway through sacrificial part 200. The sacrificial part is located in an area of the sprocket tooth in which degradation is expected, and one end of the encapsulated wire 202 embedded in the sacrificial part 200 is located at a depth to which degradation of the sacrificial part 200 (and surrounding sprocket material) is to be detected. The other side of the power source 201 is connected to a metal part of the sprocket 203 that is electrically connected to at least the sprocket tooth in which the sensor 84ₓ is located.

With further reference to FIG. 16B, a core 44ᵢ of the track 22 is a metal bar 204 and can be used to drive the sprocket 203, or can be driven by the sprocket 203. When the sprocket 203 sustains little or no degradation, the encapsulated wire 202 is not in electrical contact with the metal bar 204. Accordingly, the current flowing from one terminal of the power source 201, through the electrical wire 202, across the metal bar 204 and back through the sprocket 203 to the other end of the power source 201 is nil or negligible. Thus, the current detector 205 detects a nil or negligible current.

With reference to FIG. 16C, when the material of the sprocket 203 is sufficiently degraded, by frictional forces between the sprocket 203 and the metal bar 204, or otherwise, the material of the electrically insulating sacrificial part 200 also becomes degraded. When the electrically insulating sacrificial part 200 becomes sufficiently degraded, the encapsulated wire 202 comes into electrical contact with the metal bar 204. Accordingly, a current begins to flow from one terminal of the power source 201, through the electrical wire 202, across the metal bar 204 and back through the sprocket 203 to the other end of the power source 201, and is detected by current detector 205. Thus, the sensor device 85 can detect degradation of sprocket 203.

In the example of FIGS. 16A to 16C, the sensor 84ₓ is therefore arranged to issue a detection signal when a portion of the sprocket has degraded to a predetermined depth.

As will be appreciated, each of the above components of the sensing device 85 can be replaced with functionally equivalent components. For example, in the present example, the power source 201 is the same power source as that of sensor 84ₓ (e.g. battery, piezo-electric, etc.). In other embodiments however, the power source 201 of sensing device 85 can be different to that of sensor 84ₓ. Moreover, the sensing device 85 could be arranged to incorporate a voltage detector instead of incorporating a current detector 205. The sensing device 85 could also incorporate any other suitable means of detecting whether the electrical detection circuit has been closed by a degradation of the sacrificial part 200 and subsequent contact of the encapsulated wire 202 with the metal bar 204. Moreover, the encapsulated wire 202 can be made of any suitable material, or could be replaced with any other suitable electrically conductive component. Furthermore, the electrically insulating sacrificial part 200 can be made of any suitable material, or could be replaced with any other suitable electrically insulating component.

FIGS. 17A to 17C show embodiments in which the track 22 comprises a sensor 84ₓ for detecting normal wear of a core 44ᵢ of the track 22 which is a metal bar 204 that engaged sprocket teeth of a wheel (e.g., the drive wheel 24) of the track system that is a sprocket 203.

With reference to FIG. 17B, the sensor 84ₓ is embedded in the metal bar 204 and its sensing device 85 has an encapsulated power source 201, a current detector 205, an encapsulated wire 202, and an electrically insulating sacrificial part 200 electrically coupled to the encapsulated wire 202 which runs partway through sacrificial part 200.

The sacrificial part is located in an area of the metal bar in which degradation is expected, and one end of the encapsulated wire 202 embedded in the sacrificial part 200 is located at a depth to which degradation of the sacrificial part 200 (and surrounding metal bar) is to be detected. The other side of the power source 201 is connected to a metal part of the metal bar that is electrically connected to at least a portion of the metal bar that comes into electrical contact with the sprocket 203.

With further reference to FIG. 17B, metal bar 204 can be used to drive the sprocket 203, or can be driven by the sprocket 203. When the metal bar sustains little or no degradation, the encapsulated wire 202 is not in electrical contact with the sprocket. Accordingly, the current flowing from one terminal of the power source 201, through the electrical wire 202, across the sprocket 203 and back through the metal bar 204 to the other end of the power source 201 is nil or negligible. Thus, the current detector 205 detects a nil or negligible current.

With reference to FIG. 17C, when the material of the metal bar 204 is sufficiently degraded, by frictional forces between the sprocket 203 and the metal bar 204, or otherwise, the material of the electrically insulating sacrificial part 200 also becomes degraded. When the electrically insulating sacrificial part 200 becomes sufficiently degraded, the encapsulated wire 202 comes into electrical contact with the sprocket 203. Accordingly, a current begins to flow from one terminal of the power source 201, through the electrical wire 202, across the sprocket 203 and back through the metal bar 204 to the other end of the power source 201, and is detected by current detector 205. Thus, the sensor device 85 can detect degradation of sprocket and/or sprocket tooth.

As will be appreciated, each of the above components of the sensing device 85 can be replaced with functionally equivalent components. For example, in the present example, the power source 201 is the same power source as that of sensor 84ₓ (e.g. battery, piezo-electric, etc.). In other embodiments however, the power source 201 of sensing device 85 can be different to that of sensor 84ₓ. Moreover, the sensing device 85 could be arranged to incorporate a voltage detector instead of incorporating a current detector 205. The sensing device 85 could also incorporate any other suitable means of detecting whether the electrical detection circuit has been closed by a degradation of the sacrificial part 200 and subsequent contact of the encapsulated wire 202 with the sprocket 203. Moreover, the encapsulated wire 202 can be made of any suitable material, or could be replaced with any other suitable electrically conductive component. Furthermore, the electrically insulating sacrificial part 200 can be made of any suitable material, or can be replaced with any other suitable electrically insulating component.

In the example of FIGS. 17A to 17C the sensor 84ₓ is therefore arranged to issue a detection signal when a section of the metal bar 204 has degraded to a predetermined depth.

FIG. 18 shows embodiments for sensing or detecting a loss of track carcass integrity, such as chunking. In this embodiment, the sensor 84x comprises a sensing device 85, a power source 201 arranged to create a difference of potential between a first continuous reinforcing cable winding 37₁-37₄ and a second continuous reinforcing cable winding 37₅-37₈. The sensing device 85 also comprises a current detector 205.

When the first continuous reinforcing cable winding 37₁-37₄ and the second continuous reinforcing cable winding 37₅-37₈ are completely embedded with the elastomeric material of the carcass 36, no current flows between the first continuous reinforcing cable winding 37₁-37₄ and the second continuous reinforcing cable winding 37₅-37₈. When, however, enough elastomeric material of the carcass is remove to expose at least one section 37₂ of the first continuous reinforcing cable winding 37₁-37₄ and another section 37₇ of the second continuous reinforcing cable winding 37₅-37₈, electrical contact between the first continuous reinforcing cable winding 37₁-37₄ and the second continuous reinforcing cable winding 37₅-37₈ is established through moisture in the ground or in another material (e.g., soil, mud, sand, ice, snow, etc.) covering the track 22. Accordingly, a non-nil or non-negligible current is detected in by the current detector 205, and degradation is detected.

As will be appreciated, each of the above components of the sensing device 85 can be replaced with functionally equivalent components. For example, in the present example, the power source 201 is the same power source as that of sensor 84ₓ (e.g. battery, piezo-electric, etc.). In other embodiments however, the power source 201 of sensing device 85 can be different to that of sensor 84ₓ.

Moreover, the sensing device 85 could be arranged to incorporate a voltage detector instead of incorporating a current detector 205. The sensing device 85 could also incorporate any other suitable means of detecting whether electrical connection has been established between the first continuous reinforcing cable winding 37₁-37₄ and the second continuous reinforcing cable winding 37₅-37₈. In some embodiments, the entire sensor 84ₓ, or any part thereof, can be embedded in the track 22.

In the example of FIG. 18, the sensor 84ₓ is therefore arranged to issue a detection signal when the elastomeric material of the carcass 36 on the ground engaging side of the track has degraded to a predetermined depth, such that at least enough elastomeric material of the carcass is remove to expose at least one section 37₂ of the first continuous reinforcing cable winding 37₁-37₄ and at least another section 37₇ of the second continuous reinforcing cable winding 37₅-37₈.

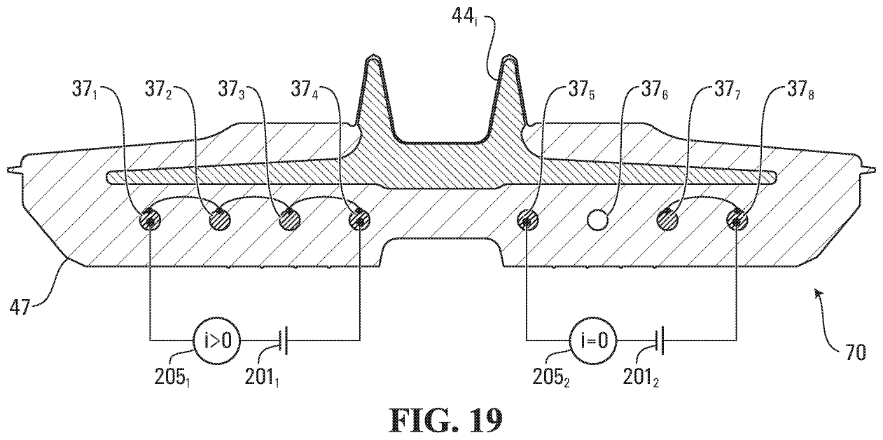

FIG. 19 shows embodiments for sensing or detecting a loss of track carcass integrity, such as a broken reinforcing cable. In this embodiment, each of the first reinforcing cable winding 37₁-37₄ and the second reinforcing cable winding 37₅-37₈, are attached to a sensor 84x.

The first sensor 84x comprises a sensing device 85, a power source 201₁ arranged to create a difference of potential between a first end 37₁ of the first reinforcing cable winding 37₁-37₄ and a second end 37₄ of the first reinforcing cable winding 37₁-37₄. The sensing device 85 also comprises a current detector 205₁. Similarly, the second sensor 84x comprises a sensing device 85, a power source 2012 arranged to create a difference of potential between a first end 37₅ of the second reinforcing cable winding 37₅-37₈ and a second end 37₈ of the second reinforcing cable winding 37₅-37₈. The sensing device 85 also comprises a current detector 205₂.

As shown in FIG. 19, when the first reinforcing cable winding 37₁-37₄ is intact (i.e. electrically continuous), a non-nil or non-negligible current flows through the first reinforcing cable winding 37₁-37₄ and is detected by the current detector 205. When however the first reinforcing cable winding 37₁-37₄ is severed (i.e. not electrically continuous), a nil or negligible current flows through the first reinforcing cable winding 37₁-37₄. Accordingly, by detected a change in current values from a non-nil or non-negligible value to a nil or negligible value, the sensor 84ₓ can sense when a reinforcing cable winding is broken.

In the example of FIG. 19, the sensor 84ₓ is therefore arranged to issue a detection signal when the reinforcing cable winding 37ₓ-37_{y} breaks or otherwise degrades to an extent which prevents it from conducting electricity along at least part of its length.

As will be appreciated, each of the above components of the sensing device 85 can be replaced with functionally equivalent components. For example, in the present example, the power source 201 is the same power source as that of sensor 84ₓ (e.g. battery, piezo-electric, etc.). In other embodiments however, the power source 201 of sensing device 85 can be different to that of sensor 84ₓ.

Moreover, the sensing device 85 could be arranged to incorporate a voltage detector instead of incorporating a current detector 205. The sensing device 85 could also incorporate any other suitable means of detecting whether electrical connection has been interrupted between a first and a second segment of a continuous reinforcing cable winding 37ₓ-37_{y}. In some embodiments, the entire sensor 84ₓ, or any part thereof, can be embedded in the track 22.

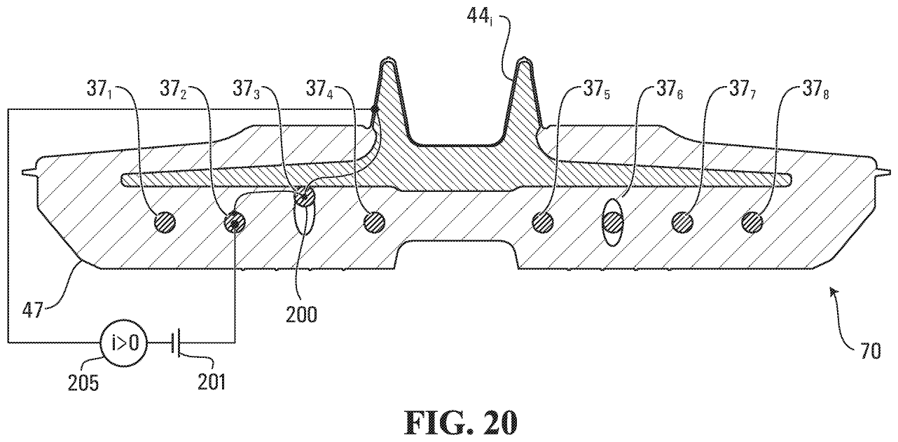

FIG. 20 shows embodiments for sensing or detecting a loss of track carcass integrity, such as reinforcing cable de-bonding and/or metal bar/core de-bonding. In this embodiment, an individual reinforcing cable winding 37ₓ-37_{y} and a track core 44ᵢ can be attached to the sensor 84ₓ. The sensor 84ₓ comprises a sensing device 85, a power source 201 arranged to create a difference of potential between a first segment 37₂ of the first reinforcing cable winding 37₁-37₄ and an area of the metal core 44ᵢ. The sensor 84ₓ also comprises a current detector 205. As shown in FIG. 20, when any segment 37₁, 37₂, 37₃, 37₄ of the first reinforcing cable winding 37₁-37₄ comes into electrical contact with any part of the metal core 44ᵢ, a non-nil or non-negligible current flows from one end of the power source 201, through a first segment 37₂ of the reinforcing cable winding 37₁-37₄, through a portion of the reinforcing cable winding 37₁-37₄ to a second segment 37₃ of the reinforcing cable winding 37₁-37₄, the second segment being electrically connected to the core 44ₗ. Then the non-nil or non-negligible current flows back to the other end of the power source 201, by way of the current detector 205.

Accordingly, by monitoring the current flow through the current detector, it is possible to detect whether the reinforcing cable winding 37₁-37₄ has come into electrical contact with the core 44ₗ which could indicate the presence of reinforcing cable de-bonding and/or metal bar/core de-bonding.

As will be appreciated, each of the above components of the sensing device 85 can be replaced with functionally equivalent components. For example, in the present example, the power source 201 is the same power source as that of sensor 84ₓ (e.g. battery, piezo-electric, etc.). In other embodiments however, the power source 201 of sensing device 85 can be different to that of sensor 84ₓ.

Moreover, the sensing device 85 could be arranged to incorporate a voltage detector instead of incorporating a current detector 205. The sensing device 85 could also incorporate any other suitable means of detecting whether electrical connection has been established between a continuous reinforcing cable winding 37ₓ-37_{y} and the track core 44i. In some embodiments, the entire sensor 84ₓ, or any part thereof, can be embedded in the track 22.

In the example of FIG. 20, the sensor 84ₓ is therefore arranged to issue a detection signal when a continuous reinforcing cable winding 37ₓ-37_{y} comes into electrical contact with the core 44i, which can be indicative of reinforcing cable de-bonding and/or metal bar/core de-bonding.

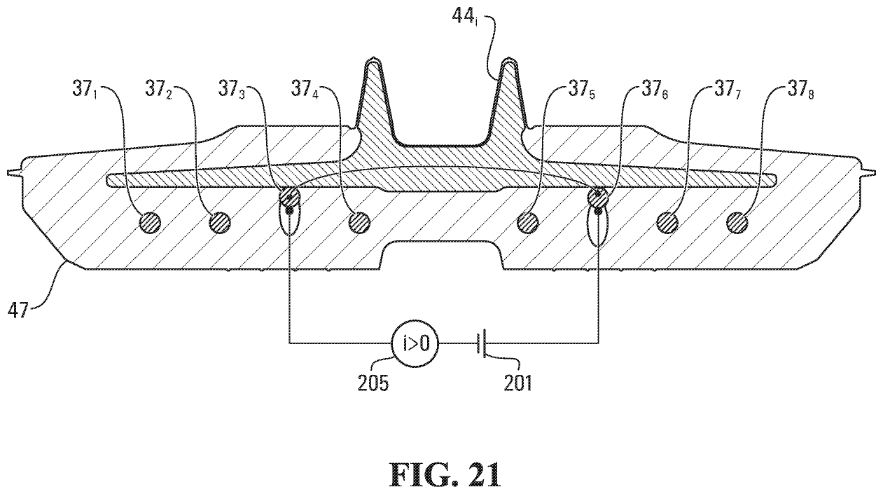

FIG. 21 shows other embodiments for sensing or detecting a loss of track carcass integrity, such as reinforcing cable de-bonding and/or metal bar/core de-bonding. In this embodiment, the sensor 84ₓ comprises a sensing device 85, a power source 201 arranged to create a difference of potential between a first continuous reinforcing cable winding 37₁-37₄ and a second continuous reinforcing cable winding 37₅-37₈. The sensing device 85 also comprises a current detector 205. This arrangement is similar to the embodiment of FIG. 18.

When the first continuous reinforcing cable winding 37₁-37₄ and the second continuous reinforcing cable winding 37₅-37₈ are completely embedded with the elastomeric material of the carcass 36, no current flows between the first continuous reinforcing cable winding 37₁-37₄ and the second continuous reinforcing cable winding 37₅-37₈.

When, however, an electrical connection is established between at least one section 37ₓ of the first continuous reinforcing cable winding 37₁-37₄ and another section 37ₓ of the second continuous reinforcing cable winding 37₅-37₈, by way of reinforcing cable de-n bonding and/or metal bar/core de-bonding, the first continuous reinforcing cable winding 37₁-37₄ and the second continuous reinforcing cable winding 37₅-37₈, come into electrical contact by way of the core 44ᵢ. Accordingly, a non-nil or non-negligible current is detected by the current detector 205.

In the example of FIG. 21, the sensor 84ₓ is therefore arranged to issue a detection signal when both continuous reinforcing cable windings 37ₓ-37_{y} come into electrical contact with the core 44ᵢ, which can be indicative of reinforcing cable de-bonding and/or metal bar/core de-bonding.

In other embodiments, the example of FIG. 18 and FIG. 21 are combined. In these embodiments, the current detector 205 is arranged to measure two threshold non-nil or non-negligible currents, namely a first non-nil or non-negligible current indicative of an electrical connection created across moisture in the ground and/or another material (e.g., soil, mud, sand, ice, snow, etc.) covering the track 22 (e.g. caused by “chunking”), and a second first non-nil or non-negligible current indicative of an electrical connection created across the core 44; (e.g. caused by reinforcing cable de-bonding and/or metal bar/core de-bonding). Accordingly, in some embodiments, the sensor 84ₓ can determine whether the track has sustained chunking or reinforcing cable de-bonding and/or metal bar/core de-bonding.

As will be appreciated, each of the above components of the sensing device 85 can be replaced with functionally equivalent components. For example, in the present example, the power source 201 is the same power source as that of sensor 84ₓ (e.g. battery, piezo-electric, etc.). In other embodiments however, the power source 201 of sensing device 85 can be different to that of sensor 84ₓ. Moreover, the sensing device 85 could be arranged to incorporate a voltage detector instead of incorporating a current detector 205. The sensing device 85 could also incorporate any other suitable means of detecting whether electrical connection has been established between the first continuous reinforcing cable winding 37₁-37₄ and the second continuous reinforcing cable winding 37₅-37₈. In some embodiments, the entire sensor 84ₓ, or any part thereof, can be embedded in the track 22.

The sensors 84ₓ may be implemented in any other suitable way in other embodiments.

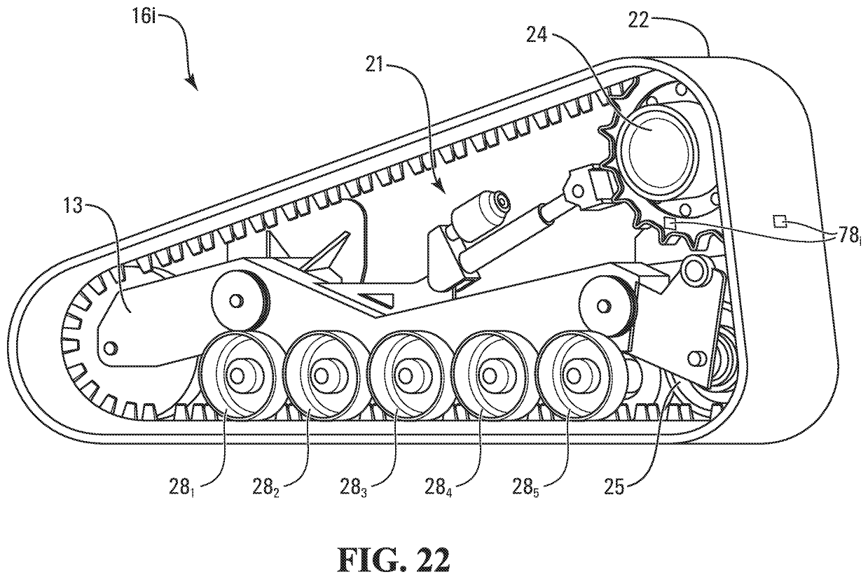

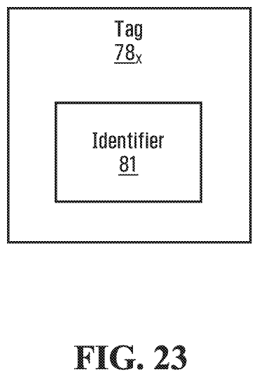

With additional reference to FIGS. 22 and 23, in some embodiments, the track systems 16₁-16₄ may comprise a plurality of tags 78₁-78_{G} configured to identify components of the track systems 16₁-16₄ (e.g., the track 22, one or more of the wheels 24, 25, 28₁-28₅, or each of the track systems 16₁-16₄ itself). For example, in some embodiments, as further discussed below, the processing entity 88 of the monitoring system 82 may perform certain actions in respect of the vehicle 10 based on identification of components of the track systems 16₁-16₄ using the tags 78₁-78_{G}, such as controlling the vehicle 10 (e.g., the speed of the vehicle 10, etc.) based on what is identified and/or conveying information relating to what is identified to a remote party (e.g., a provider such as a manufacturer or distributor of the track systems 16₁, 16₂ and/or of the vehicle 10) who can act based on what is identified (e.g., manage a warranty, prepare for maintenance of the vehicle 10, order and/or ship a replacement track or other component, etc.).

Each of the tags 78₁-78_{G} is an identification element that is part of a component (e.g., the track 22, one of the wheels 25, 28₁-28₅, etc.) of a track system 16ᵢ and configured to convey an identifier 81 of that component of the track system 16ᵢ, such as a serial number, a make, a model, a type, and/or any other information identifying (i.e., indicating an identity of) that component of the track system 16ᵢ, to allow identification of that component of the track system 16ᵢ.

The tags 78₁-78_{G} may be implemented in any suitable way in various embodiments. For example, in some embodiments, a tag 78ₓ may be an RFID tag configured to wirelessly transmit an identification signal conveying the identifier 81 to the processing entity 88 of the monitoring system 82, in which case the processing entity 88 comprises an RFID reader. As another example, in some embodiments, a tag 78ₓ may be an optical tag configured to allow the identifier 81 to be optically determined by the processing entity 88 of the monitoring system 82, in which case the processing entity 88 comprises an optical device (e.g., an infrared reader, a camera, etc.) to optically read the identifier 81 from the tag 78ₓ. As yet another example, in some embodiments, a tag 78ₓ may be a magnetic tag configured to allow the identifier 81 to be magnetically determined by the processing entity 88 of the monitoring system 82, in which case the processing entity 88 comprises a magnetic reader.

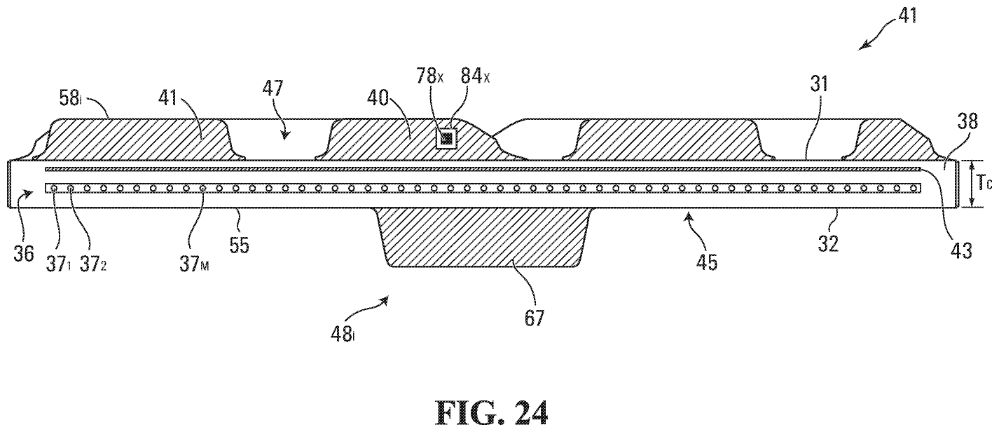

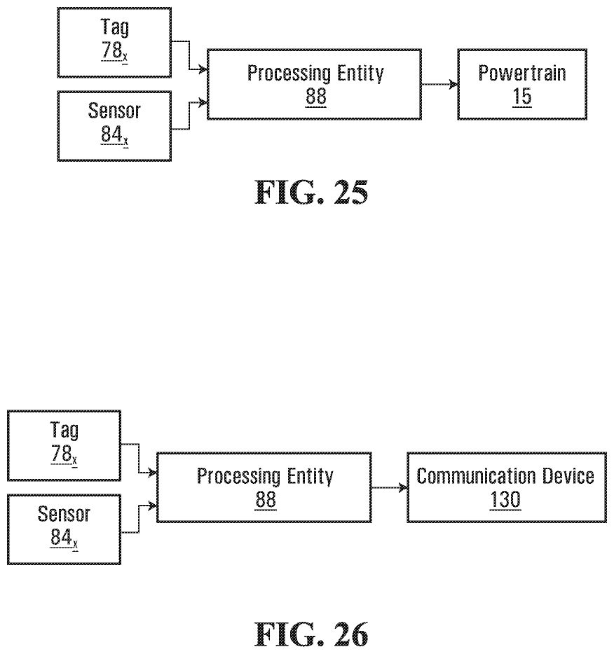

For instance, in this embodiment, with additional reference to FIG. 24, a tag 78ₓ is part of the track 22 of a track system 16ᵢ to convey the identifier 81 of the track 22. More particularly, in this embodiment, the tag 78ₓ is an RFID tag configured to wirelessly transmit an identification signal conveying the identifier 81 to the processing entity 88 of the monitoring system 82, in which case the processing entity 88 comprises an RFID reader. In this example, a sensor 84ₓ of the track 22 also implements RFID and thus may include the tag 78ₓ (i.e., the sensor 84ₓ and the tag 78ₓ constitute a common element sharing a common transmitter to transmit the identification signal and the sensor signal, which may both be part of a common signal). In other examples, the tag 78ₓ may be physically distinct from any sensor 84ₓ of the track 22 (e.g., the tag 78ₓ and the sensor 84ₓ may comprise respective transmitters to transmitting the identification signal and the sensor signal).

The processing entity 88 of the monitoring system 82 is configured to perform actions based on signals from the sensor 84₁-84ₓ and/or the tags 78₁-78_{G} and possibly based on other input and/or information.

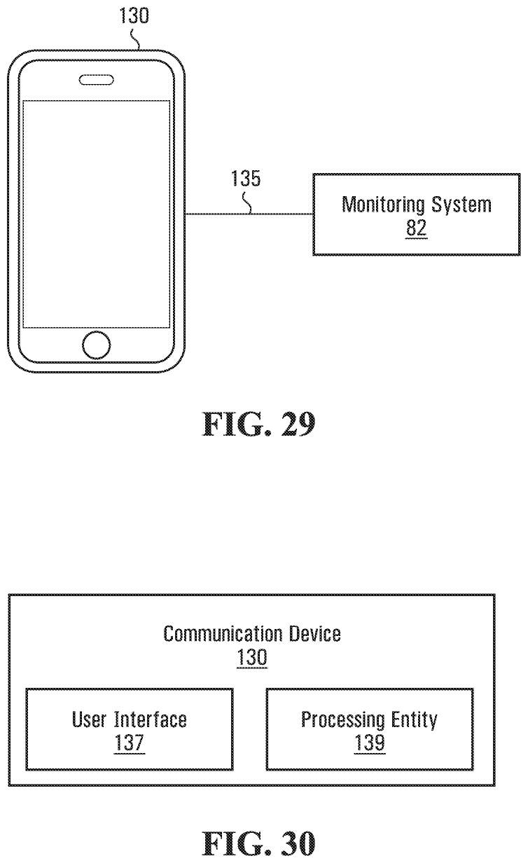

For example, in some embodiments, the processing entity 88 may issue an output signal relating to the operation of the vehicle 10 based on the sensor signal from a sensor 84ₓ of the track 22 of a track system 16ᵢ and/or the identification signal from a tag 78ₓ of the track 22 of the track system 16ᵢ. For instance, in some embodiments, as shown in FIG. 29, the output signal issued by the processing entity 88 may be directed to the powertrain 15 of the vehicle 10 to control the operation (e.g., the speed) of the vehicle 10 based on detection of the physical degradation of the track 22 detected by the sensor 84ₓ and/or the identity of the track 22. In other embodiments, the output signal issued by the processing entity 88 may be directed to a communication device (e.g., comprising a display) for outputting information regarding the operation of the vehicle 10 to the operator of the vehicle 10. As another example, in some embodiments, the processing entity 88 may issue an output signal conveying information about the track system 16; (e.g., attainment of a threshold of degradation of track 22, the identifier 81 of the track 22, etc.). As another example in some embodiments, the processing entity 88 may store information about the track system 16ᵢ in memory (e.g., for future reference), such as attainment of a threshold of degradation of track 22, the identity of the track 22, etc. at a given moment (e.g., date and time).

To that end, in this embodiment, the processing entity 88 comprises an interface 102, a processing portion 108, and a memory portion 110, which are implemented by suitable hardware and/or software.

The interface 102 comprises one or more inputs and outputs allowing the processing entity 88 to receive input signals from and send output signals to other components to which the processing entity 88 is connected (i.e., directly or indirectly connected), including, in this embodiment, the sensors 84₁-84ₛ and the tags 78₁-78_{G}. For example, in this embodiment, an input of the interface 102 is implemented by the wireless receiver 104 to receive the sensor signal from a sensor 84ₓ and the identification signal from a tag 78ₓ. An output of the interface 102 is implemented by a transmitter 112 to transmit the output signal relating to the operation of the vehicle 10. Another output of the interface 102 is implemented by the wireless transmitter 106 to transmit the interrogation signal to a sensor 84ₓ and/or a tag 78ₓ.

The processing portion 108 comprises one or more processors for performing processing operations that implement functionality of the processing entity 88. A processor of the processing portion 108 may be a general-purpose processor executing program code stored in the memory portion 110. Alternatively, a processor of the processing portion 108 may be a specific-purpose processor comprising one or more preprogrammed hardware or firmware elements (e.g., application-specific integrated circuits (ASICs), electrically erasable programmable read-only memories (EEPROMs), etc.) or other related elements.

The memory portion 110 comprises one or more memories for storing program code executed by the processing portion 108 and/or data used during operation of the processing portion 108. A memory of the memory portion 110 may be a semiconductor medium (including, e.g., a solid-state memory), a magnetic storage medium, an optical storage medium, and/or any other suitable type of memory. A memory of the memory portion 110 may be read-only memory (ROM) and/or random-access memory (RAM), for example.

In some embodiments, two or more elements of the processing entity 88 may be implemented by devices that are physically distinct from one another and may be connected to one another via a bus (e.g., one or more electrical conductors or any other suitable bus) or via a communication link which may be wired, wireless, or both. In other embodiments, two or more elements of the processing entity 88 may be implemented by a single integrated device.

The processing entity 88 may be implemented in any other suitable way in other embodiments.

In some embodiments, the processing entity 88 may issue an output signal relating to a degradation alert based on the sensor signal from a sensor 84ₓ of the track 22 of a track system 16ᵢ and/or the identification signal from a tag 78ₓ of the track 22 of the track system 16ᵢ. In some embodiments, the degradation alerts indicates that a particular level of degradation of a track system component has been reached.

In other embodiments, the processing entity 88 may issue an output signal relating to a track ordering system based on the sensor signal from a sensor 84ₓ of the track 22 of a track system 16ᵢ and/or the identification signal from a tag 78ₓ of the track 22 of the track system 16ᵢ. In some embodiments, the track ordering signal conveys information relating to the type of track system component, the level of degradation of the track system component and the location of the vehicle. This information allows a track ordering system to ensure that a track is available for shipment to a particular location within a given amount of time. The information can also be collected and compiled by the track ordering system in order to provide users with recommendations for future track system components. For example, information can be collected and aggregated by geographic region in order to allow track system component suppliers to provide recommendations relating to track system components that are particularly well suited (i.e. exhibiting relatively slow degradation rates) to certain geographic regions.

In yet other embodiments, the processing entity 88 may issue an output signal relating to the operation of the vehicle 10 based on the sensor signal from a sensor 84ₓ of the track 22 of a track system 16ᵢ and/or the identification signal from a tag 78ₓ of the track 22 of the track system 16ᵢ. In some embodiments, the processing entity 88 may combine the signal from the sensor 84ₓ and/or the identification signal from a tag 78ₓ with vehicle information conveying whether or not the vehicle is in a particular state. For example, the vehicle information could convey whether the vehicle is in a particular position, such as, for example, on a hill with a relatively steep incline. The resulting output signal relating to the operation of the vehicle 10 can be directed to the powertrain 15 of the vehicle 10 in order control the operation of the vehicle to avoid further degradation of the track system component when the vehicle 10 is in a particular state (e.g. descending a steep incline).

As noted above, in some embodiments, the processing entity 88 may issue an output signal relating to the operation of the vehicle 10 based on the sensor signal from a sensor 84ₓ of the track 22 of a track system 16ᵢ and/or the identification signal from a tag 78ₓ of the track 22 of the track system 16ᵢ.

For example, in some embodiments, the output signal issued by the processing entity 88 may be directed to the powertrain 15 of the vehicle 10 to control the operation of the vehicle based on the detection of a particular threshold of degradation of the track 22 sensed by the sensor 84ₓ and/or the identity of the track 22 derived from the tag 78ₓ. For instance, the output signal issued by the processing entity 88 may be directed to the powertrain 15 of the vehicle 10 to control the speed of the vehicle 10, such as by limiting and/or reducing the speed of the vehicle 10 or by allowing the speed of the vehicle 10 to be increased, based on the detection of a particular threshold of degradation of the track 22 and/or the identity of the track 22.

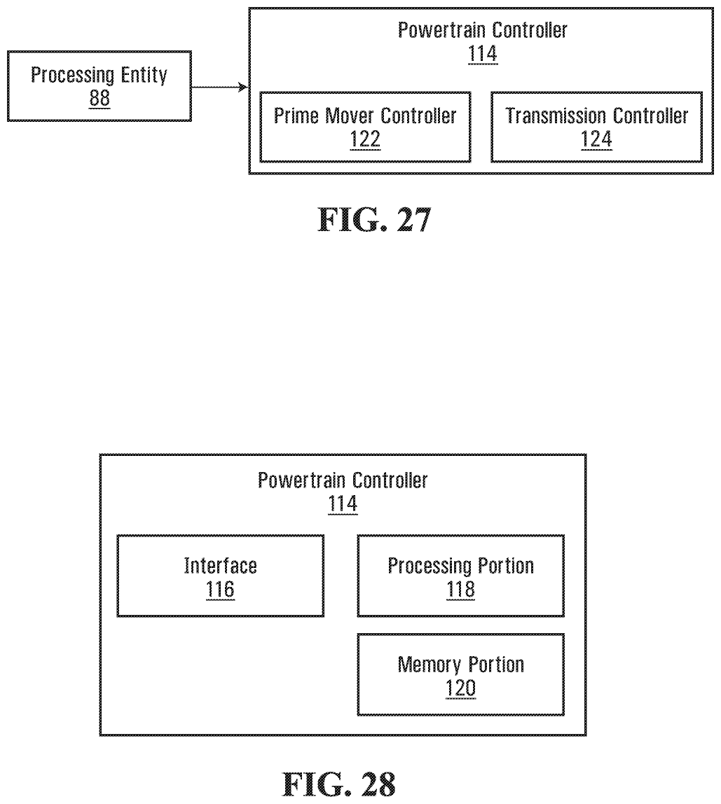

In some embodiments, as shown in FIGS. 27 and 28, the output signal issued by the processing entity 88 may be directed to a powertrain controller 114 of the powertrain 15. The powertrain controller 114 is configured for controlling operation of the powertrain 15.

More particularly, in this embodiment, the powertrain controller 114 is an electronic controller that comprises suitable hardware and/or software (e.g., firmware) configured to implement its functionality. The powertrain controller 114 comprises an interface 116, a processing portion 118 and a memory portion 120.

The interface 116 allows the powertrain controller 114 to receive inputs from and release outputs to other components of the vehicle 10 to which the powertrain controller 114 is connected (i.e., directly or indirectly connected to), including, in this embodiment, the power source 14, a transmission, an accelerator and/or other components of the user interface 70, and one or more sensors (e.g., a throttle position sensor; a motor speed sensor, i.e., a sensor sensing a speed of a motor of the power source 14; a vehicle speed sensor, i.e., a sensor sensing a speed of the vehicle 10 on the ground; a motor temperature sensor; an outside environment temperature sensor; etc.). In this example, the interface 116 of the powertrain controller 114 allows the powertrain controller 114 to receive the output signal of the processing entity 88.

The processing portion 118 comprises one or more processors for performing processing operations that implement functionality of the powertrain controller 114. A processor of the processing portion 118 may be a general-purpose processor executing program code stored in the memory portion 120. Alternatively, a processor of the processing portion 118 may be a specific-purpose processor comprising one or more preprogrammed hardware or firmware elements (e.g., application-specific integrated circuits (ASICs), electrically erasable programmable read-only memories (EEPROMs), etc.) or other related elements.

The memory portion 120 comprises one or more memories for storing program code executed by the processing portion 118 and/or data used during operation of the processing portion 118. A memory of the memory portion 120 may be a semiconductor memory (e.g., read-only memory (ROM) and/or random-access memory (RAM)), a magnetic storage medium, an optical storage medium, and/or any other suitable type of memory.

More particularly, in this embodiment, the powertrain controller 114 comprises a prime mover controller 122 and a transmission controller 124. For instance, in embodiments in which the power source 14 comprises an internal combustion engine and the transmission is an automatic transmission, the prime mover controller 122 may be an engine control unit (ECU) and the transmission controller 124 may be a transmission control unit (TCU). Such ECUs and TCUs are well understood by those skilled in the art. In some cases, the powertrain controller 114 may be a distributed controller in which the prime mover controller 122 and the transmission controller 124 are physically distinct from one another and may be connected to one another via a bus (e.g., a controller-area network (CAN) bus or other suitable bus). In other cases, the prime mover controller 122 and the transmission controller 124 may be functional entities of a single physical control module (e.g., a powertrain control module (PCM)).

The prime mover controller 122 is configured to control operation of the power source 14. Specifically, the prime mover controller 122 is configured to control one or more prime mover characteristics.

For example, in this embodiment, one prime mover characteristic controlled by the prime mover controller 122 is a power output of the power source 14. The power output of the power source 14 refers to the power currently generated by the power source 14. It can be evaluated as a torque produced by the power source 14 multiplied by a speed (i.e., a rotational speed) of the power source 14 (e.g., revolutions per minute (RPM)) at a given instant.

The prime mover controller 122 controls the power output of the power source 14 based on inputs from various entities, such as: the accelerator and/or one or more other components of the user interface 70; one or more sensors (e.g., a throttle position sensor, an air-fuel ratio sensor, a prime mover speed sensor, a vehicle speed sensor, a temperature sensor, a pressure sensor, etc.); one or more other controllers (e.g., the transmission controller 124); and/or other entities. In this example, the prime mover controller 122 may control the power output of the power source 14 based on the output signal issued by the processing entity 88.

To control prime mover characteristics such as the power output of the power source 14, in this embodiment, the prime mover controller 122 comprises a program stored in the memory portion 120 and executed by the processing portion 118. For example, the program may determine the power output of the power source 14 by performing computations based on inputs from a throttle position sensor, an air-fuel ratio sensor, a prime mover speed sensor, the accelerator, and/or the transmission controller 124. In this example, the program may determine the power output of the power source 14 based on the output signal issued by the processing entity 88. In some cases, certain operations of the program may refer to reference data stored in the memory portion 120. This reference data comprises data representative of one or more maps, tables, curves or other sets of reference values that are used during execution of the program of the prime mover controller 122. For instance, the reference data may associate different values of certain parameters of the power source 14 (e.g., the speed, temperature, air-fuel ratio, pressure, etc. of the prime mover 14) to corresponding values of fuel injection, ignition timing, valve timing, and/or other parameters of the power source 14 (e.g., a fuel map, an injection map, a boost map, and/or other performance map). Such programs and reference data are well-understood by those skilled in the art and will therefore not be discussed in further detail.

The transmission controller 124 is configured to control operation of the transmission. Specifically, the transmission controller 124 is configured to control one or more transmission characteristics. For example, in this embodiment, the transmission controller 124 controls a transmission state of the transmission. The transmission state of the transmission can be defined in terms of (i) a transmission ratio of the transmission, which is the ratio that the transmission currently applies between its input and its output, and/or (ii) an output direction of the transmission, which refers to a direction of motion (i.e., forward or reverse) of the output of the transmission that allows the vehicle 10 to advance or back up. At a given instant, the transmission state of the transmission is one of a set of available transmission states. The set of available transmission states can comprise a number of available transmission ratios that can be applied by the transmission. This number may be a finite number (e.g., two, three, four or any other finite number) of available transmission ratios, or an infinite number of available transmission ratios (e.g., in embodiments where the transmission comprises a CVT).

The transmission controller 124 controls the transmission state of the transmission based on inputs from various entities, such as: the accelerator and/or one or more other components (e.g., a gear shift stick or pedal) of the user interface 70; one or more sensors (e.g., a throttle position sensor, a shift lever sensor, a prime mover speed sensor, a vehicle speed sensor, a temperature sensor, etc.); one or more other controllers (e.g., the prime mover controller 122); and/or other entities. In this example, the transmission controller 124 may control the transmission state of the transmission based on the output signal issued by the processing entity 88.

To control the state of the transmission, in this embodiment, the transmission controller 124 comprises a program stored in the memory portion 120 and executed by the processing portion 118. For example, the program may determine when and how to shift between different transmission ratios of the transmission by performing certain computations based on inputs from a throttle position sensor, a prime mover speed sensor, a vehicle speed sensor, the accelerator and/or other components of the user interface 70, and/or the prime mover controller 122. In this example, the program may determine the state of the transmission based on the output signal issued by the processing entity 88. In some cases, certain operations of the program may refer to reference data stored in the memory portion 120. This reference data comprises data representative of one or more maps, tables, curves or other sets of reference values that are used during execution of the program of the transmission controller 124. For instance, the reference data may associate different values of the speed of the power source 14 and of the speed of the vehicle 10 to corresponding transmission ratios of the transmission. Such programs are well-understood by those skilled in the art and will therefore not be discussed in further detail.

For example, in some embodiments, a sensor 84ₓ of the track 22 of a track system 16ᵢ may be a degradation sensor of track 22, and the powertrain controller 114 may control the speed of the vehicle 10 based on whether a threshold of degradation of track 22 has occurred.

In other embodiments, as shown in FIG. 29, the output signal issued by the processing entity 88 may be directed to a communication device 130 for communicating information regarding the operation of the vehicle 10 to a user, such as the operator of the vehicle 10.

The communication device 130 may be implemented in various ways in various embodiments.

In other embodiments, the communication device 130 may be part of the user interface 70 of the operator cabin 20 in order to convey information to the operator.

As another example, in some embodiments, as shown in FIG. 29, the communication device 130 may be a personal communication device (e.g., a smartphone, a computer, etc.) or other device that is usable by a user (e.g., the operator) and distinct from and not built into the user interface 70 of the operator cabin 20 of the vehicle 10. This may be useful, for instance, in situations where the vehicle 10 was not originally manufactured with the track system 16i and/or is not readily modifiable to allow interaction between the monitoring system 82 and the user interface 70 and/or other original components of the vehicle 10.

The communication device 130 may interact with the monitoring system 82 over a communication link 135, which may be wireless, wired, or partly wireless and partly wired (e.g., Bluetooth or other short-range or near-field wireless connection, WiFi or other wireless LAN, WiMAX or other wireless WAN, cellular, Universal Serial Bus (USB), etc.). For example, in some embodiments, the communication device 130 may be:
a smartphone or other wireless phone; a tablet computer; a head-mounted display, smartwatch or other degradationable device; or any other communication device carried, worn or otherwise associated with the user (e.g., the operator);
a server or other computing entity (e.g., implementing a website) associated with: the user (e.g., the operator); an organization associated with the user (e.g., the operator); a manufacturer of the track 22, the track system 16i, and/or of the vehicle 10; a retailer, distributor, or other vendor of the track 22, the track system 16i, and/or of the vehicle 10; or any other party who may have an interest in the track 22, the track system 16i, and/or of the vehicle 10;
etc.

In some cases, such as where the communication device 130 is a smartphone, tablet, head-mounted display, smartwatch, or other communication device carried or worn by the user (e.g., the operator), communication between the communication device 130 and the monitoring system 82 may be direct, i.e., without any intermediate device. For instance, in some embodiments, this can be achieved by pairing (e.g., Bluetooth pairing) the communication device 130 and the monitoring system 82.

In other cases, such as where the communication device 130 is remote from the monitoring system 82, communication between the communication device 130 and the monitoring system 82 may be indirect, e.g., through one or more networks and/or one or more additional communication devices. For example, in some embodiments, the monitoring system 82 may communicate (e.g., via the transmitter 112 and/or the receiver 104 of the processing entity 88 or the transmitter 90 and/or the receiver 92 of the sensor 84ₓ) with a WiFi hotspot or cellular base station, which may provide access to a service provider and ultimately the Internet or another network, thereby allowing the monitoring system 82 and the communication device 130 to communicate. As another example, in some embodiments, communication between the communication device 130 and the monitoring system 82 may take place through a smartphone, tablet, head-mounted display, smartwatch, or other communication device which is carried or worn by the user of the communication device 130 and which itself may have established communication with a WiFi hotspot or cellular base station.

For example: in some embodiments, the communication device 130 may be a smartphone or other mobile phone, a tablet, a smart watch, head-mounted display or other degradationable device, or any other communication device that may be carried by the user, and the communication link 135 may be a short-range wireless link (e.g., Bluetooth) or a wired link (e.g., USB); in other embodiments, the communication device 130 may be a server or other computing entity or a smartphone or other mobile phone, a tablet, a smart watch, head-mounted display or other degradationable device, or any other communication device that may be carried by the user and the communication link 135 may be implemented by a data network such as the Internet over a wired connection and/or a wireless connection (e.g., WiFi, WiMAX, cellular, etc.); and, in other embodiments, the communication device 130 may be a server or other computing entity and the communication link 135 may be implemented over a wireless connection using, for instance, dedicated short-range communication (DSRC), IEEE 802.11, Bluetooth and CALM (Communications Access for Land Mobiles), RFID, etc.

In some embodiments, an application (“app”, i.e., software) may be installed on the communication device 130 to interact with the monitoring system 82 of the vehicle 10. For example, in some embodiments, such as where the communication device 130 is a smartphone, a tablet, a computer, etc., the user (e.g., the operator) may download the app from a repository (e.g., Apple's App Store, iTunes, Google Play, Android Market, etc.) or any other website onto the communication device 130. Upon activation of the app on the communication device 130, the user may access certain features relating to the monitoring system 82 of the vehicle 10 locally on the communication device 130. In addition, a data connection can be established over the Internet with a server of which executes a complementary server-side application interacting with the app on the communication device 130.

For example, in some embodiments, the communication device 130 may be a smartphone of the operator of the vehicle 10, onto which an app to interact with the monitoring system 82 of the vehicle 10 has been installed (e.g., downloaded).

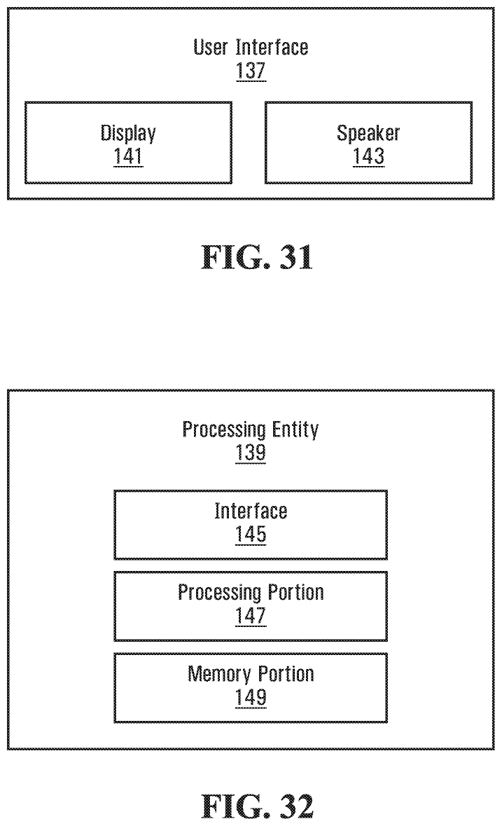

In various embodiments, as shown in FIGS. 30 to 32, the communication device 130 (e.g., whether part of the user interface 70 of the operator cabin 20, or a personal communication device such as a smartphone, tablet, computer, etc.) may comprise a user interface 137 and a processing entity 139. The user interface 137 may comprise a display 141, a speaker 143, and/or any other output device, such as the display 132 of the operator cabin 20, a display of a smartphone, etc. The processing entity 139 comprises an interface 145, a processing portion 147, and a memory portion 149, which are implemented by suitable hardware and/or software.

The interface 145 comprises one or more inputs and outputs allowing the processing entity 139 to receive input signals from and send output signals to other components to which the processing entity 139 is connected (i.e., directly or indirectly connected). For example, in this embodiment, an input of the interface 145 is implemented by a wireless receiver to receive a signal from the monitoring system 82. An output of the interface 145 is implemented by a transmitter.

The processing portion 147 comprises one or more processors for performing processing operations that implement functionality of the processing entity 139. A processor of the processing portion 147 may be a general-purpose processor executing program code stored in the memory portion 149. Alternatively, a processor of the processing portion 147 may be a specific-purpose processor comprising one or more preprogrammed hardware or firmware elements (e.g., application-specific integrated circuits (ASICs), electrically erasable programmable read-only memories (EEPROMs), etc.) or other related elements.

The memory portion 149 comprises one or more memories for storing program code executed by the processing portion 147 and/or data used during operation of the processing portion 147. A memory of the memory portion 149 may be a semiconductor medium (including, e.g., a solid-state memory), a magnetic storage medium, an optical storage medium, and/or any other suitable type of memory. A memory of the memory portion 149 may be read-only memory (ROM) and/or random-access memory (RAM), for example.

In some embodiments, two or more elements of the processing entity 139 may be implemented by devices that are physically distinct from one another and may be connected to one another via a bus (e.g., one or more electrical conductors or any other suitable bus) or via a communication link which may be wired. In other embodiments, two or more elements of the processing entity 139 may be implemented by a single integrated device.

The processing entity 139 may be implemented in any other suitable way in other embodiments.

Although the output signal issued by the processing entity 88 was described in embodiments considered above as being directed to the powertrain 15 of the vehicle 10 or the communication device 130, in some embodiments, both of these actions can be performed by the processing entity 88. That is, an output signal may be issued by the processing entity 88 and directed to the powertrain 15 of the vehicle 10 to control the powertrain 15 of the vehicle 10 and another output signal may be issued by the processing entity 88 and directed to the communication device 130 for communicating information regarding the operation of the vehicle 10 to a user such as the operator of the vehicle 10.

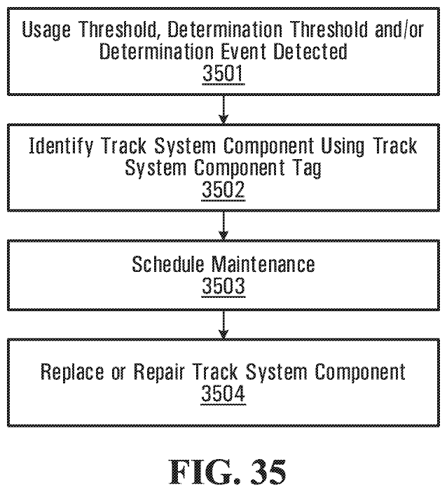

The monitoring system 82 can have a number of applications, non-limiting examples of which are described below with reference to FIGS. 35 to 37. Any feature of any embodiment discussed with reference to FIGS. 35 to 37 may be combined with any feature of any other embodiment discussed with reference to FIGS. 35 to 37 in order to optimize vehicle downtime, track system component order/shipping times, vehicle maintenance scheduling, vehicle use schedules, vehicle dispatch schedules and dispatch locations and/or any other operational, logistical or organisational criteria relating to track system components, vehicles, fleets of vehicles, and/or maintenance facility operations.

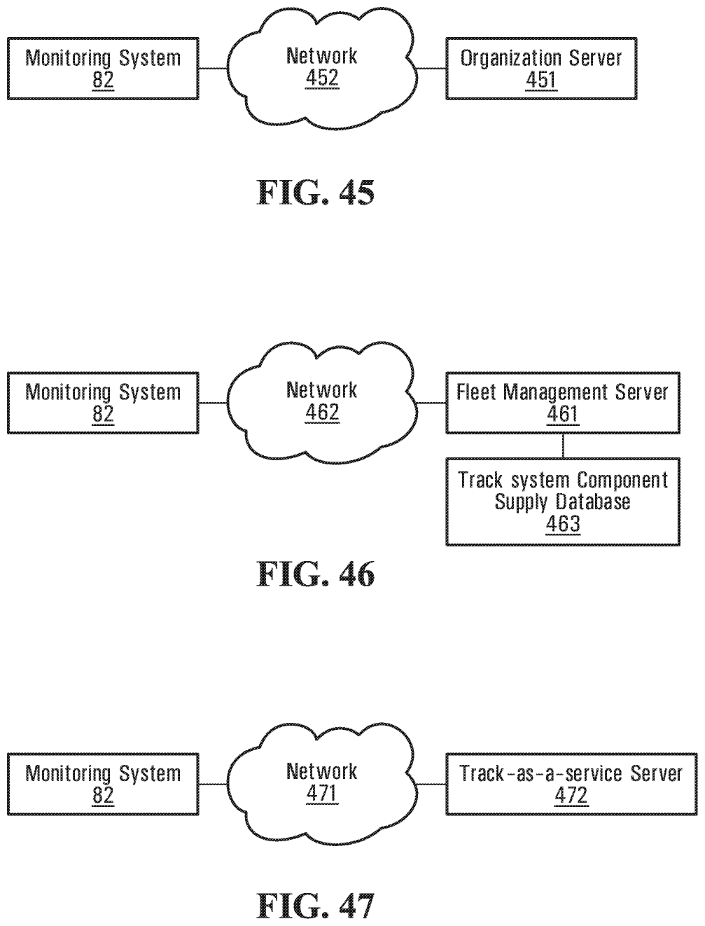

For example, with reference to FIG. 35, in some embodiments, the monitoring system 82 can be used in a rental market to monitor usage of track system components. At step 3501, the monitoring system 82 determines that an event arising from usage of a track system 16ₓ, such as a usage threshold event (e.g. an amount of tread wear, an amount of time such as a number of hours the track 22 has been used), deterioration threshold event (e.g. a number of exposed reinforcing cable locations) and/or deterioration event (e.g. one or more snapped or broken reinforcing cables), has occurred. At step 3502, the monitoring system 82 identifies the track system component for which the usage threshold event, deterioration threshold event and/or deterioration event has occurred. In some embodiments, the track system component information and information relating to the usage threshold event, deterioration threshold event and/or deterioration event is conveyed to the operator of the vehicle by the monitoring system 82 in order to facilitate scheduling of track system component servicing and/or other maintenance. For instance, the monitoring system 82 may issue a notification conveying this information to the operator via the user interface of the operator cabin 20 of the vehicle 10 and/or the communication device 130. In other embodiments, the monitoring system 82 conveys the track system component information and information relating to the usage threshold event, deterioration threshold event and/or deterioration event to an organisation providing maintenance services. For instance, as shown in FIG. 45, the monitoring system 82 may issue a notification conveying this information to a server 451 associated with the organisation via a network 452 (e.g. which may be implemented by the Internet, a cellular connection, and/or any other network infrastructure). Once the information is received, the organisation can schedule maintenance of the vehicle at step 3503, and subsequently replace or repair the track system component.

Accordingly, track system component maintenance operations can be initiated and scheduled without the need for input from the vehicle operator.

Moreover, multiple sensors 84₁-84ₛ can be embedded in the elastomeric material of the traction projections 58₁-58_{T}, the wheel-contacting projections 48₁-48_{N}, and/or the carcass 36 of the track, at different depths, thereby providing a simple and inexpensive solution for monitoring the progression of track wear. In the vehicle rental market, for example, this can allow a pay-per-use model, in which vehicle rental costs are not based on the length of the rental period, but rather at least partly on the amount of use (i.e. wear on the track) that is incurred during the rental period.

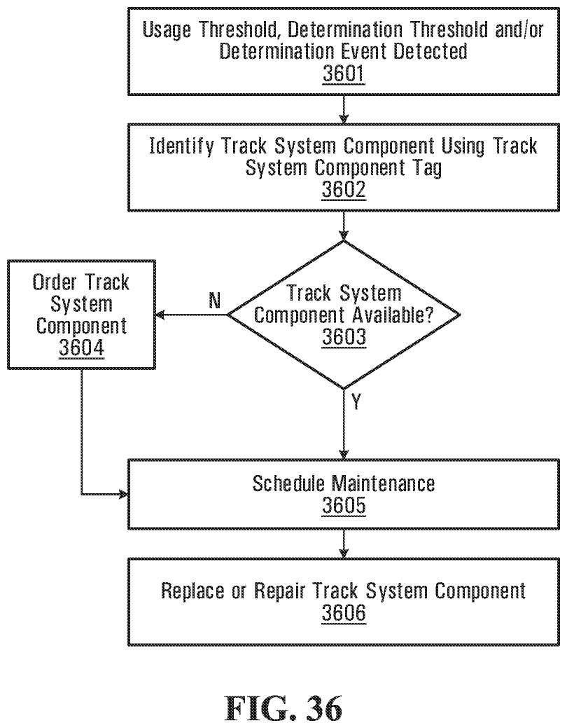

In some embodiments, and with reference to FIG. 36, the monitoring system 82 allows organisations managing large fleets (e.g. vehicle rental companies, construction companies, forestry companies, etc.) to ensure that maintenance operations can be scheduled and carried out effectively and efficiently. For example, by monitoring the wear of track system components, it is possible to more precisely predict when a track system component will fail and/or when a replacement track system component should be ordered and/or shipped. Moreover, for an organisation managing a fleet of vehicles, knowing which vehicles will shortly require maintenance and/or replacement parts contributes to efficient and effective deployment of vehicles and maintenance resources. For example, at step 3601, the monitoring system 82 determines that an event arising from usage of a track system 16ₓ, such as a usage threshold event (e.g. an amount of tread wear, an amount of time such as a number of hours the track 22 has been used), deterioration threshold event (e.g. a number of exposed reinforcing cable locations) and/or deterioration event (e.g. one or more snapped or broken reinforcing cables), has occurred. At step 3602, the monitoring system 82 identifies the track system component for which the usage threshold event, deterioration threshold event and/or deterioration event has occurred. In some embodiments, as shown in FIG. 46, the monitoring system 82 conveys the track system component information and information relating to the usage threshold event, deterioration threshold event and/or deterioration event to an automated fleet management system comprising a server 461. The monitoring system 82 may communicate with the server 461 of the automated fleet management system over a network 462 (e.g. which may be implemented by the Internet, a cellular connection, and/or any other network infrastructure). At step 3603, the server 461 of the automated feet management system queries a track system component supply database 463 to determine whether the identified track system component is available or needs to be ordered. The track system component supply database can be managed by the fleet management system, or can be managed by a third-party track system component supplier. If the identified track system component is available, the vehicle can be scheduled for maintenance. If, on the other hand, the track system component is not available, the fleet management system can cause the track system component to be order at step 3604, before scheduling maintenance of the vehicle at step 3605. In some embodiments, the scheduling of the vehicle maintenance is at least in part based on the estimated delivery time for an ordered track system component. In order embodiments, the dispatching of the vehicle relating to the identified track system component can, at least partially, be based on the scheduled maintenance. Finally, at step 3606, the maintenance operation is carried out and the track system component is replaced or repaired.

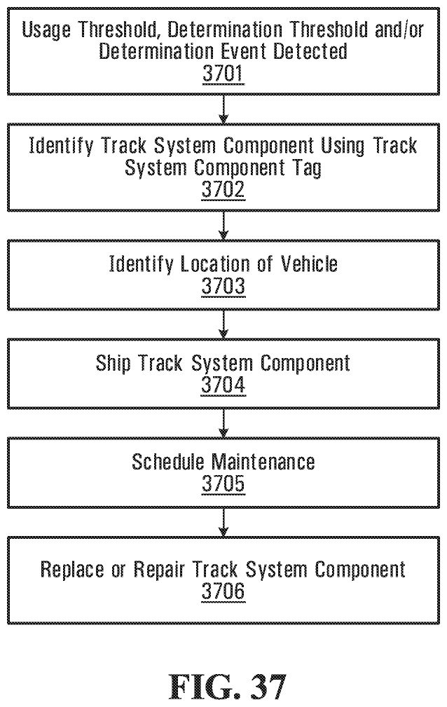

In some embodiments, as shown in FIG. 37, the monitoring system 82 allows organisations to provide track-as-a-service type payment/usage models, in which tracks are not purchased, but are rather provided as a service to vehicle operators in exchange for a subscription fee. For example, for a monthly fee, an organisation could provide vehicle operators with tracks, as well as the monitoring system 82 which will allow the organisation to ensure that the vehicle operator is never without an operable/functional track, regardless of how much and how (i.e. under what circumstances) the vehicle operator uses the track. This can lead to significant savings in term of vehicle downtime and logistics. For example, at step 3701, the monitoring system 82 determines that an event arising from usage of a track system 16ₓ, such as a usage threshold event (e.g. an amount of tread wear, an amount of time such as a number of hours the track 22 has been used), deterioration threshold event (e.g. a number of exposed reinforcing cable locations) and/or deterioration event (e.g. one or more snapped or broken reinforcing cables), has occurred. At step 3702, the monitoring system 82 identifies the track system component for which the usage threshold event, deterioration threshold event and/or deterioration event has occurred. At step 3703, vehicle location information relating to the geographic location of the vehicle is determined. This can be achieved by any suitable means including, but not limited to, Global Positioning System (GPS) receivers. In some embodiment, the monitoring system 82 conveys the track system component information, vehicle location information and information relating to the usage threshold event, deterioration threshold event and/or deterioration event to the track-as-a-service organisation. As shown in FIG. 47, the monitoring system 82 may communicate with the server 472 of the track-as-a-service organisation over a network 471 (e.g. which may be implemented by the Internet, a cellular connection, and/or any other network infrastructure). Then, at step 3704, the track-as-a-service organisation ships a replacement track system component to a location related to the geographic location of the vehicle. For example, the track-as-a-service location could ship the replacement track system component to the nearest maintenance service dispatch location or third party maintenance organisation. At step 3705, the track-as-a-service organisation can schedule a maintenance of the track system. In some embodiments, the track-as-a-service organisation schedules a third party mobile maintenance team to perform onsite maintenance based on the geographic location of the vehicle. Finally, at step 3706, the track-as-a-service organisation, or an agent thereof, replaces the track system component. In some embodiments, this can be performed onsite, based at least in part on the vehicle location information received from the track-as-a-service organisation.

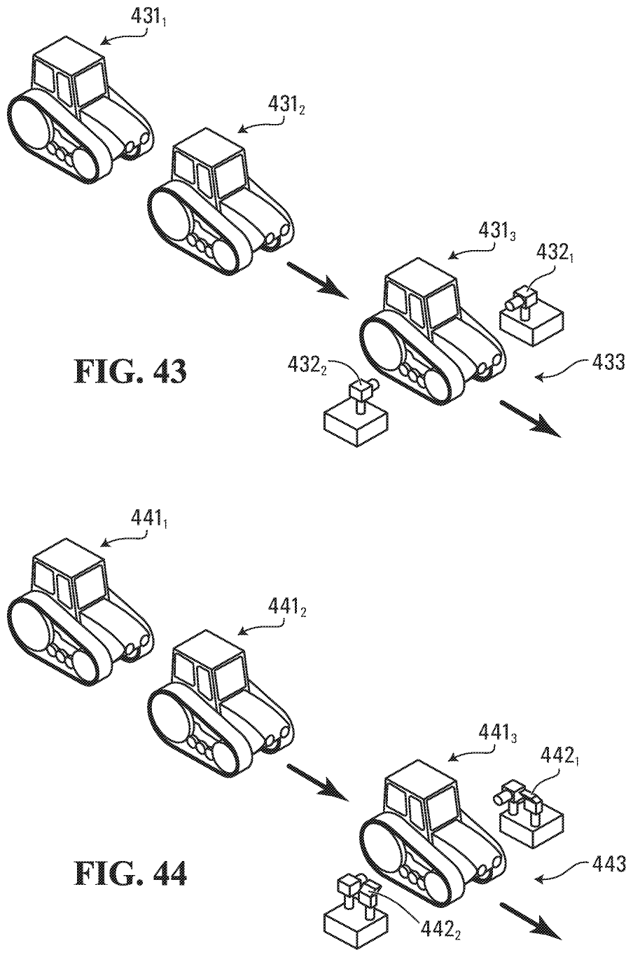

In some embodiments, with additional reference to FIGS. 43 and 44, in addition to or instead of the sensors 84₁-84ₛ of the track systems 16₁, 16₂, the monitoring system 82 may comprise an inspection station for inspecting vehicles such as the vehicle 10 when they are in proximity.

For example, in some embodiments, as shown in FIG. 43, the monitoring system 82 may include a visual inspection station 433 for inspecting track systems of vehicles 431ₓ. In some embodiments, the visual inspection station 433 comprises camera systems 432ₓ arranged to capture images of each of the track system 16₁, 16₂ and their environment. The captured images can then be optionally processed and analyzed locally or remotely. The camera systems 432ₓ can include directional cameras having any configuration of lenses suitable for inspecting the system 16₁, 16₂ and their environment.

In other embodiments, with additional reference to FIG. 44, the monitoring system 82 may include a scanning inspection station 443 for inspecting track systems of vehicles 441ₓ. In some embodiments, the inspection station 443 comprises laser line scanner and/or laser area scanner systems 442ₓ arranged to scan each of the track system 16₁, 16₂ and their environment as each vehicle 441ₓ moves past the inspection station 443. The information generated by the laser line scanner and/or laser area scanner systems 442ₓ can then be optionally processed and analyzed locally or remotely.

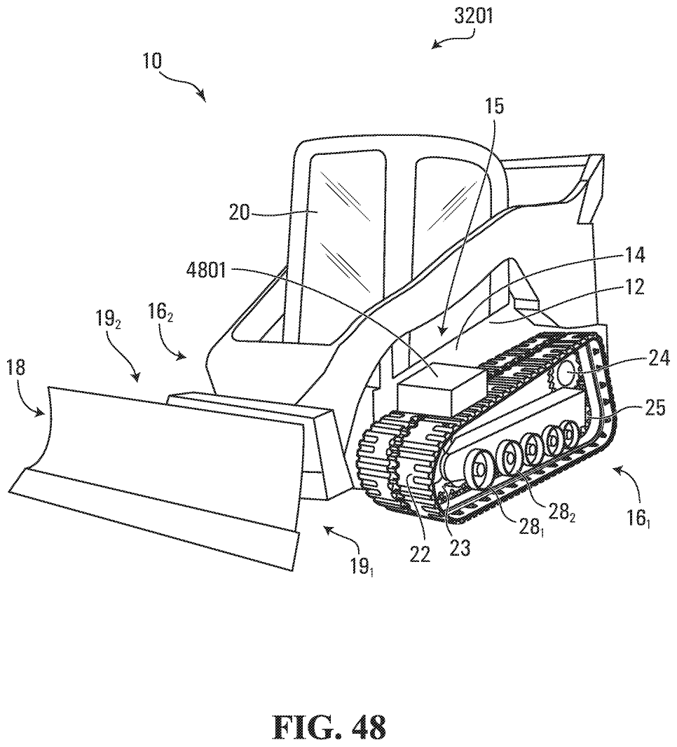

In some embodiments, with additional reference to FIG. 48, in addition to or instead of the sensors 84₁-84ₛ of the track systems 16₁, 16₂, the monitoring system 82 may comprise a vehicle-mounted inspection device 4801 for inspecting the track systems 16₁, 16₂ of the vehicle 10. In particular, the monitoring system 82 may include one or more vehicle-mounted inspection device 4801 for inspecting track systems 16₁, 16₂ of vehicles. In some embodiments, each track system 16₁ and 16₂ is provided with a vehicle-mounted inspection device 4801.

In some embodiments, the vehicle-mounted inspection device 4801 comprises a camera system arranged to capture images of the track system 16₁, 16₂ and its environment as the track 22 moves around the track-engaging assembly 21. The information generated by the camera system can then be optionally processed and analyzed locally or remotely.

In some embodiments, the vehicle-mounted inspection device 4801 comprises a laser line scanner system and/or a laser area scanner system arranged to scan the track system 16₁, 16₂ and its environment as the track 22 move around the track-engaging assembly 21. The information generated by the laser line scanner and/or laser area scanner systems can then be optionally processed and analyzed locally or remotely.

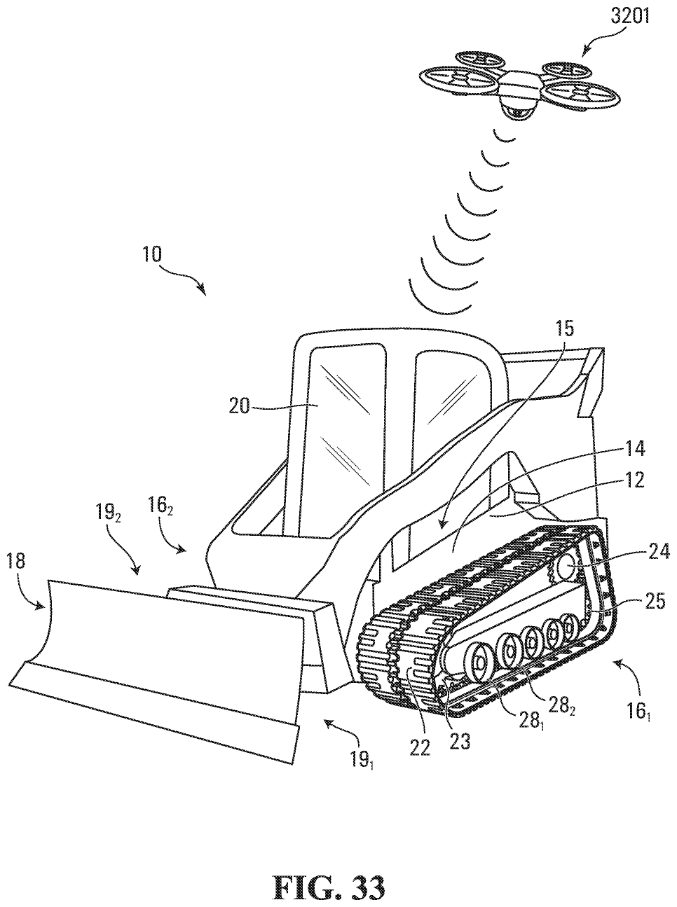

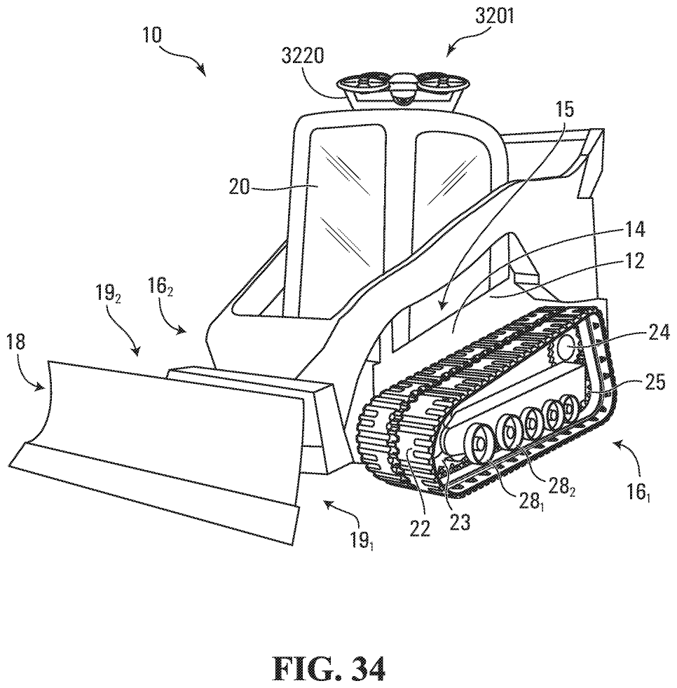

In some embodiments, with additional reference to FIGS. 33 and 34, in addition to or instead of the sensors 84₁-84ₛ of the track systems 16₁, 16₂, the monitoring system 82 may comprise a drone 3201 for inspecting the track 22 and/or other components of each of the track systems 16₁, 16₂ and/or their environment (e.g., detecting the presence of debris, etc.), so that information derived from the drone 3210 may be relayed to the operator of the vehicle 10 and/or another remote device or person. The vehicle 10 may comprise a drone mount 3220 configured to mount the drone 3220 to the vehicle 10 and release the drone 3201 when the drone 3201 is to monitor the vehicle 10 by moving around it.

In some embodiments, the drone 3201 is arranged to follow the vehicle, capture and analyze images of each of the track system 16₁, 16₂ and their environment. In other embodiments, the drone 3201 is equipped with a laser line scanner for scanning the track system 16₁, 16₂ and their environment. Communication between the drone 3201 and the vehicle 10 (e.g., between the drone 3201 and the processing entity 88) can be provided for by any suitable means, including but not limited to any combination of Global Positioning System (GPS) signals, Radio Frequency (RF) signals, Bluetooth signals, LIDAR, and RADAR signals.

In this embodiment, the drone 3210 is an aerial drone configured to fly about the vehicle 10. While the drone 3201 shown in FIG. 33 is a multi-rotor flying drone, other drones are possible, including but not limited to fixed-wing drones, or any other type of unmanned aerial vehicle. Also, in other embodiments, the drone 3210 may be a land drone configured to travel on the ground about the vehicle 10 (e.g., on wheels or on tracks).

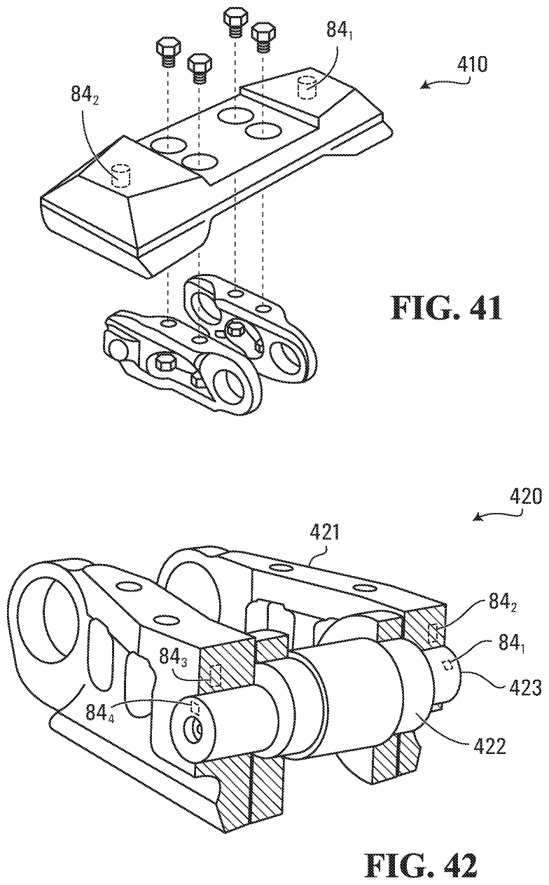

In some embodiments, with reference to FIGS. 41 and 42, instead of being a continuous one-piece structure, the track 22 may comprise a plurality of track sections 410₁-410_{T} that are interconnected at a plurality of joints to make it endless, and the sensors 84₁-84ₛ similar to those described above in reference to FIGS. 14 and 15, FIGS. 16A to 16C and 17A to 17C can be used to detect degradation of one or more of the track sections 410₁-410_{T}. For instance, in this embodiment, each of the track sections 410₁-410_{T} comprises a chain-on (roadliner) elastomeric (e.g., rubber) pad 412 mounted to a metallic link 421. The sensors 84₁-84ₛ may be implemented in the elastomeric pad 412 similarly to what discussed in respect of FIGS. 14 and 15 to detect degradation of their elastomeric material and/or in the metallic link 421 to detect degradation of bushings, pins, rails and/or other elements of the link 421.

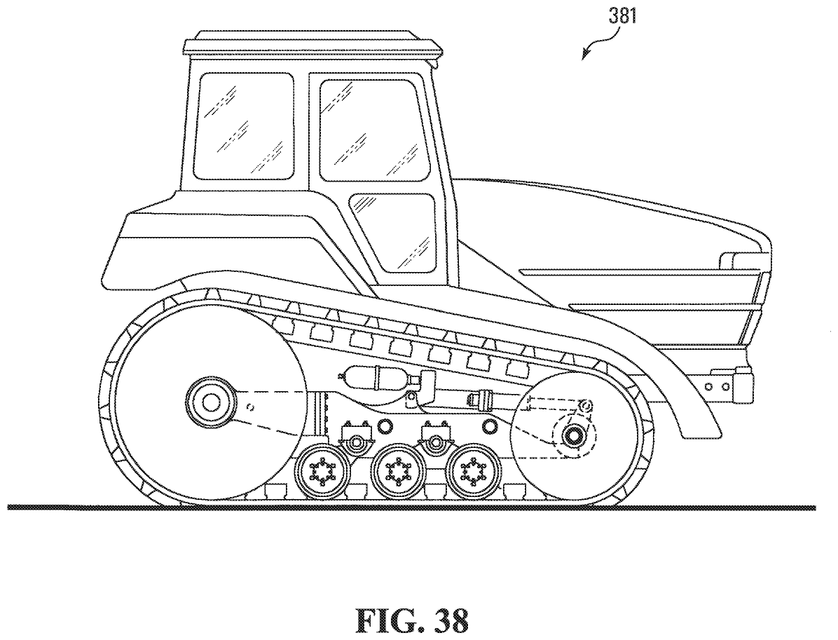

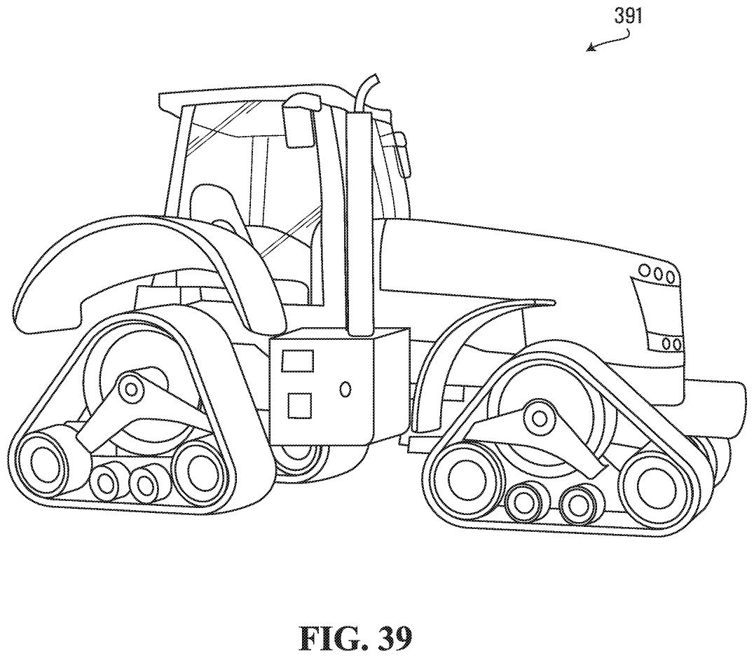

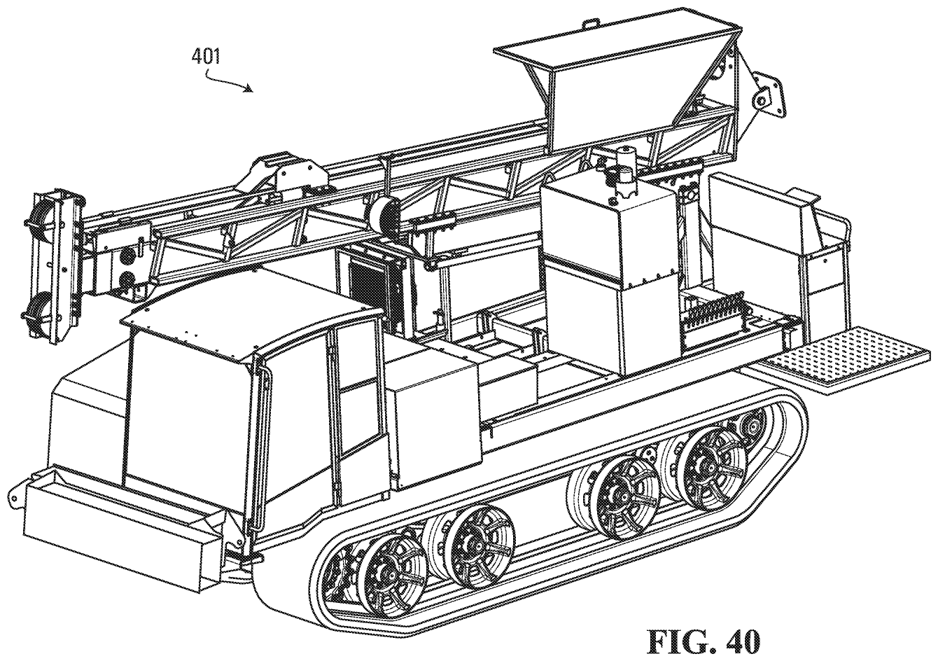

While in embodiments considered above the off-road vehicle 10 is a construction vehicle, in other embodiments, the vehicle 10 may be another type of work vehicle such as an agricultural vehicle, as shown in FIGS. 38 and 39, (e.g., a combine harvester, another type of harvester, a tractor, etc.) for performing agricultural work, a forestry vehicle (e.g., a feller-buncher, a tree chipper, a knuckleboom loader, etc.) for performing forestry work, or a military vehicle (e.g., a combat engineering vehicle (CEV), etc.) for performing military work, a carrier (e.g. carrying a boom, a rig, and/or other equipment t), as shown in FIG. 40, or may be any other type of vehicle operable off paved road. Although operable off paved roads, the vehicle 10 may also be operable on paved roads in some cases. Also, while in embodiments considered above the off-road vehicle 10 is driven by a human operator in the vehicle 10, in other embodiments, the vehicle 10 may be an unmanned ground vehicle (e.g., a teleoperated or autonomous unmanned ground vehicle). Moreover, the monitoring system 82 disclosed herein can be used in combination with sensors 84ₓ located in any component of a track system used by any of the aforementioned types of vehicles.

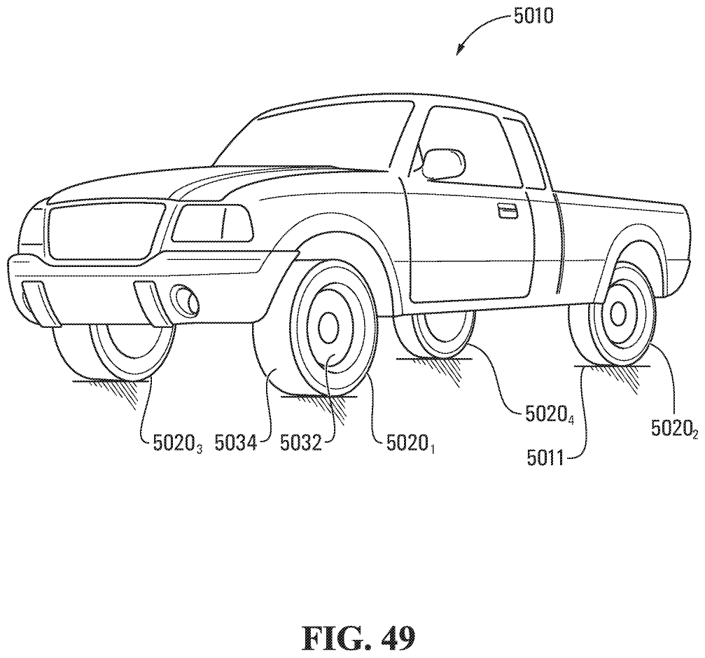

FIG. 49 shows an example of an embodiment of a vehicle 5010 comprising wheels 5020₁-5020₄ on a ground surface 5011. Each of the wheels 5020₁-5020₄ comprises a tire 5034 for contacting the ground surface 5011.

As further discussed later, in this embodiment, the vehicle 5010, including the wheels 5020₁-5020₄, can be monitored (e.g., during operation of the vehicle 5010) to obtain information regarding the vehicle 5010, including information regarding the wheels 5020₁-5020₄, such as an indication of deterioration of the tire 5034 and/or another component of a given one of the wheels 5020₁-5020₄ (e.g., an indication of a level of wear, a rupture like a break, a puncture, chunking, de-bonding, etc. of the tire 5034 and/or other component of that wheel), an identifier of the tire 5034 and/or another component of the given one of the wheels 5020₁-5020₄, and/or other parameters of the tire 5034 and/or another component of the given one of the wheels 5020₁-5020₄, which can be used for various purposes, such as, for example, to: convey the information to a user (e.g., an operator of the vehicle 5010); control the vehicle 5010 (e.g., a speed of the vehicle 5010); transmit the information to a remote party (e.g., a provider such as a manufacturer or distributor of the tire 5034 and/or another component of the given one of the wheels 5020₁-5020₄, and/or of the vehicle 5010; etc.); etc. This may be useful, for example, to gain knowledge about the vehicle 5010, including the wheels 5020₁-5020₄, to enhance efficiency of the vehicle 5010, help prevent rapid wear or other deterioration of the wheels 5020₁-5020₄, facilitate maintenance (e.g., replacement or repair) of the tire 5034 and/or another component of each of the wheels 5020₁-5020₄, and/or for various other reasons.

In this embodiment, the ground surface 5011 is a road and the vehicle 5010 is a road vehicle that is designed to legally carry people or cargo on the road 5011, which is part of a public road infrastructure (e.g., public streets, highways, etc.). More particularly, in this embodiment, the road vehicle 5010 is a truck. In this example, the vehicle 5010 is a light truck for cargo transportation (e.g., having a gross vehicle weight rating (GVWR) greater than 6,001 lbs or 2,722 kg, such as in class 2 or higher according to the U.S. Department of Transportation's Federal Highway Administration (FHWA)). As will be appreciated, other examples can relate to trucks of any class or size, as well as any other vehicle requiring tires.

In addition to the wheels 5020₁-5020₄, in this embodiment, the vehicle 5010 comprises a frame, a powertrain, a steering system, a suspension, a cabin, and a control system. The vehicle 5010 has a longitudinal direction, a widthwise direction, and a heightwise direction.

The powertrain is configured to generate power for the vehicle 5010, including motive power for respective ones of the wheels 5020₁-5020₄ to propel the vehicle 5010 on the ground surface 5011. To that end, the powertrain comprises a power source (e.g., a primer mover) that includes one or more motors. For example, in some embodiments, the power source may comprise an internal combustion engine, an electric motor (e.g., powered by a battery), or a combination of different types of motor (e.g., an internal combustion engine and an electric motor). The powertrain can transmit power from the power source to one or more of the wheels 5020₁-5020₄ in any suitable way (e.g., via a transmission, a differential, a shaft engaging (i.e., directly connecting) a motor and a given one of the wheels 5020₁-5020₄, etc.).

The steering system is configured to steer the vehicle 5010 on the ground surface 5011. In this embodiment, the steering system is configured to turn front ones of the wheels 5020₁-5020₄ to change their orientation relative to the frame of the vehicle 5010 in order to cause the vehicle 5010 to move in a desired direction.

The suspension is connected between the frame and the wheels 5020₁-5020₄ to allow relative motion between the frame and the wheels 5020₁-5020₄ as the vehicle 5010 travels on the ground surface 5011. For example, the suspension may enhance handling of the vehicle 5010 on the ground surface 5011 by absorbing shocks and helping to maintain traction between the wheels 5020₁-5020₄ and the ground surface 5011. The suspension may comprise an arrangement of springs and dampers. A spring may be a coil spring, a leaf spring, a gas spring (e.g., an air spring), or any other elastic object used to store mechanical energy. A damper (also sometimes referred to as a “shock absorber”) may be a fluidic damper (e.g., a pneumatic damper, a hydraulic damper, etc.), a magnetic damper, or any other object which absorbs or dissipates kinetic energy to decrease oscillations. In some cases, a single device may itself constitute both a spring and a damper (e.g., a hydropneumatic device).

The cabin is configured to be occupied by one or more occupants of the vehicle 5010. In this embodiment, the cabin comprises a user interface configured to interact with one or more occupants of the vehicle 5010, including, in this example, the operator (e.g., a driver) of the vehicle 5010. The user interface comprises an input portion including one or more input devices (e.g., a set of buttons, levers, dials, etc., a touchscreen, a microphone, etc.) allowing an occupant of the vehicle 5010 to input commands and/or other information into the vehicle 5010 and an output portion including one or more output devices (e.g., a display, a speaker, etc.) to provide information to an occupant of the vehicle 5010. The output portion of the user interface which may comprise an instrument panel (e.g., a dashboard) which provides indicators (e.g., a speedometer indicator, a tachometer indicator, etc.) related to operation of the vehicle 5010.

The wheels 5020₁-5020₄ engage the ground surface 5011 for traction of the vehicle 5010. Each wheel 5020ᵢ comprises its tire 5034 for contacting the ground surface 5011 and a hub 5032 for connecting the wheel 5020ᵢ to an axle.

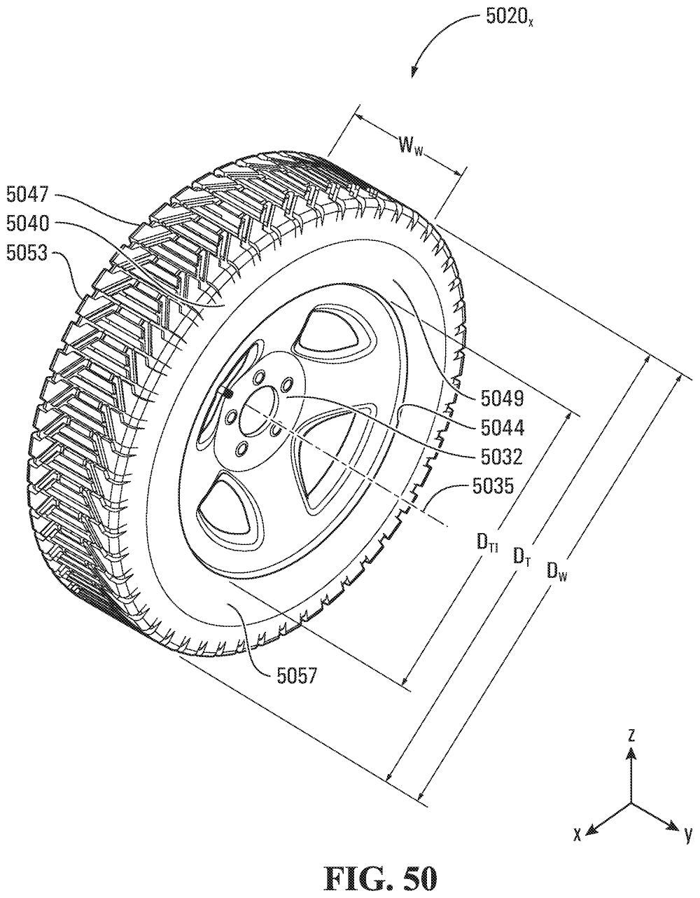

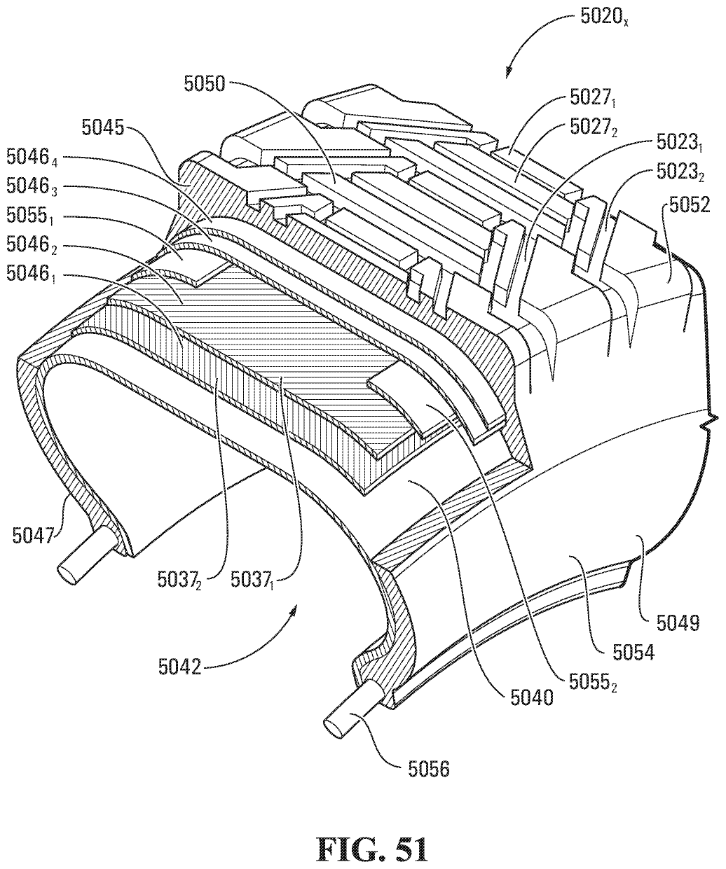

With additional reference to FIGS. 50 and 51, the wheel 5020ᵢ has an axis of rotation 5035, which defines an axial direction (also referred to as a “Y” direction) parallel to the axis of rotation 5035 of the wheel 5020ᵢ, a vertical direction (also referred to as a “Z” direction) that is normal to the axis of rotation 5035 of the wheel 5020ᵢ, and a horizontal direction (also referred to as a “X” direction) that is normal to the axis of rotation 5035 of the wheel 5020ᵢ and the vertical direction and can be viewed as corresponding to a heading direction of the wheel 5020ᵢ. The axial direction of the wheel 5020ᵢ can also be referred to as a lateral or widthwise direction of the wheel 5020ᵢ, while each of the vertical direction and the horizontal direction of the wheel 5020ᵢ can also be referred to as radial direction of the wheel 5020ᵢ (also referred to as a “R” direction). The wheel 5020ᵢ also has a circumferential direction (also referred to as a “C” direction). The wheel 5020ᵢ has an outer diameter D_{W} and a width W_{W}. It comprises an inboard lateral side 5047 for facing towards a center of the vehicle 5010 in the widthwise direction of the vehicle 5010 and an outboard lateral side 5049 opposite its inboard lateral side 5047.

Similarly, the tire 5034 has an axial direction, a vertical direction and a horizontal direction that each are a radial direction, and a circumferential direction, which respectively correspond to the axial direction, the vertical direction and the horizontal direction that each are the radial direction, and the circumferential direction of the wheel 5020ᵢ, has an inner diameter D_{TI}, an outer diameter D_{T}, and a width W_{T}, and comprises an inboard lateral side 5053 and an outboard lateral side 5057, which are respectively part of the inboard lateral side 5047 and the outboard lateral side 5049 of the wheel 5020ᵢ.

When it is in contact with the ground surface 5011, the tire 5034 has an area of contact with the ground surface 5011, which may be referred to as a “contact patch” of the tire 5034 with the ground surface 5011.

In this embodiment, the tire 5034 is a pneumatic tire, which comprises a body 5040 to define a cavity 5042 containing pressurized gas (e.g., air) to support loading on the tire 5034 and allow the tire 5034 to be resiliently deformable (i.e., changeable in configuration) as it contacts the ground surface 5011. The tire 5034 is configured to be mounted to a rim 5044 of the hub 5032 to form the cavity 5042 containing the pressurized gas. Inflation pressure of the tire 5034 is suitable for use of the vehicle 5010.

More particularly, in this embodiment, the tire 5034 comprises a tread 5050, a shoulder 5052, a sidewall 5054, and a bead 5056. The tread 5050 is configured to contact the ground surface 5011 and enhance traction. The tread 5050 may comprise a plurality of tread recesses 5023₁-5023_{R} and a plurality of tread projections 5027₁-5027_{P} such that each of the tread recesses 5023₁-5023_{R} is disposed between adjacent ones of the tread projections 5027₁-5027_{P}. The tread 5050 may be implemented in any suitable way in other embodiments (e.g., may have a smooth outer surface without tread recesses or projections). The bead 5056 is configured to engage the rim 5044. The sidewall 5054 extends between the tread 5050 and the bead 5056 and contains the pressurized gas within the cavity 5042. The shoulder 5052 is a transition between the tread 5050 and the sidewall 5054.

The tire 5034 comprises elastomeric material 5045 to allow the tire 5034 to be resiliently deformable. The elastomeric material 5045 can include any polymeric material with suitable elasticity. In this embodiment, the elastomeric material 5045 includes rubber. Various rubber compounds may be used and, in some cases, different rubber compounds may be present in different areas of the tire 5034. In other embodiments, the elastomeric material 5045 may include another elastomer in addition to or instead of rubber (e.g., polyurethane elastomer).

Also, the tire 5034 comprises reinforcement 5040 disposed within (e.g., embedded in) the elastomeric material 5045 to reinforce the tire 5034. In this embodiment, the reinforcement 5040 comprises a plurality of reinforcing members 5046₁-5046_{R} each of which can be stiffer and stronger than the elastomeric material 5045 to reinforce the tire 5034 in one or more directions. For example, a given one of the reinforcement members 5046₁-5046_{R} may be metallic in that it is at least mainly (i.e., mainly or entirely) made of metal. As another example, a given one of the reinforcing members 5046₁-5046_{R} may be polymeric but non-elastomeric in that it is at least mainly made of polymeric but non-elastomeric material (e.g., nylon, polyester, aramid, etc.).

More particularly, in this embodiment, each of the reinforcing members 5046₁, 5046₂ is a belt running in the circumferential direction of the tire 5034. In this example, each of the belts 5046₁, 5046₂ comprises a layer of reinforcing cables 5037₁-5037_{M} that extend generally parallel to one another. In this example, the reinforcing cables 5037₁-5037_{M} of the belt 5046₂ extend diagonally to the circumferential direction tire, and in the general direction of outboard lateral side 5049 of the tire 5034 to reinforce the tire 5034 in that direction, whereas the reinforcing cables 5037₁-5037_{M} of the belt 5046₁ extend diagonally to the circumferential direction tire, and in the general direction of the inboard lateral side 5047 of tire 5034 to reinforce the tire 5034 in that direction. In other examples, the reinforcing cables 5037₁-5037_{M} of the belt 5046₁ extend in the circumferential direction of the tire 5034 to reinforce the tire 5034 in that direction, whereas the reinforcing cables 5037₁-5037_{M} of the belt 5046₂ extend transversally to the circumferential direction of the tire 5034 to reinforce the tire 5034 in that direction. In this embodiment, each of the reinforcing cables 5037₁-5037_{M} of the each of belts 5046₁, 5046₂ is a cord including a plurality of strands (e.g., metallic fibers or wires). Specifically, in this embodiment, each of the reinforcing members 5046₁, 5046₂ is a metallic (e.g., steel) belt in which the reinforcing cables 5037₁-5037_{M} are metallic.

In some embodiments, the belts 5046₁, 5046₂ are separated by belt edge wedges 5055₁ and 5055₂ extending circumferentially around the tire 5034 between the edges of the belts 5046₁, 5046₂. The belt edge wedges 5055₁ and 5055₂ are configured to suppress the formation of cracks at the edges of the belts 5046₁, 5046₂.

Also, in this embodiment, each of the reinforcing members 5046₃, 5046₄ is a layer of reinforcing fabric. Each of the layers of reinforcing fabric 5046₃, 5046₄ comprises thin pliable material made usually by weaving, felting, knitting, interlacing, or otherwise crossing natural or synthetic elongated fabric elements, such as fibers, filaments, strands and/or others, such that some elongated fabric elements extend transversally others. For instance, each of the layers of reinforcing fabric 5046₃, 5046₄ may comprise a ply of reinforcing woven fibers (e.g., nylon, polyester, aramid, and/or other synthetic fibers).

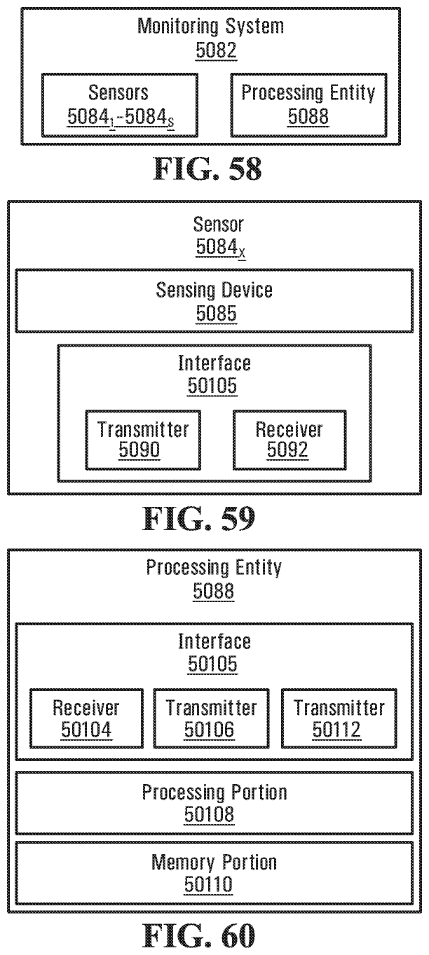

In this embodiment, with additional reference to FIG. 58, a monitoring system 5082 is configured to monitor the vehicle 5010 including the wheels 5020₁-5020_{W} to obtain information regarding the vehicle 5010 such as information regarding the tire 5034 of a given one of the wheels 5020₁-5020_{W} that can be used for various purposes, such as, for example, to: convey the information to a user (e.g., the operator); control the vehicle 5010 (e.g., a speed of the vehicle 5010); transmit the information to a remote party (e.g., a provider such as a manufacturer or distributor of the tire 5034 and/or another component of the given one of the wheels 5020₁-5020_{W} and/or of the vehicle 5010, etc.); etc. This may be useful, for example, to gain knowledge about the vehicle 5010, including the wheels 5020₁-5020_{W}, to enhance efficiency of the vehicle 5010 help prevent rapid wear or other deterioration of the tire 5034 and/or other component of the given one of wheels 5020₁-5020_{W} facilitate maintenance (e.g., replacement or repair) of the tire 5034 and/or other component of the given one of the wheels 5020₁-5020_{W} and/or for various other reasons.

The information regarding the vehicle 5010 that is obtained by the monitoring system 5082 may include information regarding the tire 5034 and/or another component of a wheel 5020ᵢ. For example, in some embodiments, the information regarding the tire 5034 and/or other component of the wheel 5020ᵢ that is obtained by the monitoring system 5082 may include one or more parameters of the tire 5034, such as:
an indication of deterioration of the tire 5034 (e.g., an indication of a level of wear, a rupture, a break, etc.);
an identifier of the tire 5034 such as a serial number, a make, a model, a type, and/or any other information identifying the tire 5034 (i.e., indicating an identity of the tire 5034); and/or
any other information about the tire 5034.

In this embodiment, the monitoring system 5082 comprises a plurality of sensors 5084₁-5084ₛ for monitoring the vehicle 5010, including the wheels 5020₁-5020_{W}, and their tire 5034 and a processing entity 5088 for performing certain actions based on input from the sensors 5084₁-5084ₛ. For example, in various embodiments, actions performed by the processing entity 5088 based on input from the sensors 5084₁-5084ₛ may include an action to convey the information regarding the vehicle 5010 (e.g., the information regarding the tire 5034 and/or another component of a given one of the wheels 5020₁-5020_{W}) an action to store the information regarding the vehicle 5010 and/or an action relating to the operation of the vehicle 5010, such as, for example, controlling the speed and/or another operational aspect of the vehicle 5010, and/or providing information to the operator of the vehicle 5010.

Each of the sensors 5084₁-5084ₛ is configured to detect deterioration of a tire 5034 and to issue a sensor signal derived based on the detection. Each of the sensors 5084₁-5084ₛ comprises a sensing device 5085 to detect deterioration.

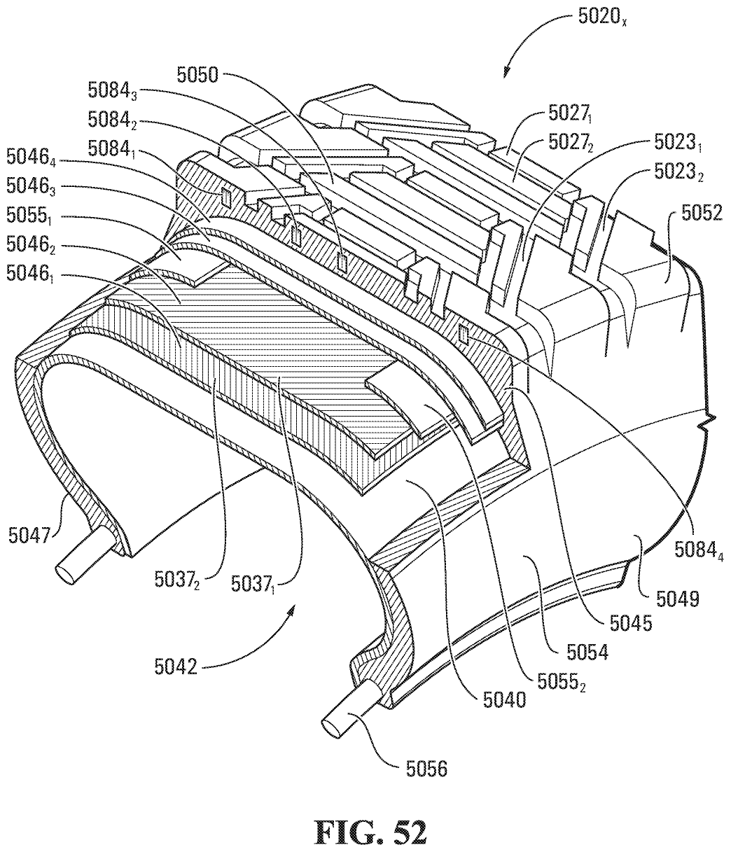

In this embodiment, as shown in FIG. 52, the tire 5034 of a wheel 5020ᵢ comprises at least one sensor 5084ₓ. For instance, in this embodiment, the sensor 5084ₓ is embedded within the elastomeric material 5045 of the tire 5034. This may allow degradation of the elastomeric material to be detected by the sensor 5084ₓ. For example, in embodiments where the sensor 5084ₓ is to detect degradation of the tire 5034, the sensor 5084ₓ may be located in an area of increased degradation within the tire 5034, such as an area close to a surface of the elastomeric material 5045 of the tire 5034. More particularly, in this embodiment, the sensor 5084ₓ may be disposed within the elastomeric material 5045 of the tread 5050 of the tire 5034. For instance, in this case, the sensor 5084ₓ may be disposed within the elastomeric material 5045 of a tread projection 5027ᵢ of the tread 5050.

As further discussed later, in this embodiment, the sensor 5084x may be configured to sense the deterioration of the tire 5034 irrespective of the inflation pressure of the tire 5034. Thus, the sensor 5084ₓ may sense the deterioration of the tire 5034 independently of the inflation pressure of the tire 5034, regardless of whether the tire 5034 is properly inflated or not and regardless of whether a puncture of the tire 5034 occurred to deflate the tire 5034. Indeed, in this embodiment, the sensor 5084ₓ is configured to sense the deterioration of the tire 5034 without sensing the inflation pressure of the tire 5034 (i.e., without sensing directly or indirectly the inflation pressure of the tire 5034). The sensor 5084ₓ is therefore operable irrespective of whether the tire 5034 and the vehicle 5010 have any tire-pressure monitoring system (i.e., any pressure sensor to directly measure the tire's inflation pressure or any mechanism to sense indirectly the tire's inflation pressure). Accordingly, in this example, the sensor 5084ₓ is configured to sense the deterioration of the tire 5034 before a reduction of the inflation pressure of the tire 5034 begins, such as due to puncturing of the tire 5034. This may allow detection of a crack or other failure in the tire 5034 that could lead to a puncture before the puncture actually occurs.

In this example, respective ones of the sensors 5084₁-5084ₛ are disposed in the elastomeric material 5045 of respective ones of the tread projections 5027₁-5027ᵢ. As such, an amount of degradation of the elastomeric material of each tread projections 5027₁-5027ᵢ can be detected. Although it is possible to have a sensor 5084ₓ within each tread projection 5027ᵢ, this may not be the case in some embodiments. For example, in this embodiment, three or four of the sensors 5084₁-5084ₛ provided within respective ones of the tread projections 5027₁-5027ᵢ may enable assessment of degradation to the tire 5034. In other cases, the tire 5034 may include only a single sensor 5084ₓ (e.g., in only a single one of the tread projections 5027₁-5027ᵢ).

The sensor 5084ₓ may be provided and retained within the elastomeric material 5045 of the tread projections 5027₁-5027ᵢ in various ways. For instance, in some embodiments, the sensor 5084ₓ is placed in a mold used for molding of the tire 5034 and the elastomeric material 5045 is molded over the sensor 5084ₓ. For example, this may involve disposing a first layer of elastomeric material (e.g., destined to form part of the elastomeric material 5045 of the tread projections 5027₁-5027ᵢ) within the mold, positioning the sensor 5084ₓ on the first layer of elastomeric material, and disposing a second layer of elastomeric material (e.g., destined to form part of the elastomeric material 5045 of the tread projections 5027₁-5027ᵢ) on top of the first layer of elastomeric material such as to effectively sandwich the sensor 5084ₓ between the first and second layers of elastomeric material.

In some embodiments, an adhesive may be used to help retention of the sensor 5084ₓ in elastomeric material. For example, the adhesive may be a metal-to-elastomer adhesive such as Chemlok™ or any other suitable metal-to-elastomer adhesive.

In some cases, the sensor 5084ₓ may be inserted into the elastomeric material 5045 of the tread projections 5027₁-5027ᵢ after molding of the elastomeric material 5045 of the tread projection 5027ᵢ. For example, in a post-molding operation, the tread projections 5027₁-5027ᵢ may be opened (e.g., via drilling a hole or making an incision) and the sensor 5084ₓ inserted into the elastomeric material 5045 of the tread projections 5027₁-5027ᵢ. The tread projection 5027ᵢ may be sealed thereafter. In such cases, the sensor 5084ₓ may be retained in the tread projection 5027ᵢ by overmolding (i.e., molding a layer of elastomeric material on top of an already molded layer of elastomeric material), by friction (e.g., a press-fit), by an adhesive, or by a fastener.

With reference to FIG. 59, the sensor 5084ₓ may comprise an interface 50105 comprising a transmitter 5090 for issuing a detection signal indicative of the physical aspect of the tire 5034 that is detected. In this embodiment, the transmitter 5090 is configured for transmitting the detection signal to the processing entity 5088, which comprises a receiver 50104 to receive the detection signal from the sensor 5084ₓ. The sensor 5084ₓ further comprises a sensing device, arranged to affect a physical characteristic of the sensor 5084ₓ once a characteristic of the tire 5034 altered. For example, and as described in more detail below, in some embodiments, the sensing device 5085 can be arranged to detect an electrical change (e.g., a current flowing and/or a voltage variation in an electrical circuit) caused by physical degradation of the tire 5034.

The transmitter 5090 of the sensor 5084ₓ and the receiver 50104 of the processing entity 5088 may be connected in any suitable way. In this embodiment, the sensor 5084ₓ and the processing entity 5088 are connected wirelessly. Thus, in this embodiment, the transmitter 5090 of the sensor 5084ₓ is a wireless transmitter that can wirelessly transmit the detection signal and the receiver 50104 of the processing entity 5088 is a wireless receiver that can wirelessly receive the detection signal.

The sensor 5084ₓ may be disposed such that the detection signal issued by the sensor 5084ₓ has a signal strength sufficient to overcome a thickness of elastomeric material 5045 of the tire 5034 and the interference created by reinforcement member 5046₁-5046₄ along a path of the sensor signal.

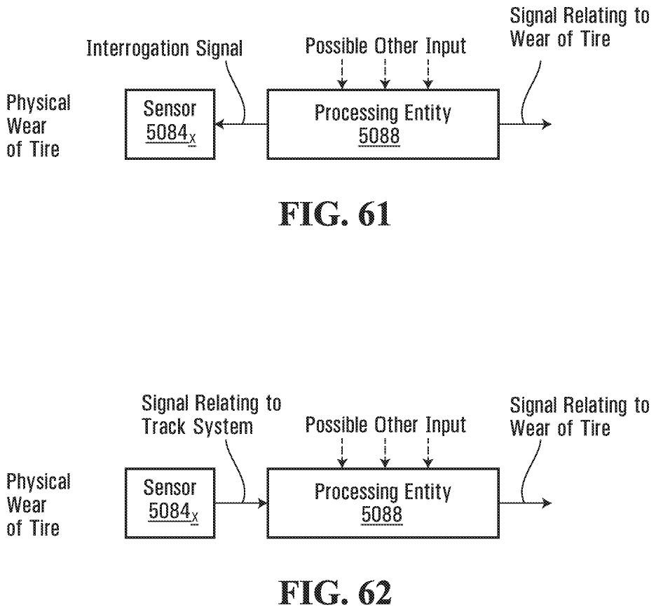

The detection signal may be issued by the sensor 5084ₓ in any suitable manner in various embodiments. For example, in this embodiment, as shown in FIG. 61, the processing entity 5088 is configured to issue an interrogation signal directed to the sensor 5084ₓ, which is configured to issue the sensor signal to the processing entity 5088 in response to the interrogation signal. Thus, in this embodiment, the processing entity 5088 comprises a transmitter 50106 to transmit the interrogation signal to the sensor 5084ₓ, the interface 50105 of which comprises a receiver 5092 to receive the interrogation signal. In this case, the transmitter 50106 of the processing entity 5088 is a wireless transmitter to wirelessly transmit the interrogation signal and the receiver 5092 of the interface 50105 of sensor 5084ₓ is a wireless receiver to wirelessly receive the interrogation signal. In some examples of implementation, the transmitter 5090 and the receiver 5092 of the sensor 5084ₓ may be implemented by a transceiver and/or the transmitter 50106 and the receiver 50104 of the processing entity 5088 may be implemented by a transceiver.

More particularly, in this embodiment, the sensor 5084ₓ and the processing entity 5088 implement radio-frequency identification (RFID) technology to communicate, including to wirelessly transmit the sensor signal from the sensor 5084ₓ to the processing entity 5088. In this case, the transmitter 5090 and the receiver 5092 of the sensor 5084ₓ implement an RFID element (e.g., an RFID tag) and the transmitter 50106 and the receiver 50104 of the processing entity 5088 implement an RFID element (e.g., an RFID reader).

The RFID element implemented by the transmitter 5090 and the receiver 5092 of the sensor 5084ₓ may be a passive RFID tag that is powered by the interrogation signal of the RFID element implemented by the transmitter 50106 and the receiver 50104 of the processing entity 5088, which may be an active RFID reader. That is, the RFID tag implemented by the transmitter 5090 and the receiver 5092 of the sensor 5084ₓ is electromagnetically powered by the interrogation signal of the RFID reader implemented by the transmitter 50106 and the receiver 50104 of the processing entity 5088. The power generated through this interaction may then be used by the RFID tag to issue the sensor signal.

In this example of implementation, the RFID tag implemented by the transmitter 5090 and the receiver 5092 of the sensor 5084ₓ enables the detection entity 50140 of the sensor 5084ₓ to make a reading of the physical aspect of the sensing device 5085 in the tire 5034. More specifically, when the RFID tag is powered by the interrogation signal of the RFID reader, at least part of the power is routed to the detection entity 50140 in order for the detection entity 50140 to make a reading of the sensing device 5085. The transmitter 5090 then issues the detection signal the RFID reader implemented by the transmitter 50106 and the receiver 50104 of the processing entity 5088.

In other embodiments, the sensor 5084ₓ may be configured to issue the detection signal to the processing entity 5088 autonomously (i.e., without receiving any interrogation signal). For instance, in some embodiments, such as the one shown in FIG. 62, the transmitter 5094 of the sensor 5084ₓ may issue the detection signal to the processing entity 5088 repeatedly (e.g., periodically or at some other predetermined instants).

For instance, in other embodiments, the RFID element implemented by the transmitter 5090 and the receiver 5092 of the sensor 5084ₓ may be an active RFID tag or a battery-assisted passive (BAP) RFID tag.

For example, an active RFID tag implemented by the transmitter 5090 and the receiver 5092 of the sensor 5084ₓ has its own power source (e.g., a battery) to enable the entire functionality of the active RFID tag. That is, the active RFID tag's power source enables the sensor 5084ₓ to make a reading of the physical degradation of the tire 5034 that is detected by the sensor 5084ₓ and also enables the transmitter 5094 to issue the detection signal to the RFID reader (i.e., the processing entity 5088). Thus, in this case, the active RFID tag can implement its functions independently of the RFID reader. In such a case, the power source (i.e., the battery) of the active RFID tag may be configured to provide power to the RFID tag for an amount of time at least as great, and in some cases greater, than a lifetime of the tire 5034 (i.e., a span of time that the tire 5034 is expected to last).

Conversely, a BAP RFID tag's power source (e.g., a battery) only enables part of the BAP RFID tag's functions. For instance, the power source may enable the sensor 5084ₓ to record a reading of the physical degradation of the tire 5034 that is detected by the sensor 5084ₓ. However the BAP RFID tag is dependent on the interrogation signal of the RFID reader (i.e., the processing entity 5088) to power the transmitter 5094 to issue the sensor signal to the processing entity 5088.

Therefore, in various embodiments, the sensor 5084ₓ may comprise a power source for its operation and/or may harvest energy from its environment (e.g., inductively from an interrogation signal; by a piezoelectric effect; etc.) for its operation.

In this embodiment, the sensor 5084ₓ comprises a housing that houses components of the sensor 5084ₓ and is configured to protect the sensor 5084ₓ (e.g., by preventing intrusion of particles that may be damaging to the sensor 5084ₓ, protecting against heat, preventing excessive deformation, etc.).

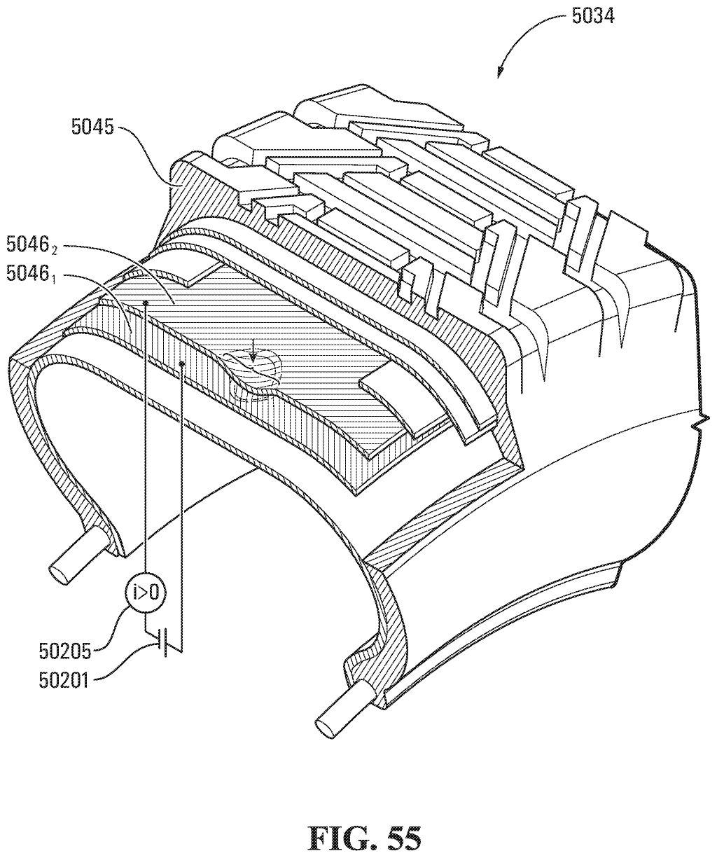

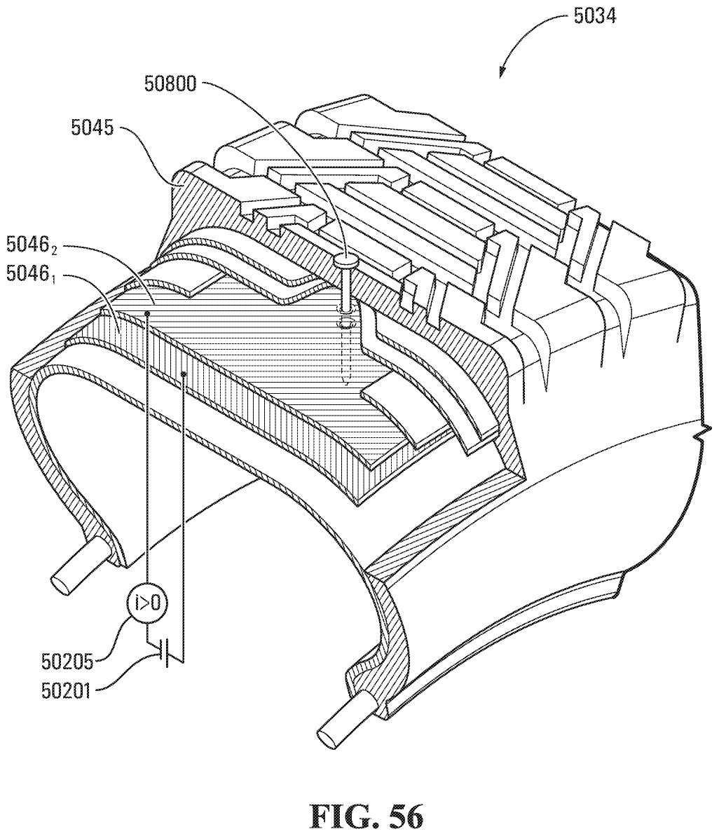

The sensor 5084ₓ may be disposed elsewhere on the tire 5034. For example, in some embodiments, such as those shown in FIGS. 55 and 56, the sensor 5084ₓ may be disposed in the elastomeric material 5045 of the tire 5034 (e.g. between reinforcing members 5046₁-5046₄).

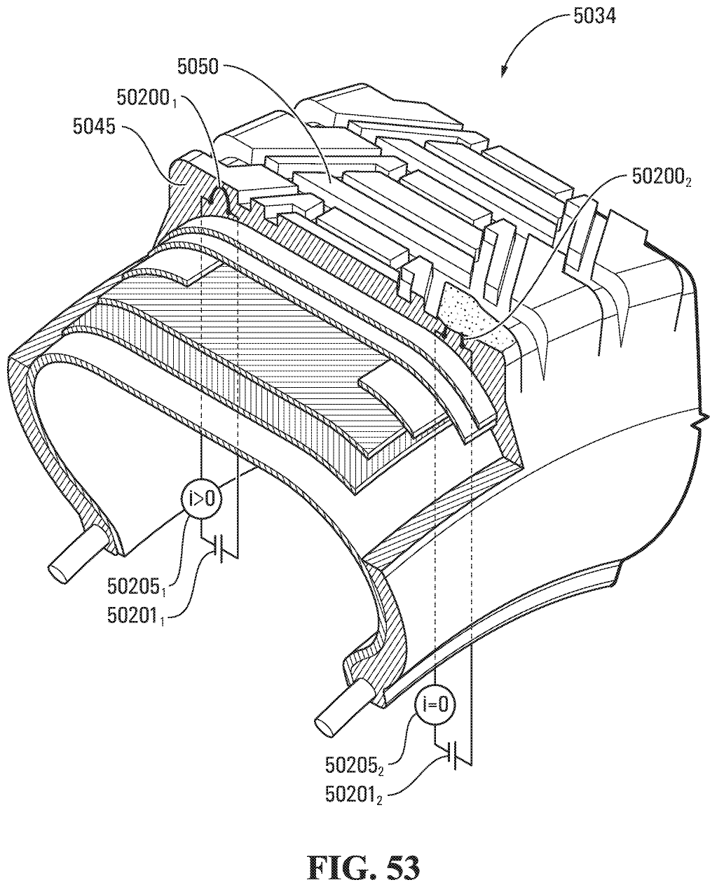

In some embodiments, as set out below with reference to FIGS. 53 to 56, one or more of the sensors 5084₁-5084ₛ may be arranged to sense a plurality of tire deteriorations, and to issue corresponding detection signals. Example of such failures or other deteriorations include, but are not limited to, normal tire degradation, such as tread 5050 wear, as well as loss of tire component integrity, such as punctures, chunking, broken or de-bonded reinforcement members 5046₁-5046₄.

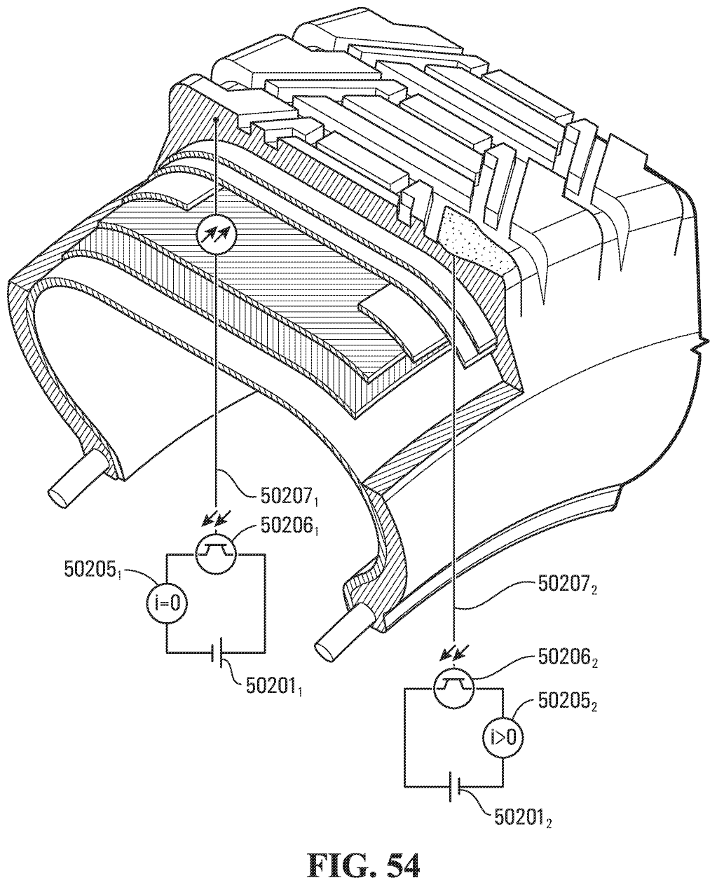

FIGS. 53 and 54 show embodiments for detecting normal tread wear of the elastomeric material 5045 of the tire 5034.

With additional reference to FIG. 53, in some embodiments, the sensing device 5085 of the sensor 5084ₓ comprises an electrical detector 50205ₓ configured to detect an electrical change such as a variation in a current flowing or a voltage across the electrical detector 50205ₓ. More particularly, in this embodiment, the sensing device 5085 comprises a power source 50201ₓ, a closed electrical detection circuit having at least one sacrificial part 50200ₓ and the electrical detector 50205ₓ that is a current detector, all of which are imbedded in the tire 5034. The current detector 50205ₓ is arranged to measure the current in the electrical detection circuit. The sacrificial part 50200ₓ is arranged to break the electrical detection circuit when the tire is sufficiently degraded. Accordingly, at least a length of the sacrificial part 50200ₓ is located in an area of the tire 5034 in which degradation is expected, and at a depth to which degradation of the elastomeric material 5045 is to be detected. The sacrificial part 50200ₓ can be made of any suitable electrically conductive material capable of breaking, snapping, and/or otherwise degrading, to an extent sufficient to open the electrical detection circuit when the elastomeric material 5045 of the tire 5034 surrounding at least a piece of the sacrificial part is degraded. Alternatively, the sacrificial part 50200ₓ can be made of any suitable electrically conductive material arranged to be dislodged from the tire 5034 when all or part of the elastomeric material 5045 surrounding the sacrificial part 50200ₓ is degraded.

In the example shown in FIG. 53, a first section of the ground-engaging side of the tire 5034 is not degraded, and the sacrificial part 50200₁ is intact and completely surrounded by the elastomeric material 5045 of the tread 5050. Accordingly, the electrical detection circuit is closed and the power source 50201₁ causes the current detector 50205₁ to detect a positive current through the electrical circuit. As also shown in FIG. 53, a second section of the ground-engaging part of the tire however is degraded, and the sacrificial part 50200₂ is no longer intact, having been degraded and/or broken and/or dislodged from the tire 5034, along with the surrounding elastomeric material of the tread 5050. Accordingly, the electrical detection circuit 50205₂ is opened and the current detector 50205₂ to detects a nil or negligible current value through the electrical detection circuit.

In the example of FIG. 53, the sensor 5084ₓ is therefore arranged to issue a detection signal when the elastomeric material of the tread 5050 on the ground engaging side of the tire 5034 has degraded to a predetermined depth.

As will be appreciated, each of the above components of the sensing device 5085 can be replaced with functionally equivalent components. For example, in the present example, the power source 50201ₓ is the same power source as that of sensor 5084ₓ (e.g. battery, piezo-electric, etc.). In other embodiments however, the power source 50201ₓ of sensing device 5085 can be different to that of sensor 5084ₓ. Moreover, the electrical detector 50205ₓ of sensing device 5085 could be a voltage detector instead of a current detector. The sensing device 5085 could also incorporate any other suitable means of detecting whether the electrical detection circuit has been broken by a degradation of the sacrificial part 50200ₓ. In some embodiments, the sacrificial part 50200ₓ can be the only part of the sensor that is embedded in the tire 5034. In other embodiments, however, the entire sensor 5084ₓ, or any part thereof, can be embedded in the tire 5034.

In another embodiment, and with reference to FIG. 54, the sensing device 5085 comprises an optical detector 50206ₓ configured to detect an optical change such as a variation in light intensity. More particularly, in this embodiment, the sensing device 5085 comprises a length of optical fiber 50207ₓ that is embedded in the elastomeric material 5045 of the tire 5034, as well as a closed electrical detection circuit including a power source 50201ₓ, a current detector 50205ₓ and a phototransistor 50206ₓ. One end of the optical fiber 50207ₓ is located in an area of the tread 5050 in which degradation is expected, and at a depth to which degradation of the elastomeric material 5045 is to be detected. The other end of the optical fiber 50207ₓ is optically coupled to a phototransistor 50206ₓ which is arranged to allow current to flow through the electrical detection circuit when light is introduced into the optical fiber 50207ₓ.

In the example shown in FIG. 54, a first section of the ground-engaging side of the tire 5034 is not degraded, and the optical fiber 50207₁ is completely surrounded by the elastomeric material 5045 of the tread 5050. Accordingly, a negligible amount of light is captured by the optical fiber 50207₁ and the phototransistor 50206₁ is in a cut-off state. The electrical detection circuit is therefore open and the current detector 50205₁ detects a nil or negligible current value through the electrical detection circuit. As also shown in FIG. 54, a second section of the ground-engaging part of the tire 5034 however is degraded, and part of the optical fiber 50207₂ is exposed. Despite typically being covered with debris (e.g., soil, mud, sand, ice, snow, etc.), the exposed portion of optical fiber 50207₂ receives more light than in a state of being completely embedded in the elastomeric material 5045 of the tread 5050. This difference in the amount of light being received is detected by the phototransistor 50205₂. Accordingly, the electrical detection circuit 50205₂ is closed and the current detector 50205₂ detects an increase in the current value through the electrical detection circuit.

In the example of FIG. 54, the sensor 5084ₓ is therefore arranged to issue a detection signal when the elastomeric material of the tread 5050 on the ground engaging side of the tire has degraded to a predetermined depth.

As will be appreciated, each of the above components of the sensing device 5085 can be replaced with functionally equivalent components. For example, in the present example, the power source 50201ₓ is the same power source as that of sensor 5084ₓ (e.g. battery, piezo-electric, etc.). In other embodiments however, the power source 50201ₓ of sensing device 5085 can be different to that of sensor 5084ₓ. Moreover, the sensing device 5085 could be arranged to incorporate a voltage detector instead of incorporating a current detector 50205ₓ. Moreover, the optical components of the above-described embodiment can be replaced with functionally equivalent components. For example, the current detector 50205ₓ and the phototransistor 50206ₓ could be replaced with another photosensitive detector, such as a single-pixel charge-coupled device (CCD), or any other suitably sensitive light sensor.

FIG. 55 shows embodiments for sensing or detecting a loss of tire component integrity, such as metallic belt 5046₁, 5046₂ de-bonding. In this embodiment, each individual reinforcing members 5046₁, 5046₂ can be attached to the sensor 5084ₓ. The sensor 5084ₓ comprises a sensing device 5085, a power source 5020₁ arranged to create a difference of potential between a first reinforcing member 5046₁ and a second reinforcing member 5046₂. The sensor 5084x also comprises a current detector 50205. As shown in FIG. 55, when first reinforcing member 5046₁ and second reinforcing member 5046₂ come into electrical contact, a non-nil or non-negligible current flows from one end of the power source 50201, through a first reinforcing member 5046₁ and a second reinforcing member 5046₂. Then the non-nil or non-negligible current flows back to the other end of the power source 50201, by way of the current detector 50205. Accordingly, by monitoring the current flow through the current detector, it is possible to detect whether the first reinforcing member 5046₁ and a second reinforcing member 5046₂ have come into electrical contact, which could indicate the presence of reinforcing member 5046₁, 5046₂ de-bonding.

FIG. 56 shows another example of sensing or detecting a loss of tire component integrity using the device of arrangement of FIG. 55. In this embodiment, each individual reinforcing members 5046₁, 5046₂ can be attached to the sensor 5084ₓ. The sensor 5084x comprises a sensing device 5085, a power source 50201 arranged to create a difference of potential between a first reinforcing member 5046₁ and a second reinforcing member 5046₂. The sensor 5084ₓ also comprises a current detector 50205. As shown in FIG. 56, when a puncture resulting from an electrically-conductive penetrating object 50800 (e.g. a nail) causes the first reinforcing member 5046₁ and second reinforcing member 5046₂ to come into electrical contact, a non-nil or non-negligible current flows from one end of the power source 5020₁, through the first reinforcing member 5046₁, the electrically conductive penetrating object 50800, and the second reinforcing member 5046₂. Then the non-nil or non-negligible current flows back to the other end of the power source 5020₁, by way of the current detector 50205. Accordingly, by monitoring the current flow through the current detector 50205, it is possible to detect whether a puncture resulting from an electrically-conductive penetrating object 50800 has electrically-connected the first reinforcing member 5046₁ and the second reinforcing member 5046₂.

As will be appreciated, each of the above components of the sensing device 5085 can be replaced with functionally equivalent components. For example, in the present example, the power source 50201 is the same power source as that of sensor 5084ₓ (e.g. battery, piezo-electric, etc.). In other embodiments however, the power source 50201 of sensing device 5085 can be different to that of sensor 5084ₓ.

Moreover, the sensing device 5085 could be arranged to incorporate a voltage detector instead of incorporating a current detector 50205. The sensing device 5085 could also incorporate any other suitable means of detecting whether electrical connection has been established between a first reinforcing member 5046₁ and a second reinforcing member 5046₂. In some embodiments, the entire sensor 5084ₓ, or any part thereof, can be embedded in the tire 5034.

In the examples of FIGS. 55 and 56, the sensor 5084ₓ is therefore arranged to issue a detection signal when a first electrically-conductive reinforcing member 5046ₓ comes into electrical contact with a second electrically-conductive reinforcing member 5046_{y}, which can be indicative of reinforcing member 5046ᵢ; de-bonding or an electrically conductive penetrating object 50800 having punctured both a first reinforcing member 5046₁ and a second reinforcing member 5046₂.

The sensors 5084ₓ may be implemented in any other suitable way in other embodiments.

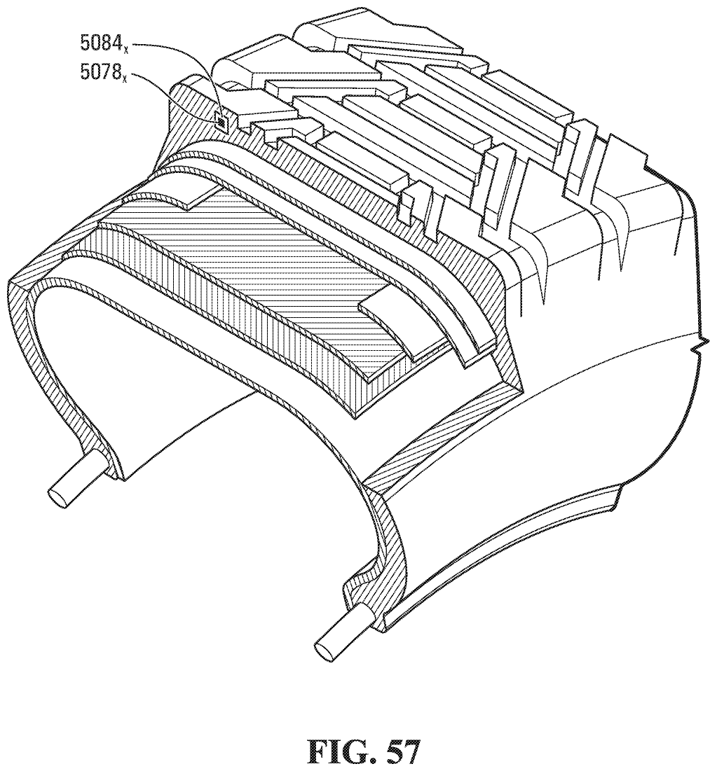

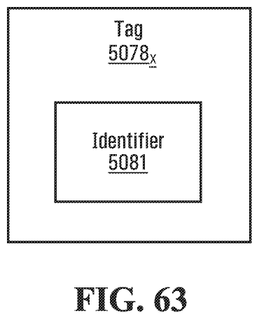

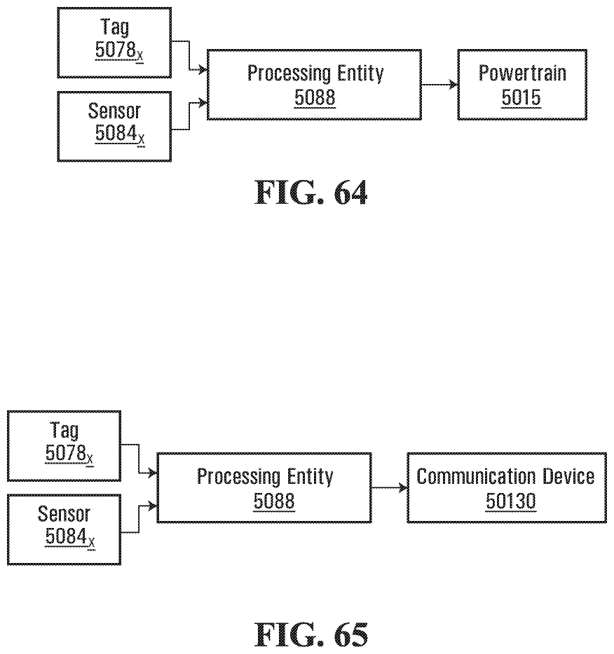

With additional reference to FIGS. 57 and 63, in some embodiments, the tire 5034 may comprise one or more tags 5078ₓ configured to identify the tire 5034. For example, in some embodiments, as further discussed below, the processing entity 5088 of the monitoring system 5082 may perform certain actions in respect of the vehicle 5010 based on identification of the tire 5034 using a tag 5078ₓ, such as controlling the vehicle 5010 (e.g., the speed of the vehicle 5010, etc.) based on what is identified and/or conveying information relating to what is identified to a remote party (e.g., a provider such as a manufacturer or distributor of the tire 5034 and/or of the vehicle 5010) who can act based on what is identified (e.g., manage a warranty, prepare for maintenance of the vehicle 5010, order and/or ship a replacement tire or other component, etc.).

Each of the tags 5078₁-5078_{G} is an identification element that is part of a component (e.g., a tire 5034) and configured to convey an identifier 5081 of that tire 5034, such as a serial number, a make, a model, a type, and/or any other information identifying (i.e., indicating an identity of) that tire 5034, to allow identification of that tire 5034.

The tags 5078₁-5078_{G} may be implemented in any suitable way in various embodiments. For example, in some embodiments, a tag 5078ₓ may be an RFID tag configured to wirelessly transmit an identification signal conveying the identifier 5081 to the processing entity 5088 of the monitoring system 5082, in which case the processing entity 5088 comprises an RFID reader. As another example, in some embodiments, a tag 5078ₓ may be an optical tag configured to allow the identifier 5081 to be optically determined by the processing entity 5088 of the monitoring system 5082, in which case the processing entity 5088 comprises an optical device (e.g., an infrared reader, a camera, etc.) to optically read the identifier 5081 from the tag 5078ₓ. As yet another example, in some embodiments, a tag 5078ₓ may be a magnetic tag configured to allow the identifier 5081 to be magnetically determined by the processing entity 5088 of the monitoring system 5082, in which case the processing entity 5088 comprises a magnetic reader.

For instance, in this embodiment, with additional reference to FIG. 56, a tag 5078ₓ is part of the tire 5034 to convey the identifier 5081 of the tire 5034. More particularly, in this embodiment, the tag 5078ₓ is an RFID tag configured to wirelessly transmit an identification signal conveying the identifier 5081 to the processing entity 5088 of the monitoring system 5082, in which case the processing entity 5088 comprises an RFID reader. In this example, a sensor 5084ₓ of the tire 5034 also implements RFID and thus may include the tag 5078ₓ (i.e., the sensor 5084ₓ and the tag 5078ₓ constitute a common element sharing a common transmitter to transmit the identification signal and the sensor signal, which may both be part of a common signal). In other examples, the tag 5078ₓ may be physically distinct from any sensor 5084ₓ of the tire 5034 (e.g., the tag 5078ₓ and the sensor 5084ₓ may comprise respective transmitters to transmitting the identification signal and the sensor signal).

The processing entity 5088 of the monitoring system 5082 is configured to perform actions based on signals from the sensor 5084₁-5084ₛ and/or the tags 5078₁-5078_{G} and possibly based on other input and/or information.

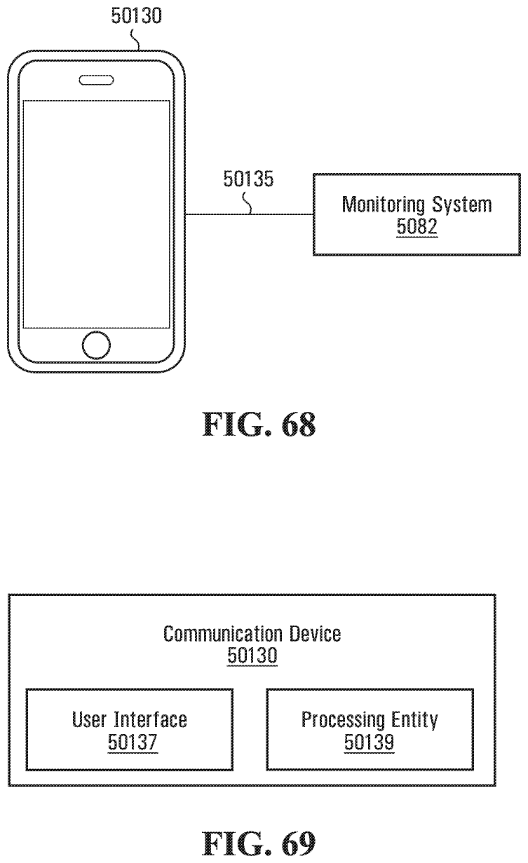

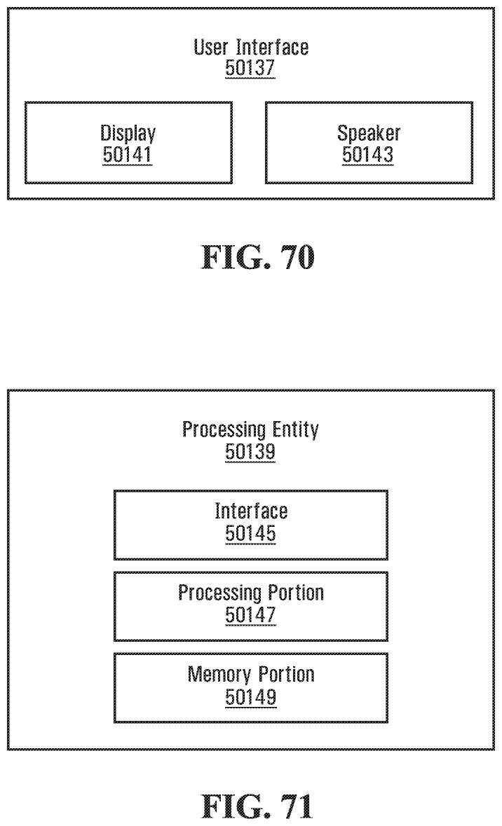

For example, in some embodiments, the processing entity 5088 may issue an output signal relating to the operation of the vehicle 5010 based on the sensor signal from a sensor 5084ₓ of the tire 5034 and/or the identification signal from a tag 5078ₓ of the tire 5034. For instance, in some embodiments, as shown in FIG. 68, the output signal issued by the processing entity 5088 may be directed to the powertrain 5015 of the vehicle 5010 to control the operation (e.g., the speed) of the vehicle 5010 based on detection of the physical degradation of the tire 5034 detected by the sensor 5084ₓ and/or the identity of the tire 5034. In other embodiments, the output signal issued by the processing entity 5088 may be directed to a communication device (e.g., comprising a display) for outputting information regarding the operation of the vehicle 5010 to the operator of the vehicle 5010. As another example, in some embodiments, the processing entity 5088 may issue an output signal conveying information about the tire 5034 (e.g., attainment of a threshold of degradation of the tire 5034, the identifier 5081 of the tier 5034, etc.). As another example in some embodiments, the processing entity 5088 may store information about the tire 5034 in memory (e.g., for future reference), such as attainment of a threshold of degradation of the tire 5034, the identity of the tire 5034, etc. at a given moment (e.g., date and time).

To that end, in this embodiment, the processing entity 5088 comprises an interface 50102, a processing portion 50108, and a memory portion 50110, which are implemented by suitable hardware and/or software.

The interface 50102 comprises one or more inputs and outputs allowing the processing entity 5088 to receive input signals from and send output signals to other components to which the processing entity 5088 is connected (i.e., directly or indirectly connected), including, in this embodiment, the sensors 5084₁-5084ₛ and the tags 5078₁-5078_{G}. For example, in this embodiment, an input of the interface 50102 is implemented by the wireless receiver 50104 to receive the sensor signal from a sensor 5084ₓ and the identification signal from a tag 5078ₓ. An output of the interface 50102 is implemented by a transmitter 50112 to transmit the output signal relating to the operation of the vehicle 5010. Another output of the interface 50102 is implemented by the wireless transmitter 50106 to transmit the interrogation signal to a sensor 5084ₓ and/or a tag 5078ₓ.

The processing portion 50108 comprises one or more processors for performing processing operations that implement functionality of the processing entity 5088. A processor of the processing portion 50108 may be a general-purpose processor executing program code stored in the memory portion 50110. Alternatively, a processor of the processing portion 50108 may be a specific-purpose processor comprising one or more preprogrammed hardware or firmware elements (e.g., application-specific integrated circuits (ASICs), electrically erasable programmable read-only memories (EEPROMs), etc.) or other related elements.

The memory portion 50110 comprises one or more memories for storing program code executed by the processing portion 50108 and/or data used during operation of the processing portion 50108. A memory of the memory portion 50110 may be a semiconductor medium (including, e.g., a solid-state memory), a magnetic storage medium, an optical storage medium, and/or any other suitable type of memory. A memory of the memory portion 50110 may be read-only memory (ROM) and/or random-access memory (RAM), for example.

In some embodiments, two or more elements of the processing entity 5088 may be implemented by devices that are physically distinct from one another and may be connected to one another via a bus (e.g., one or more electrical conductors or any other suitable bus) or via a communication link which may be wired, wireless, or both. In other embodiments, two or more elements of the processing entity 5088 may be implemented by a single integrated device.

The processing entity 5088 may be implemented in any other suitable way in other embodiments.

In some embodiments, the processing entity 5088 may issue an output signal relating to a degradation alert based on the sensor signal from a sensor 5084ₓ of the tire 5034 and/or the identification signal from a tag 5078ₓ of the tire 5034. In some embodiments, the degradation alerts indicates that a particular level of degradation of a tire 5034 has been reached.

In other embodiments, the processing entity 5088 may issue an output signal relating to a tire ordering system based on the sensor signal from a sensor 5084ₓ of the tire 5034 of a and/or the identification signal from a tag 5078ₓ of the tire 5034. In some embodiments, the tire ordering signal conveys information relating to the type of tire, the level of degradation of the tire 5034 and the location of the vehicle. This information allows a tire ordering system to ensure that a tire is available for shipment to a particular location within a given amount of time. The information can also be collected and compiled by the tire ordering system in order to provide users with recommendations for future tires. For example, information can be collected and aggregated by geographic region in order to allow tire suppliers to provide recommendations relating to tires that are particularly well suited (i.e. exhibiting relatively slow degradation rates) to certain geographic regions.

In yet other embodiments, the processing entity 5088 may issue an output signal relating to the operation of the vehicle 5010 based on the sensor signal from a sensor 5084ₓ of the tire 5034 and/or the identification signal from a tag 5078ₓ of the tire 5034. In some embodiments, the processing entity 5088 may combine the signal from the sensor 5084ₓ and/or the identification signal from a tag 5078ₓ with vehicle information conveying whether or not the vehicle is in a particular state. For example, the vehicle information could convey whether the vehicle is traversing an unpaved road. The resulting output signal relating to the operation of the vehicle 5010 can be directed to the powertrain 5015 of the vehicle 5010 in order control the operation of the vehicle to avoid further degradation of the tire when the vehicle 5010 is in a particular state.

As noted above, in some embodiments, the processing entity 5088 may issue an output signal relating to the operation of the vehicle 5010 based on the sensor signal from a sensor 5084ₓ of the tire 5034 and/or the identification signal from a tag 5078ₓ of the tire 5034.

For example, in some embodiments, the output signal issued by the processing entity 5088 may be directed to the powertrain 5015 of the vehicle 5010 to control the operation of the vehicle based on the detection of a particular threshold of degradation of the tire 5034 sensed by the sensor 5084ₓ and/or the identity of the tire 5034 derived from the tag 5078ₓ. For instance, the output signal issued by the processing entity 5088 may be directed to the powertrain 5015 of the vehicle 5010 to control the speed of the vehicle 5010, such as by limiting and/or reducing the speed of the vehicle 5010 or by allowing the speed of the vehicle 5010 to be increased, based on the detection of a particular threshold of degradation of the tire 5034 and/or the identity of the tire 5034.

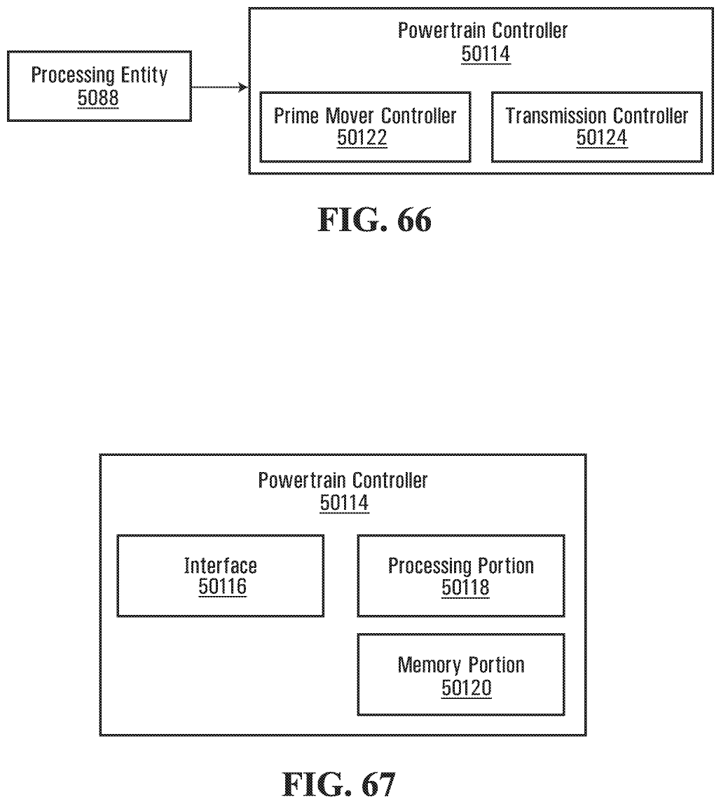

In some embodiments, as shown in FIGS. 66 and 67, the output signal issued by the processing entity 5088 may be directed to a powertrain controller 50114 of the powertrain 5015. The powertrain controller 50114 is configured for controlling operation of the powertrain 5015.

More particularly, in this embodiment, the powertrain controller 50114 is an electronic controller that comprises suitable hardware and/or software (e.g., firmware) configured to implement its functionality. The powertrain controller 50114 comprises an interface 50116, a processing portion 50118 and a memory portion 50120.

The interface 50116 allows the powertrain controller 50114 to receive inputs from and release outputs to other components of the vehicle 5010 to which the powertrain controller 50114 is connected (i.e., directly or indirectly connected to), including, in this embodiment, the power source, a transmission, an accelerator and/or other components of the user interface, and one or more sensors (e.g., a throttle position sensor; a motor speed sensor, i.e., a sensor sensing a speed of a motor of the power source; a vehicle speed sensor, i.e., a sensor sensing a speed of the vehicle 5010 on the ground; a motor temperature sensor; an outside environment temperature sensor; etc.). In this example, the interface 50116 of the powertrain controller 50114 allows the powertrain controller 50114 to receive the output signal of the processing entity 5088.

The processing portion 50118 comprises one or more processors for performing processing operations that implement functionality of the powertrain controller 50114. A processor of the processing portion 50118 may be a general-purpose processor executing program code stored in the memory portion 50120. Alternatively, a processor of the processing portion 50118 may be a specific-purpose processor comprising one or more preprogrammed hardware or firmware elements (e.g., application-specific integrated circuits (ASICs), electrically erasable programmable read-only memories (EEPROMs), etc.) or other related elements.

The memory portion 50120 comprises one or more memories for storing program code executed by the processing portion 50118 and/or data used during operation of the processing portion 50118. A memory of the memory portion 50120 may be a semiconductor memory (e.g., read-only memory (ROM) and/or random-access memory (RAM)), a magnetic storage medium, an optical storage medium, and/or any other suitable type of memory.

More particularly, in this embodiment, the powertrain controller 50114 comprises a prime mover controller 50122 and a transmission controller 50124. For instance, in embodiments in which the power source comprises an internal combustion engine and the transmission is an automatic transmission, the prime mover controller 50122 may be an engine control unit (ECU) and the transmission controller 50124 may be a transmission control unit (TCU). Such ECUs and TCUs are well understood by those skilled in the art. In some cases, the powertrain controller 50114 may be a distributed controller in which the prime mover controller 50122 and the transmission controller 50124 are physically distinct from one another and may be connected to one another via a bus (e.g., a controller-area network (CAN) bus or other suitable bus). In other cases, the prime mover controller 50122 and the transmission controller 50124 may be functional entities of a single physical control module (e.g., a powertrain control module (PCM)).

The prime mover controller 50122 is configured to control operation of the power source. Specifically, the prime mover controller 50122 is configured to control one or more prime mover characteristics.

For example, in this embodiment, one prime mover characteristic controlled by the prime mover controller 50122 is a power output of the power source. The power output of the power source refers to the power currently generated by the power source. It can be evaluated as a torque produced by the power source multiplied by a speed (i.e., a rotational speed) of the power source (e.g., revolutions per minute (RPM)) at a given instant.

The prime mover controller 50122 controls the power output of the power source based on inputs from various entities, such as: the accelerator and/or one or more other components of the user interface; one or more sensors (e.g., a throttle position sensor, an air-fuel ratio sensor, a prime mover speed sensor, a vehicle speed sensor, a temperature sensor, a pressure sensor, etc.); one or more other controllers (e.g., the transmission controller 50124); and/or other entities. In this example, the prime mover controller 50122 may control the power output of the power source based on the output signal issued by the processing entity 5088.

To control prime mover characteristics such as the power output of the power source, in this embodiment, the prime mover controller 50122 comprises a program stored in the memory portion 50120 and executed by the processing portion 50118. For example, the program may determine the power output of the power source by performing computations based on inputs from a throttle position sensor, an air-fuel ratio sensor, a prime mover speed sensor, the accelerator, and/or the transmission controller 50124. In this example, the program may determine the power output of the power source based on the output signal issued by the processing entity 5088. In some cases, certain operations of the program may refer to reference data stored in the memory portion 50120. This reference data comprises data representative of one or more maps, tables, curves or other sets of reference values that are used during execution of the program of the prime mover controller 50122. For instance, the reference data may associate different values of certain parameters of the power source (e.g., the speed, temperature, air-fuel ratio, pressure, etc. of the power source) to corresponding values of fuel injection, ignition timing, valve timing, and/or other parameters of the power source (e.g., a fuel map, an injection map, a boost map, and/or other performance map). Such programs and reference data are well-understood by those skilled in the art and will therefore not be discussed in further detail.

The transmission controller 50124 is configured to control operation of the transmission. Specifically, the transmission controller 50124 is configured to control one or more transmission characteristics. For example, in this embodiment, the transmission controller 50124 controls a transmission state of the transmission. The transmission state of the transmission can be defined in terms of (i) a transmission ratio of the transmission, which is the ratio that the transmission currently applies between its input and its output, and/or (ii) an output direction of the transmission, which refers to a direction of motion (i.e., forward or reverse) of the output of the transmission that allows the vehicle 5010 to advance or back up. At a given instant, the transmission state of the transmission is one of a set of available transmission states. The set of available transmission states can comprise a number of available transmission ratios that can be applied by the transmission. This number may be a finite number (e.g., two, three, four or any other finite number) of available transmission ratios, or an infinite number of available transmission ratios (e.g., in embodiments where the transmission comprises a CVT).

The transmission controller 50124 controls the transmission state of the transmission based on inputs from various entities, such as: the accelerator and/or one or more other components (e.g., a gear shift stick or pedal) of the user interface; one or more sensors (e.g., a throttle position sensor, a shift lever sensor, a prime mover speed sensor, a vehicle speed sensor, a temperature sensor, etc.); one or more other controllers (e.g., the prime mover controller 50122); and/or other entities. In this example, the transmission controller 50124 may control the transmission state of the transmission based on the output signal issued by the processing entity 5088.

To control the state of the transmission, in this embodiment, the transmission controller 50124 comprises a program stored in the memory portion 50120 and executed by the processing portion 50118. For example, the program may determine when and how to shift between different transmission ratios of the transmission by performing certain computations based on inputs from a throttle position sensor, a prime mover speed sensor, a vehicle speed sensor, the accelerator and/or other components of the user interface, and/or the prime mover controller 50122. In this example, the program may determine the state of the transmission based on the output signal issued by the processing entity 5088. In some cases, certain operations of the program may refer to reference data stored in the memory portion 50120. This reference data comprises data representative of one or more maps, tables, curves or other sets of reference values that are used during execution of the program of the transmission controller 50124. For instance, the reference data may associate different values of the speed of the power source and of the speed of the vehicle 5010 to corresponding transmission ratios of the transmission. Such programs are well-understood by those skilled in the art and will therefore not be discussed in further detail.

For example, in some embodiments, a sensor 5084x of the tire 5034 may be a degradation sensor of the tire 5034, and the powertrain controller 50114 may control the speed of the vehicle 5010 based on whether a threshold of degradation of tire 5034 has occurred.

In other embodiments, as shown in FIG. 68, the output signal issued by the processing entity 5088 may be directed to a communication device 50130 for communicating information regarding the operation of the vehicle 5010 to a user, such as the operator of the vehicle 5010.

The communication device 50130 may be implemented in various ways in various embodiments.

In other embodiments, the communication device 50130 may be part of the user interface of the operator cabin in order to convey information to the operator.

As another example, in some embodiments, as shown in FIG. 68, the communication device 50130 may be a personal communication device (e.g., a smartphone, a computer, etc.) or other device that is usable by a user (e.g., the operator) and distinct from and not built into the user interface of the operator cabin of the vehicle 5010.

The communication device 50130 may interact with the monitoring system 5082 over a communication link 50135, which may be wireless, wired, or partly wireless and partly wired (e.g., Bluetooth or other short-range or near-field wireless connection, WiFi or other wireless LAN, WiMAX or other wireless WAN, cellular, Universal Serial Bus (USB), etc.). For example, in some embodiments, the communication device 50130 may be:
a smartphone or other wireless phone; a tablet computer; a head-mounted display, smartwatch or other degradationable device; or any other communication device carried, worn or otherwise associated with the user (e.g., the operator);
a server or other computing entity (e.g., implementing a website) associated with: the user (e.g., the operator); an organization associated with the user (e.g., the operator); a manufacturer of the tire 5034 and/or of the vehicle 5010; a retailer, distributor, or other vendor of the tire 5034 and/or of the vehicle 5010; or any other party who may have an interest in the tire 5034 and/or of the vehicle 5010;
etc.

In some cases, such as where the communication device 50130 is a smartphone, tablet, head-mounted display, smartwatch, or other communication device carried or worn by the user (e.g., the operator), communication between the communication device 50130 and the monitoring system 5082 may be direct, i.e., without any intermediate device. For instance, in some embodiments, this can be achieved by pairing (e.g., Bluetooth pairing) the communication device 50130 and the monitoring system 5082.

In other cases, such as where the communication device 50130 is remote from the monitoring system 5082, communication between the communication device 50130 and the monitoring system 5082 may be indirect, e.g., through one or more networks and/or one or more additional communication devices. For example, in some embodiments, the monitoring system 5082 may communicate (e.g., via the transmitter 50112 and/or the receiver 50104 of the processing entity 5088 or the transmitter 5090 and/or the receiver 5092 of the sensor 5084ₓ) with a WiFi hotspot or cellular base station, which may provide access to a service provider and ultimately the Internet or another network, thereby allowing the monitoring system 5082 and the communication device 50130 to communicate. As another example, in some embodiments, communication between the communication device 50130 and the monitoring system 5082 may take place through a smartphone, tablet, head-mounted display, smartwatch, or other communication device which is carried or worn by the user of the communication device 50130 and which itself may have established communication with a WiFi hotspot or cellular base station.

For example: in some embodiments, the communication device 50130 may be a smartphone or other mobile phone, a tablet, a smart watch, head-mounted display or other degradationable device, or any other communication device that may be carried by the user, and the communication link 50135 may be a short-range wireless link (e.g., Bluetooth) or a wired link (e.g., USB); in other embodiments, the communication device 50130 may be a server or other computing entity or a smartphone or other mobile phone, a tablet, a smart watch, head-mounted display or other degradationable device, or any other communication device that may be carried by the user and the communication link 50135 may be implemented by a data network such as the Internet over a wired connection and/or a wireless connection (e.g., WiFi, WiMAX, cellular, etc.); and, in other embodiments, the communication device 50130 may be a server or other computing entity and the communication link 50135 may be implemented over a wireless connection using, for instance, dedicated short-range communication (DSRC), IEEE 802.11, Bluetooth and CALM (Communications Access for Land Mobiles), RFID, etc.

In some embodiments, an application (“app”, i.e., software) may be installed on the communication device 50130 to interact with the monitoring system 5082 of the vehicle 5010. For example, in some embodiments, such as where the communication device 50130 is a smartphone, a tablet, a computer, etc., the user (e.g., the operator) may download the app from a repository (e.g., Apple's App Store, iTunes, Google Play, Android Market, etc.) or any other website onto the communication device 50130. Upon activation of the app on the communication device 50130, the user may access certain features relating to the monitoring system 5082 of the vehicle 5010 locally on the communication device 50130. In addition, a data connection can be established over the Internet with a server of which executes a complementary server-side application interacting with the app on the communication device 50130.

For example, in some embodiments, the communication device 50130 may be a smartphone of the operator of the vehicle 5010, onto which an app to interact with the monitoring system 5082 of the vehicle 5010 has been installed (e.g., downloaded).

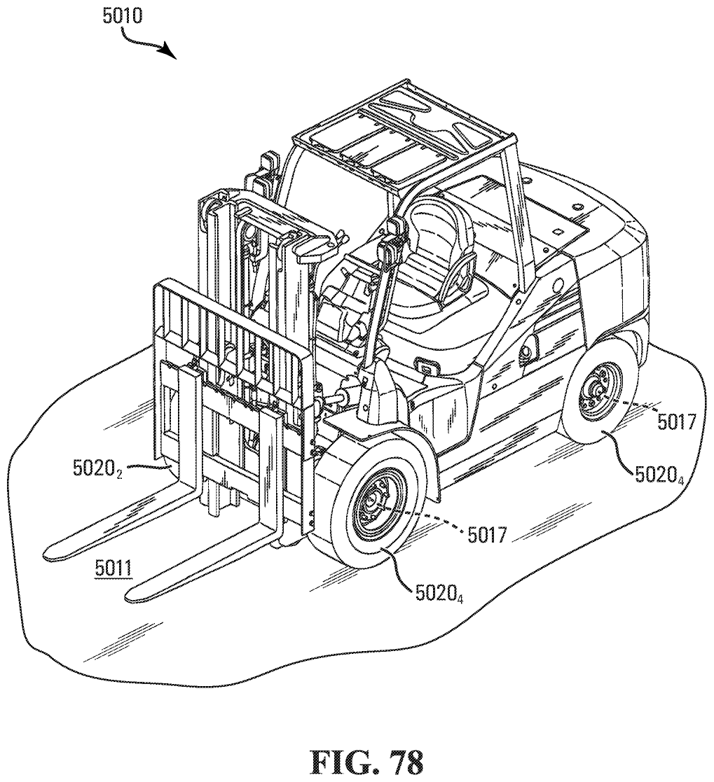

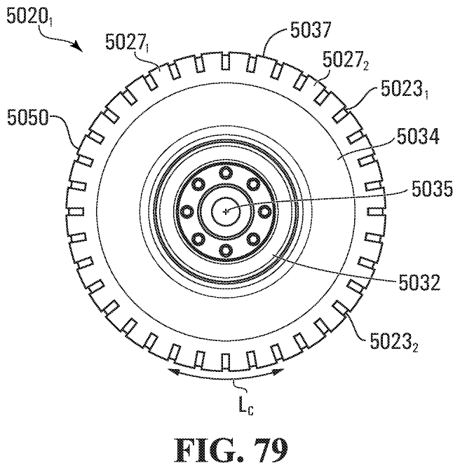

In various embodiments, as shown in FIGS. 78 to 80, the communication device 50130 (e.g., whether part of the user interface of the operator cabin, or a personal communication device such as a smartphone, tablet, computer, etc.) may comprise a user interface 50137 and a processing entity 50139. The user interface 50137 may comprise a display 50141, a speaker 50143, and/or any other output device, such as the display 50132 of the operator cabin, a display of a smartphone, etc. The processing entity 50139 comprises an interface 50145, a processing portion 50147, and a memory portion 50149, which are implemented by suitable hardware and/or software.

The interface 50145 comprises one or more inputs and outputs allowing the processing entity 50139 to receive input signals from and send output signals to other components to which the processing entity 50139 is connected (i.e., directly or indirectly connected). For example, in this embodiment, an input of the interface 50145 is implemented by a wireless receiver to receive a signal from the monitoring system 5082. An output of the interface 50145 is implemented by a transmitter.

The processing portion 50147 comprises one or more processors for performing processing operations that implement functionality of the processing entity 50139. A processor of the processing portion 50147 may be a general-purpose processor executing program code stored in the memory portion 50149. Alternatively, a processor of the processing portion 50147 may be a specific-purpose processor comprising one or more preprogrammed hardware or firmware elements (e.g., application-specific integrated circuits (ASICs), electrically erasable programmable read-only memories (EEPROMs), etc.) or other related elements.

The memory portion 50149 comprises one or more memories for storing program code executed by the processing portion 50147 and/or data used during operation of the processing portion 50147. A memory of the memory portion 50149 may be a semiconductor medium (including, e.g., a solid-state memory), a magnetic storage medium, an optical storage medium, and/or any other suitable type of memory. A memory of the memory portion 50149 may be read-only memory (ROM) and/or random-access memory (RAM), for example.

In some embodiments, two or more elements of the processing entity 50139 may be implemented by devices that are physically distinct from one another and may be connected to one another via a bus (e.g., one or more electrical conductors or any other suitable bus) or via a communication link which may be wired. In other embodiments, two or more elements of the processing entity 50139 may be implemented by a single integrated device.

The processing entity 50139 may be implemented in any other suitable way in other embodiments.

Although the output signal issued by the processing entity 5088 was described in embodiments considered above as being directed to the powertrain 5015 of the vehicle 5010 or the communication device 50130, in some embodiments, both of these actions can be performed by the processing entity 5088. That is, an output signal may be issued by the processing entity 5088 and directed to the powertrain 5015 of the vehicle 5010 to control the powertrain 5015 of the vehicle 5010 and another output signal may be issued by the processing entity 5088 and directed to the communication device 50130 for communicating information regarding the operation of the vehicle 5010 to a user such as the operator of the vehicle 5010.

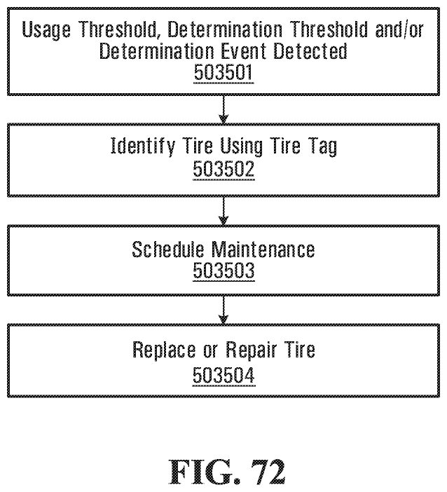

The monitoring system 5082 can have a number of applications, non-limiting examples of which are described below with reference to FIGS. 72 to 74. Any feature of any embodiment discussed with reference to FIGS. 72 to 74 may be combined with any feature of any other embodiment discussed with reference to FIGS. 72 to 74 in order to optimize vehicle downtime, tire order/shipping times, vehicle maintenance scheduling, vehicle use schedules, vehicle dispatch schedules and dispatch locations and/or any other operational, logistical or organisational criteria relating to tires, vehicles, fleets of vehicles, and/or maintenance facility operations.

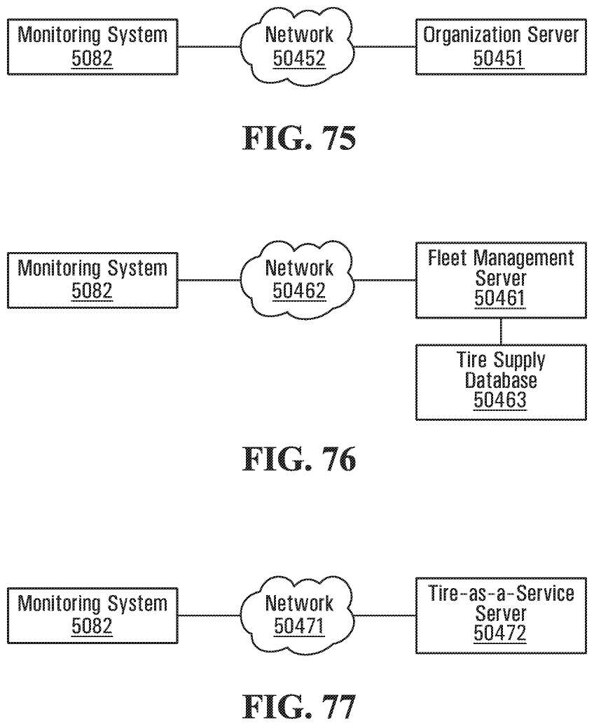

For example, with reference to FIG. 72, in some embodiments, the monitoring system 5082 can be used in a vehicle rental market to monitor usage of tire components. At step 503501, the monitoring system 5082 determines that an event arising from usage of a tire 5034, such as a usage threshold event (e.g. an amount of tread wear, an amount of time such as a number of hours the tire 5034 has been used) and/or deterioration event (e.g. a reinforcing member 5046₁-5046₄ de-bonding) has occurred. At step 503502, the monitoring system 5082 identifies the tire for which the usage threshold event and/or deterioration event has occurred. In some embodiments, the tire information and information relating to the usage threshold event and/or deterioration event is conveyed to the operator of the vehicle by the monitoring system 5082 in order to facilitate scheduling of tire 5034 servicing and/or other maintenance. For instance, the monitoring system 5082 may issue a notification conveying this information to the operator via the user interface of the operator cabin of the vehicle 5010 and/or the communication device 50130. In other embodiments, the monitoring system 5082 conveys the tire information and information relating to the usage threshold event and/or deterioration event to an organization providing maintenance services. For instance, as shown in FIG. 75, the monitoring system 5082 may issue a notification conveying this information to a server 50451 associated with the organization via a network 50452 (e.g. which may be implemented by the Internet, a cellular connection, and/or any other network infrastructure). Once the information is received, the organization can schedule maintenance of the vehicle at step 503503, and subsequently replace or repair the tire 5034. Accordingly, tire maintenance operations can be initiated and scheduled without the need for input from the vehicle operator.

Moreover, multiple sensors 5084₁-5084ₛ can be embedded in the elastomeric material of the tread projections 5027₁-5027ᵢ and/or the elastomeric material 5045 of the tire 5034 at different depths, thereby providing a simple and inexpensive solution for monitoring the progression of tire wear. In the vehicle rental market, for example, this can allow a pay-per-use model, in which vehicle rental costs are not based on the length of the rental period, but rather at least partly on the amount of use (i.e. wear on the tire) that is incurred during the rental period.

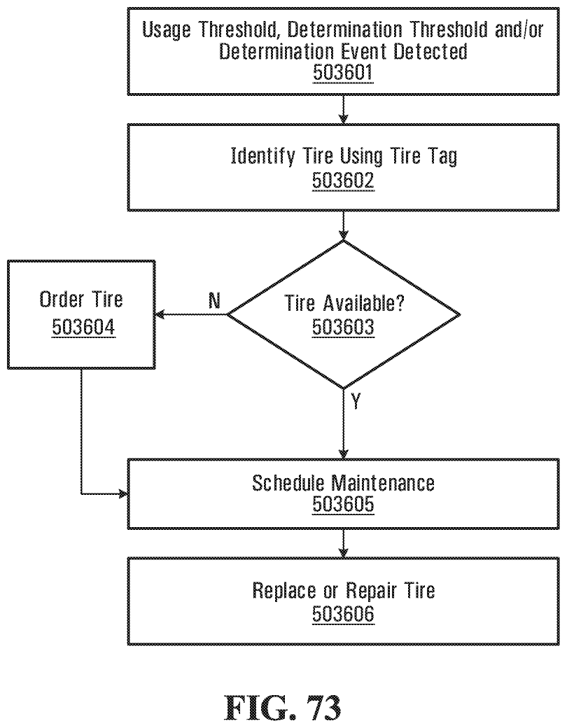

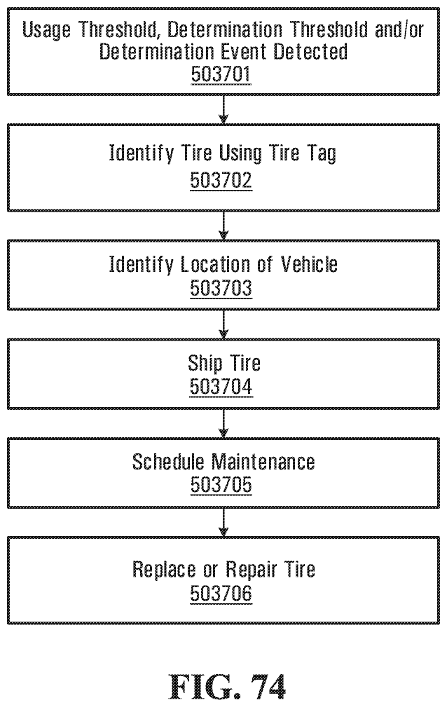

In some embodiments, and with reference to FIG. 73, the monitoring system 5082 allows organizations managing large fleets (e.g. vehicle rental companies, construction companies, long-haul trucking companies, etc.) to ensure that maintenance operations can be scheduled and carried out effectively and efficiently. For example, by monitoring the wear of tires, it is possible to more precisely predict when a tire will fail and/or when a replacement tire should be ordered and/or shipped. Moreover, for an organization managing a fleet of vehicles, knowing which vehicles will shortly require maintenance and/or replacement parts contributes to efficient and effective deployment of vehicles and maintenance resources. For example, at step 503601, the monitoring system 5082 determines that an event arising from usage of a tire, such as a usage threshold event (e.g. an amount of tread wear, an amount of time such as a number of hours the tire 5034 has been used) and/or deterioration event (e.g. a reinforcing member 5046₁-5046₄ de-bonding), has occurred. At step 503602, the monitoring system 5082 identifies the tire 5034 for which the usage threshold event and/or deterioration event has occurred. In some embodiments, as shown in FIG. 74, the monitoring system 5082 conveys the tire information and information relating to the usage threshold event and/or deterioration event to an automated fleet management system comprising a server 50461. The monitoring system 5082 may communicate with the server 50461 of the automated fleet management system over a network 50462 (e.g. which may be implemented by the Internet, a cellular connection, and/or any other network infrastructure). At step 503603, the server 50461 of the automated feet management system queries a tire supply database 50463 to determine whether the identified tire is available or needs to be ordered. The tire supply database can be managed by the fleet management system, or can be managed by a third-party tire supplier. If the identified tire is available, the vehicle can be scheduled for maintenance. If, on the other hand, the tire is not available, the fleet management system can cause the tire to be ordered at step 503604, before scheduling maintenance of the vehicle at step 503605. In some embodiments, the scheduling of the vehicle maintenance is at least in part based on the estimated delivery time for an ordered tire. In other embodiments, the dispatching of the vehicle relating to the identified tire can, at least partially, be based on the scheduled maintenance. Finally, at step 503606, the maintenance operation is carried out and the tire is replaced or repaired.

In some embodiments, as shown in FIG. 74, the monitoring system 5082 allows organizations to provide tire-as-a-service type payment/usage models, in which tires are not purchased, but are rather provided as a service to vehicle operators in exchange for a subscription fee. For example, for a monthly fee, an organization could provide vehicle operators with tires, as well as the monitoring system 5082 which will allow the organization to ensure that the vehicle operator is never without an operable/functional tire, regardless of how much and how (i.e. under what circumstances) the vehicle operator uses the tire. This can lead to significant savings in term of vehicle downtime and logistics. For example, at step 503701, the monitoring system 5082 determines that an event arising from usage of a tire 5034, such as a usage threshold event (e.g. an amount of tread wear, an amount of time such as a number of hours the tire 5034 has been used) and/or deterioration event (e.g. a reinforcing member 5046₁-5046₄ de-bonding), has occurred. At step 503702, the monitoring system 5082 identifies the tire 5034 for which the usage threshold event and/or deterioration event has occurred. At step 503703, vehicle location information relating to the geographic location of the vehicle is determined. This can be achieved by any suitable means including, but not limited to, Global Positioning System (GPS) receivers. In some embodiment, the monitoring system 5082 conveys the tire information, vehicle location information and information relating to the usage threshold event and/or deterioration event to the tire-as-a-service organization. As shown in FIG. 29, the monitoring system 5082 may communicate with the server 50472 of the tire-as-a-service organization over a network 50471 (e.g. which may be implemented by the Internet, a cellular connection, and/or any other network infrastructure). Then, at step 503704, the tire-as-a-service organization ships a replacement tire to a location related to the geographic location of the vehicle. For example, the tire-as-a-service location could ship the replacement tire to the nearest maintenance service dispatch location or third party maintenance organization. At step 503705, the tire-as-a-service organization can schedule a maintenance of the vehicle. In some embodiments, the tire-as-a-service organization schedules a third party mobile maintenance team to perform onsite maintenance based on the geographic location of the vehicle. Finally, at step 503706, the tire-as-a-service organization, or an agent thereof, replaces the tire. In some embodiments, this can be performed onsite, based at least in part on the vehicle location information received from the tire-as-a-service organization.

While in embodiments considered above the vehicle 5010 is a truck, in other embodiments, the vehicle 5010 may be an automobile (i.e., a passenger car), a bus, or any other road vehicle. Also, in other embodiments, the ground surface 5011 may be an off-road surface and the vehicle 5010 may be an off-road vehicle, such as a construction vehicle (e.g., a loader, etc.) for performing construction work, an agricultural vehicle (e.g., a combine harvester, another type of harvester, a tractor, etc.) for performing agricultural work, a forestry vehicle (e.g., a feller-buncher, a tree chipper, a knuckleboom loader, etc.) for performing forestry work, or a military vehicle (e.g., a combat engineering vehicle (CEV), etc.) for performing military work, a carrier (e.g. carrying a boom, a rig, and/or other equipment), or any other type of vehicle operable off paved roads.

Furthermore, while in embodiments considered above the vehicle 5010 is driven by a human operator in the vehicle 5010, in other embodiments, the vehicle 5010 may be an unmanned vehicle (e.g., a tele-operated or autonomous vehicle).

The wheel 5020ᵢ, including the tire 5034, may be implemented in various other ways in other embodiments. For example, in some embodiments, as shown in FIGS. 78 to 80, the vehicle 5010 is a material-handling vehicle, which is an industrial vehicle designed to travel off-road to move (e.g., transport) and/or otherwise handle materials (e.g., goods and products), such as during their manufacturing, storage, distribution, consumption, and/or disposal. More particularly, in this embodiment, the material-handling vehicle 5010 is a forklift.

In this embodiment, the tire 5034 of the wheel 5020ᵢ is a non-pneumatic tire, which is a compliant wheel structure that is not supported by gas (e.g., air) pressure and that is resiliently deformable (i.e., changeable in configuration) as the wheel 5020ᵢ contacts the ground surface 5011.

The tire 5034 comprises an outer surface 5037 for contacting the underlying surface 5011, an inner surface for facing the wheel hub 5032 and the axis of rotation 5035 of the wheel 5020ᵢ, and lateral surfaces 5041₁, 5041₂ opposite one another and spaced from one another in the lateral direction of the tire 5034. It has an outer diameter D_{T}, and an inner diameter d_{T}.

The outer surface 5037 of the tire 5034 comprises a tread 5050. In this example, the tread 5050 comprises a pattern of traction elements to enhance traction on the underlying surface. The pattern of traction elements comprises tread projections 5027₁-5027ᵢ and tread recesses 5023₁-5023_{R} between the traction projections 5027₁-5027ᵢ. Any suitable design for the pattern of traction elements may be used. In other examples, the tread 5050 may be smooth, i.e., with no pattern of traction elements such as the pattern of traction elements.

In this embodiment, the tire 5034 comprises a plurality of layers 5060₁-5060_{L} that are structurally different and arranged in the radial direction of the tire 5034. For example, in various embodiments, respective ones of the layers 5060₁-5060_{L} of the tire 5034 may include different structures, such as structures comprising different materials and/or having different shapes.

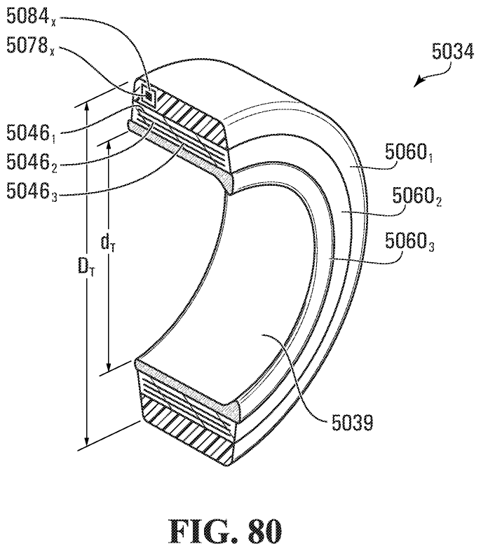

An outer one of the layers 5060₁-5060_{L}, namely the layer 5060₁, comprises the outer surface 5037 and the tread 5050 of the tire 5034. In that sense, the outer layer 5050₁ can be referred to as a “tread layer”. As shown in FIG. 80, in some embodiments, the tire 5034 includes a sensor 5084ₓ and a tag 5078ₓ, for implementing the monitoring system described in detail above. An inner one of the layers 5060₁-5060_{L}, namely the layer 50603, comprises the inner surface 5039 of the tire 5034. In some cases, depending on how the tire 5034 is constructed, the inner surface 5039 of the tire 5034 may be part of a “heel” or “inner heel” of the tire 5034, and thus the inner layer 50503 can be referred to as a “heel layer” or “inner heel layer”.

Each of one or more of the layers 5050₁-5050_{L} of the tire 5034 comprises elastomeric material 5045. The elastomeric material 5045 of a layer 5050ₓ can include any polymeric material with suitable elasticity. For example, the elastomeric material 5045 of the layer 5050ₓ may include rubber. Any suitable rubber compound may be used. As another example, in some cases, the elastomeric material of the layer 5050ₓ may include another elastomer in addition to or instead of rubber (e.g., a thermoplastic elastomer (TPE), such as thermoplastic polyurethane (TPU)).

In some embodiments, layers 5050ₓ may include reinforcing members 5046₁-5046_{R} each of which can be stiffer and stronger than the elastomeric material 5045 to reinforce the tire 5034 in one or more directions. For example, a given one of the reinforcement members 5046₁-5046_{R} may be metallic in that it is at least mainly (i.e., mainly or entirely) made of metal. As another example, a given one of the reinforcing members 5046₁-5046_{R} may be polymeric but non-elastomeric in that it is at least mainly made of polymeric but non-elastomeric material (e.g., nylon, polyester, aramid, etc.).

More particularly, in this embodiment, each of the reinforcing members 5046₁, 5046₂ is a belt running in the circumferential direction of the tire 5034. In this example, each of the belts 5046₁, 5046₂ comprises a layer of reinforcing cables that extend generally parallel to one another. Specifically, in this embodiment, each of the reinforcing members 5046₁, 5046₂ is a metallic (e.g., steel) belt in which the reinforcing cables are metallic.

Certain additional elements that may be needed for operation of some embodiments have not been described or illustrated as they are assumed to be within the purview of those of ordinary skill in the art. Moreover, certain embodiments may be free of, may lack and/or may function without any element that is not specifically disclosed herein.

Any feature of any embodiment discussed herein may be combined with any feature of any other embodiment discussed herein in some examples of implementation.

In case of any discrepancy, inconsistency, or other difference between terms used herein and terms used in any document incorporated by reference herein, meanings of the terms used herein are to prevail and be used.

Although various embodiments and examples have been presented, this was for purposes of describing, but is not limiting. Various modifications and enhancements will become apparent to those of ordinary skill in the art.

1. A track system for traction of a vehicle, the track system comprising:
a plurality of wheels; and
a track mounted around the wheels, the track comprising elastomeric material and having a ground-engaging outer surface and an inner surface opposite to the ground-engaging outer surface;
wherein said track further comprises a metal track core at least partially embedded in the elastomeric material and at least a first reinforcing cable made of electrically conductive material embedded in the elastomeric material and spaced apart from the metal track core;
wherein:
the track system comprises a sensor configured to sense deterioration of the track;
said sensor comprising an open electrical detection circuit closable in response to de-bonding of at least one of said metal track core and said first reinforcing cable;
the open electrical detection circuit comprises a power source having a first terminal electrically connected to the first reinforcing cable;
wherein the open electrical detection circuit is configured to close when said first reinforcing cable comes into electrical contact with the metal track core as a result of said de-bonding.

2. The track system of claim 1, wherein a second terminal of the power source of the open electrical detection circuit is electrically connected to the metal track core.

3. The track system of claim 2, wherein said first reinforcing cable is a first continuous reinforcing cable winding which extends in the longitudinal direction of the track of the track system, and
wherein the open electrical detection circuit is configured to close when a segment of said first continuous reinforcing cable winding comes into electrical contact with the metal track core as a result of de-bonding of at least one of said metal track core and said first continuous reinforcing cable winding.

4. The track system of claim 3, wherein the open electrical detection circuit comprises a current or voltage detector operatively coupled to said open electrical detection circuit;
wherein the power source is configured to create a difference of potential between the first continuous reinforcing cable winding and the metal track core; and
wherein the current or voltage detector is configured to detect electrical change when the open electrical detection circuit closes.

5. The track system of claim 1, wherein the track further comprises a second reinforcing cable made of electrically conductive material embedded in the elastomeric material and spaced apart from the metal track core, the first and second reinforcing cables being spaced apart from one another in opposite lateral sides of the track;
wherein a second terminal of the power source is electrically connected to the second reinforcing cable; and
wherein the open electrical detection circuit is configured to close when at least a portion of each of the first and second reinforcing cables comes into electrical contact with the metal track core as a result of de-bonding of at least one of said metal track core and said first and second reinforcing cables.

6. The track system of claim 5, wherein the first and second reinforcing cables are first and second continuous reinforcing cable windings, respectively; and
wherein the open electrical detection circuit is configured to close when at least a segment of each of the first and second continuous reinforcing cable windings comes into electrical contact with the metal track core as a result of de-bonding of at least one of said metal track core and said first and second continuous reinforcing cable windings.

7. The track system of claim 6, wherein the open electrical detection circuit comprises a current or voltage detector operatively coupled to said open electrical detection circuit;
wherein the power source is configured to create a difference of potential between the first continuous reinforcing cable winding and the second continuous reinforcing cable winding; and
wherein the current or voltage detector is configured to detect electrical change when the open electrical detection circuit closes.

8. The track system of claim 5, wherein the first and second continuous reinforcing cable windings are longitudinally arranged between the metal track core and the ground-engaging surface of the track.

9. The track system of claim 5, wherein the first and second reinforcing cables are substantially parallel to each other.

10. The track system of claim 1, wherein the metal track core extends transversally to the longitudinal direction of the track.

11. The track system of claim 1, wherein the metal track core comprises:
a core portion embedded in the elastomeric material of the track, for providing transversal rigidity to the track, and
a wheel-engaging portion protruding from the core portion and extending outwardly from the inner surface of said track, at least for guiding and driving the plurality of wheels of the track.

12. The track system of claim 1, wherein the first continuous reinforcing cable winding is longitudinally arranged between the metal track core and the ground-engaging surface of the track, and on a lateral side thereof.

13. A tire system for a vehicle having a tire, the tire system comprising:
elastomeric material;
a first reinforcing member and a second reinforcing member at least partially embedded in the elastomeric material, the first and second reinforcing members being spaced-apart from one another and made of electrically conductive material;
wherein:
the tire system comprises a sensor configured to sense deterioration of the tire of the tire system;
said sensor comprising an open electrical detection circuit closable in response to de-bonding of at least one of the first and second reinforcing members;
the open electrical detection circuit comprises a power source having a first and a second terminal, each of the first and second terminals being electrically connected to the first and second reinforcing members, respectively; and
wherein the open electrical detection circuit is configured to close when the first and second reinforcing members come into electrical contact as a result of said de-bonding.

14. The tire system of claim 13, wherein the open electrical detection circuit comprises a current or voltage detector operatively coupled to said open electrical detection circuit;
wherein the power source is configured to create a difference of potential between the first reinforcing member and the second reinforcing member; and
wherein the current or voltage detector is configured to detect electrical change when the open electrical detection circuit closes.

15. The tire system according to claim 13, wherein the tire is a pneumatic tire, and the pneumatic tire is configured to sense the deterioration thereof without sensing inflation pressure of the pneumatic tire.
